(19) United States
(12) Patent Application Publication
(10) Pub. No.: US 2005/0002552 A1
(43) Pub. Date: Jan. 6, 2005

(54) Automated in vitro cellular imaging assays for micronuclei and other target objects

(75) Inventors: Margaret C. Dunn, Wakefield, RI (US); Jinghai J. Xu, Westerly, RI (US); Lance C. Ryley, Bozrah, CT (US)

Correspondence Address: PFIZER INC., PATENT DEPARTMENT, MS8260-1611, EASTERN POINT ROAD, GROTON, CT, 06340, US

(73) Assignee: Pfizer Inc

(21) Appl. No.: 10/831,917

(22) Filed: Apr. 26, 2004

Related U.S. Application Data
(60) Provisional application No. 60/466,750, filed on Apr. 30, 2003.

(51) Int. Cl. G06K 9/00

(52) U.S. Cl. 382/133

(57) ABSTRACT

A process for identifying the presence or absence of target objects inside or outside of cells is disclosed. The target objects are identified by highlighting them and collecting and analyzing image data. When target objects are present, the process can determine their size and/or shape and/or location. With this information, diseases, conditions, syndromes, or stimuli-induced effects may be diagnosed and/or courses of treatment monitored. The process may be used to determine the effect of stimuli on cells and can be used in the fields of medical diagnostics, drug efficacy screening, and drug toxicity screening. For example, after the appropriate test cells have been exposed to a chemical agent and allowed to undergo nuclear division, the micronuclei frequency determined indicates whether the chemical agent is clastogenic and/or aneugenic, which information can be used in a drug discovery program.

### CROSS REFERENCE TO RELATED APPLICATION

This patent application claims priority from U.S. Ser. No. 60/466,750, filed Apr. 30, 2003, entitled “Automated in vitro Cellular Imaging Assays for Micronuclei and Other Target Objects”.

### COMPUTER PROGRAM LISTING APPENDIX

A source code listing of the preferred computer program (algorithm) entitled “Automated In Vitro Cellular Imaging Assays For Micronuclei And Other Target Objects” is part of this application and disclosure, and the source code and computer program are hereby incorporated herein in their entirety for all purposes. The listing consists of two files: “04172003 MN_BN script for Provis File.txt” (32 kilobytes) and “04172003 MonoNuc script for Provis File.txt” (28 kilobytes), both dated Apr. 17, 2003. The source code listing is being submitted as a computer program listing appendix on the two accompanying identical sets of compact discs (each set marked “Copy 1” or “Copy 2,” as appropriate, and consisting of one disc), created on Apr. 26, 2004, in accordance with 37 C.F.R. §§ 1.52(e), 1.77(b)(4), and 1.96(c), all of which discs and the files thereon hereby being incorporated herein in their entirety for all purposes. The electronic name of the disc of Copy 1 is “PC23076A” and the electronic name of the disc of Copy 2 is “PC23076A.” Each of the discs bears an external label with the title “AUTOMATED IN VITRO CELLULAR IMAGING ASSAYS FOR MICRONUCLEI AND OTHER TARGET OBJECTS, COMPUTER PROGRAM LISTING APPENDIX” as well as the other information required by 37 C.F.R. § 1.52(e)(6). A separate transmittal letter for the discs, in accordance with 37 C.F.R. § 1.52(e)(3)(ii), accompanies this application. The source code listing described herein is the preferred embodiment of the computer program. The methods of the invention may utilize computer programs other than the one set forth in the computer program listing appendix of this patent application.

A portion of the disclosure of this patent document contains material that is subject to copyright protection. The copyright owner has no objection to facsimile reproduction of the patent document or the patent disclosure as it appears in the United States Patent and Trademark Office files and records but otherwise reserves all copyright rights.

### FIELD OF THE INVENTION

The present invention is directed to cellular imaging. More particularly the present invention relates to cellular imaging assays for micronuclei and other target objects where abnormal presence, abnormal absence, abnormal size, abnormal shape and/or abnormal location inside or outside of cells is indicative of one or more conditions, diseases, syndromes, or stimuli-induced (e.g. chemical-induced) effects. Even more specifically this invention concerns methods to automatically score individual cell features (e.g., micronuclei) even if features and/or cells are aggregated. The present invention further relates to processes for determining the presence and/or size and/or shape and/or location of target objects inside or outside cells in a sample.

### BACKGROUND OF THE INVENTION

Cellular imaging to determine abnormal presence, abnormal absence, abnormal size, abnormal shape and/or abnormal location of target objects inside or outside cells is useful to indicating one or more conditions, diseases, syndromes or stimuli-included (e.g. chemical-induced) effects. One type of target objects which may be identified through cellular imaging in the micronucleus.

Micronuclei are small “packets” of genetic material that form during cellular (and therefore nuclear) reproduction inside a cell and are separate from the cell nucleus. Micronuclei originate during the last phase of nuclear division. It is of interest in assessing the health of cells to assess the formation of micronuclei during cellular reproduction.

Until recently the only way to visually screen a sample for micronuclei within binucleated cells was manually (i.e. technician slowly examining the sample under a microscope and counting the number of binucleated cells as well as the number of binucleated cells containing the micronuclei).
A. Slow cytometry involves lysing the cells to release any micronuclei present so that they may be measured in suspension. Unfortunately, in such a suspension, nuclei fragments and other DNA-containing debris can be mistakenly registered as micronuclei. Another problem with flow cytometry is that it is impossible to associate any of the detached micronuclei with any particular cells.

There have been attempts to provide methods for automated image onalysis for detecting micronuclei. However, none of these methods discloses how to accurately resolve cell aggregates, cell clumps, or connecting cells into individual cell objects utilizing cytoplasm image data. Such is not a desirable approach because even with low cell density, it is difficult to avoid or even minimize cell aggregates, clumps, etc. Not being able to resolve aggregates, clumps, etc. into individual cells can cause significant errors in the cell count and thereby adversely affect the results.

In addition to the failing s of these suggested methods, non of them is on in vitro micronucleus assay that can be conducted directly with a multiwell microplate. That is, none of them can acquire and analyze image data for an assay directly from a microwell microplate much less in an automated manner. As explained below, attempts to provide automated screening methods (e.g., using image analysis) have been made, but none of these methods has proved entirely satisfactory.

Thus a need remains for an automatic, rapid, and accurate method of screening large numbers of cells for micronuclei and other target objects and in particular, the need remains for such a method that can automatically, rapidly, and accurately score individual cell features (e.g., micronuclei), even if the cells and/or features are aggregated.

### BRIEF SUMMARY OF THE INVENTION

An automatic, rapid, and accurate method that avoids those earlier problems and provides significant benefits that will be apparent to one skilled in the art based on the present description and attendant claims has now been developed.

Broadly speaking, in one aspect the present invention concerns an automated process for determining the presence of micronuclei within binucleated cells in a sample or portion thereof, the cells normally containing nuclei and cytoplasm, the nuclei and micronuclei being nuclear objects, the sample or portion thereof being treated to highlight the presence of the cytoplasm and to highlight the presence of nuclear objects, and one or more images of the sample or portion thereof showing the resulting highlighting having been collected, each of the one or more images comprising image data, there being image data for a plurality of locations within each of the one or more images, one or more of the cells in one or more of the images possibly appearing to be joined together in cellular clumps and one or more of the nuclear objects in one or more of the images possibly appearing to be joined together in nuclear object clumps, the process comprising the steps of:
(a) automatically determining the outlines of the cells in the sample or portion thereof from the image data using means that can resolve cellular clumps into individual cells with an error rate no greater than 20%, (b) automatically determining the outlines of the nuclear objects in the sample or portion thereof from the image data using means that can resolve nuclear object clumps into individual nuclear objects with an error rate no greater than 20%; (c) automatically determining which of the nuclear objects are nuclei and which of the nuclear objects are micronuclei; (d) automatically determining which of the nuclei are within the cells; (e) automatically determining which of the cells are binucleated; (f) automatically determining which of the micronuclei are within the cells; and (g) automatically determining whether the binucleated cells contain micronuclei.

In another aspect, the invention concerns an automated process for determining the presence of micronuclei within binucleated cells in a sample or portion thereof, the cells normally containing nuclei and cytoplasm, the nuclei and micronuclei being nuclear objects, the sample or portion thereof being treated to highlight the presence of the cytoplasm and to highlight the presence of nuclear objects, and one or more images of the sample or portion thereof showing the resulting highlighting having been collected, each of the one or more images comprising image data, there being image data for a plurality of locations within each of the one or more images, one or more of the cells in one or more of the images possibly appearing to be joined together in cellular clumps and one or more of the nuclear objects in one or more of the images possibly appearing to be joined together in nuclear object clumps, the process comprising the steps of:
(a) automatically determining the outlines of the cells in the sample or portion thereof from the image data using means that can resolve cellular clumps into individual cells with an error rate no greater than 20%; (b) automatically determining the outlines of the nuclear objects in the sample or portion thereof from the image data using means that can resolve nuclear object clumps into individual nuclear objects with an error rate no greater than 20%; (c) automatically determining which of the nuclear objects are nuclei and which of the nuclear objects are micronuclei; and (d) using the results of the steps (a), (b), and (c), automatically identifying the cells that are binucleated and contain micronuclei.

In another aspect, the invention concerns an automated process for determining the presence of micronuclei within binucleated cells in a sample or portion thereof, the cells normally containing nuclei and cytoplasm, the nuclei and micronuclei being nuclear objects, the process comprising the steps of: (a) treating the sample or portion thereof to highlight the presence of the cytoplasm and to highlight the presence of nuclear objects; (b) collecting one or more images of the sample or portion thereof showing the resulting highlighting, each of the one or more images comprising image data, there being image data for a plurality of locations within each of the one or more images, one or more of the cells in one or more of the images possibly appearing to be joined together in cellular clumps and one or more of the nuclear objects in one or more of the images possibly appearing to be joined together in nuclear object clumps; (c) automatically determining the outlines of the cells in the sample or portion thereof from the image data using means that can resolve cellular clumps into individual cells with an error rate no greater than 20%; (d) automatically determining the outlines of the nuclear objects in the sample or portion thereof from the image data using means that can resolve nuclear object clumps into individual nuclear objects with an error rate no greater than 20%; (e) automatically determining which of the nuclear objects are nuclei and which of the nuclear objects are micronuclei; (f) automatically determining which of the nuclei are within the cells; (g) automatically determining which of the cells are binucleated; (h) automatically determining which of the micronuclei are within the cells; and (i) automatically determining whether the binucleated cells contain micronuclei.

In another aspect, the invention concerns a process for assessing the clastogenicity and/or aneugenicity of a stimulus using cells that normally contain nuclei and cytoplasm, there being a sample or portion thereof containing such cells that have been exposed to the stimulus under predetermined conditions and at least some of the cells in the sample or portion thereof having become binucleated, the sample being treated to highlight the presence of the cytoplasm and to highlight the presence of nuclear objects, nuclei and micronuclei being nuclear objects, and one or more images of the sample or portion thereof showing the resulting highlighting having been collected, the one or more images comprising image data, there being image data for a plurality of locations within each of the one or more images, there being a preselected frequency of micronuclei in binucleated cells above which a stimulus to which such cells have been exposed under predetermined conditions is assessed as being clastogenic and/or aneugenic, the process comprising the steps of:
(a) performing the foregoing process to determine how many micronuclei are within the binucleated cells in the sample or portion thereof; (b) calculating an experimental micronuclei frequency for the sample or portion thereof using the number of micronuclei determined in step (a) to be in the binucleated cells in the sample or portion thereof; and (c) comparing the experimental micronuclei frequency from step (b) with the preselected frequency and assessing the stimulus as being clastogenic and/or aneugenic if the resulting value from step (b) is above the preselected frequency.

In another aspect, the invention concerns an automated process for determining the presence of micronuclei within cells in a sample or portion thereof, the cells normally containing nuclei and cytoplasm, the nuclei and micronuclei being nuclear objects, the sample or portion thereof being treated to highlight the presence of the cytoplasm and to highlight the presence of nuclear objects, and one or more images of the sample or portion thereof showing the resulting highlighting having been collected, each of the one or more images comprising image data, there being image data for a plurality of locations within each of the one or more images, one or more of the cells in one or more of the images possibly appearing to be joined together in cellular clumps and one or more of the nuclear objects in one or more of the images possibly appearing to be joined together in nuclear object clumps, the process comprising the steps of:
(a) automatically determining the outlines of the cells in the sample or portion thereof from the image data using means that can resolve cellular clumps into individual cells with an error rate no greater than 20%; (b) automatically determining the outlines of the nuclear objects in the sample or portion thereof from the image data using means that can resolve nuclear object clumps into individual nuclear objects with an error rate no greater than 20%; (c) automatically determining which of the nuclear objects are nuclei and which of the nuclear objects are micronuclei; and (d) automatically determining which of the cells contain micronuclei.

In another aspect, the invention concerns an automated process for determining the presence of micronuclei within cells in a sample or portion thereof, the cells normally containing nuclei and cytoplasm, the nuclei and micronuclei being nuclear objects, the sample or portion thereof being treated to highlight the presence of the cytoplasm and to highlight the presence of nuclear objects, and one or more images of the sample or portion thereof showing the resulting highlighting having been collected, each of the one or more images comprising image data, there being image data for a plurality of locations within each of the one or more images, one or more of the cells in one or more of the images possibly appearing to be joined together in cellular clumps and one or more of the nuclear objects in one or more of the images possibly appearing to be joined together in nuclear object clumps, the process comprising the steps of:
(a) automatically determining the outlines of the cells in the sample or portion thereof from the image data using means that can resolve cellular clumps into individual cells with an error rate no greater than 20%; (b) automatically determining the outlines of the nuclear objects in the sample or portion thereof from the image data using means that can resolve nuclear object clumps into individual nuclear objects with an error rate no greater than 20%; (c) automatically determining which of the nuclear objects are nuclei and which of the nuclear objects are micronuclei; and (d) using the results of the steps (a), (b), and (c), automatically identifying the cells that contain micronuclei.

In another aspect, the invention concerns an automated process for determining the presence of micronuclei within cells in a sample or portion thereof, the cells normally containing nuclei and cytoplasm, the nuclei and micronuclei being nuclear objects, the process comprising the steps of:
(a) treating the sample or portion thereof to highlight the presence of the cytoplasm and to highlight the presence of nuclear objects; (b) collecting one or more images of the sample or portion thereof showing the resulting highlighting, each of the one or more images comprising image data, there being image data for a plurality of locations within each of the one or more images, one or more of the cells in one or more of the images possibly appearing to be joined together in cellular clumps and one or more of the nuclear objects in one or more of the images possibly appearing to be joined together in nuclear object clumps; (c) automatically determining the outlines of the cells in the sample or portion thereof from the image data using means that can resolve cellular clumps into individual cells with an error rate no greater than 20%; (d) automatically determining the outlines of the nuclear objects in the sample or portion thereof from the image data using means that can resolve nuclear object clumps into individual nuclear objects with an error rate no greater than 20%; (e) automatically determining which of the nuclear objects are nuclei and which of the nuclear objects are micronuclei; and (f) automatically determining which of the micronuclei are within the cells.

In another aspect, the invention concerns a process for assessing the clastogenicity and/or aneugenicity of a stimulus using cells that normally contain nuclei and cytoplasm, there being a sample or portion thereof containing such cells that have been exposed to the stimulus under predetermined conditions, the sample or portion thereof being treated to highlight the presence of the cytoplasm and to highlight the presence of nuclear objects, nuclei and micronuclei being nuclear objects, and one or more images of the sample or portion thereof showing the resulting highlighting having been collected, the one or more images comprising image data, there being image data for a plurality of locations within each of the one or more images, there being a preselected frequency of micronuclei in cells above which a stimulus to which such cells have been exposed under predetermined conditions is assessed as being clastogenic and/or aneugenic, the process comprising the steps of: (a) performing the foregoing process to determine how many micronuclei are within the cells in the sample or portion thereof; (b) calculating an experimental micronuclei frequency for the sample or portion thereof using the number of micronuclei determined in step (a) to be in the cells in the sample or portion thereof; and (c) comparing the experimental micronuclei frequency from step (b) with the preselected frequency and assessing the stimulus as being clastogenic and/or aneugenic if the resulting value from step (b) is above the preselected frequency.

In another aspect, the invention concerns an automated process for determining the presence and/or size and/or shape and/or location of target objects inside or outside cells in a sample or portion thereof, the cells normally comprising cytoplasm, the sample or portion thereof being treated to highlight the presence of cytoplasm and to highlight the presence of the target objects, one or more images of the sample or portion thereof showing the resulting highlighting having been collected, each of the one or more images comprising image data, there being image data for a plurality of locations within each of the one or more images, one or more of the cells in one or more of the images possibly appearing to be joined together in cellular clumps and one or more of the target objects in one or more of the images possibly appearing to be joined together in target object clumps, the process comprising the steps of:
(a) automatically determining the outlines of the cells in the sample or portion thereof from the image data using means that can resolve cellular clumps into individual cells with an error rate no greater than 20%; (b) automatically determining the outlines of the target objects in the sample or portion thereof from the image data using means that can resolve target object clumps into individual target objects with an error rate no greater than 20%; and (c) automatically determining which of the target objects are within the cells and/or the size and/or shape and/or location of the target objects.

In another aspect, the invention concerns an automated process for determining the presence and/or size and/or shape and/or location of target objects inside or outside cells in a sample or portion thereof, the cells normally containing cytoplasm, the process comprising the steps of:
(a) treating the sample or portion thereof to highlight the presence of the cytoplasm and to highlight the presence of target objects; (b) collecting one or more images of the sample or portion thereof showing the resulting highlighting, each of the one or more images comprising image data, there being image data for a plurality of locations within each of the one or more images, one or more of the cells in one or more of the images possibly appearing to be joined together in cellular clumps and one or more of the target objects in one or more of the images possibly appearing to be joined together in target object clumps; (c) automatically determining the outlines of the cells in the sample or portion thereof from the image data using means that can resolve cellular clumps into individual cells with an error rate no greater than 20%; (d) automatically determining the outlines of the target objects in the sample or portion thereof from the image data using means that can resolve target object clumps into individual target objects with an error rate no greater than 20%; and (e) automatically determining which of the target objects are within the cells and/or the size and/or shape and/or location of the target objects.

In another aspect, the invention concerns a process for assessing the presence and/or state of a disease, condition, syndrome, or stimuli-induced effect using cells that normally contain cytoplasm, there being a sample or portion thereof containing such cells that have been treated to highlight the presence of the cytoplasm and to highlight the presence of target objects whose abnormality is indicative of the disease, condition, syndrome, or stimuli-induced effect, one or more images of the sample or portion thereof showing the resulting highlighting having been collected, the one or more images comprising image data, there being image data for a plurality of locations within each of the one or more images, the process comprising the steps of:
(a) performing the foregoing process to determine the presence of target objects in the sample or portion thereof and/or the size and/or shape and/or location of the target objects inside or outside the cells; (b) assessing the presence and/or state of the disease, condition, syndrome, or stimuli-induced effect based on the presence or absence of target objects inside or outside the cells in the sample or portion thereof and/or the size and/or shape and/or location of the target objects inside or outside the cells.

In some preferred embodiments, the step of automatically determining the outlines of the cells from the image data uses means that can resolve cellular clumps into individual cells with an error rate no greater than 10%, 5%, or even less, and the step of automatically determining the outlines of the target objects (e.g., nuclear objects) from the image data uses means that can resolve target object clumps into individual target objects with an error rate no greater than 10%, 5%, or even less. In some preferred embodiments, the means for resolving cellular clumps into individual cells and the means for resolving target object clumps into individual target objects (e.g., nuclear objects or nuclei) employs thinning, pruning, erosion, dilation, contour-based segmentation, distance mapping, watershed splitting, non-watershed splitting, tophat transform, nonlinear Laplacian transform, dot label methods, or combinations thereof. In some preferred embodiments, the means for resolving cellular clumps into individual cells uses a target objects (e.g., nuclear objects or nuclei) influence zone diagram and the means for resolving target object (e.g., nuclear objects or nuclei) clumps into individual target objects uses watershed splitting. In some preferred embodiments, creating a target objects influence zone comprises determining which target objects are connected or are sufficiently close to be assumed to be within the same cell using a close and erosion process, a gating procedure based on perimeter convex, and a thinning and pruning operation.

As used herein, “cells” typically refers to eucaryotic cells, i.e., cells having a nucleus and cytoplasm. The cells may be cells taken from any part of an organism (e.g., plant or animal, e.g., mammal, e.g., human) and processed according to the present invention, for example, to determine whether target objects that should not be present are in fact present (e.g., lipid droplets in liver cells). The cells may also be cells that are purposely exposed to (e.g., incubated with) an external stimulus (e.g., a chemical) to determine if any abnormalities (e.g., production of micronuclei) are caused by the chemical (e.g., breakage or omission of genetic material from the nucleus in a daughter cell).

“Cells in a sample or portion thereof” and the like refer to any sample or portion thereof containing cells, whether in suspension or otherwise. For example, the cells could be present in a microwell on a microwell plate either with or without liquid present.

“To highlight” and the like refer to using any means that directly or indirectly helps indicate the thing (e.g. cytoplasm, nuclear objects or other target objects) and includes using energy means, physical means, chemical means, and combinations thereof (for example, staining and/or electromagnetic energy, e.g., light, whether or not the highlighting is visible to the naked eye). The highlighting directly or indirectly indicates the presence of the thing and/or its size and/or shape and/or location, and “the presence of the thing” includes whether the thing is absent or whether one or more of the things are present. If any of the things are present, the highlighting allows a determination of how many of the things there are and/or their sizes and/or shapes and/or locations.

“The sample or portions thereof being treated to highlight the presence of” a thing (e.g., cytoplasm, nuclear objects, or other target objects) includes (a) pretreating the sample or portions thereof by chemical, physical, or other means before collecting one or more images of or from the sample or portions thereof, as well as
(b) collecting an image of or from the sample or a portion thereof using means that highlight (i.e., indicates) the presence of the thing at the time the image is collected (e.g., using electromagnetic energy of a certain frequency that causes the target to emit certain electromagnetic wave or fluoresce or appear to be a given color or in some other way signal its presence or appear in contrast to other things in the image).

“To highlight the presence of the cytoplasm” and the like should be broadly understood and refer to highlighting the cytoplasm itself and/or highlighting other features of the cell whose presence indicates the extent of the cell (e.g., staining the outer cellular membrane, which encircles the cytoplasm).

“To highlight the presence of nuclear objects” and the like should be broadly understood and refer to highlighting the nuclear objects themselves and/or highlighting other features of the cell whose presence indicates the presence of nuclear objects (e.g., staining nuclear membranes or nuclear envelopes, which encircle the nuclear objects). Micronuclei are nuclear objects.

“To highlight the presence of target objects” and the like should be broadly understood and refer to highlighting the target objects themselves and/or highlighting other features of the cell whose presence indicates the presence of target objects (e.g., staining a specific antibody that binds to and thus recognizes, i.e., indicates the presence of, the target objects inside or outside a cell). Micronuclei are one type of target object.

“Image data representing” a thing include image data directly or indirectly indicating the thing. For example, image data representing the cytoplasm include image data directly indicating the cytoplasm (e.g., if the cytoplasm is itself stained) as well as image data indicating the outer cell membrane or any other feature that indirectly indicates the cytoplasm even if the cytoplasm itself is not highlighted (e.g., stained).

“Image data” are data indicating the color, black, or white values (e.g., intensity) for locations within the image (e.g., pixels). The image is typically stored at least temporarily for further processing (e.g., stored in computer memory and/or on a storage device). A “location” within the image will generally be any addressable portion of the image (e.g., using x-axis/y-axis coordinates for a two-dimensional image) and usually will be a single pixel or a group of contiguous pixels.

The term “nuclear objects image data” should be broadly understood and refers to image data representing the nuclear objects (e.g., nuclei) or image data representing other features that indicate the extent of the nuclei (e.g., nuclear membranes or nuclear envelopes, which encircle nuclear objects).

The term “target objects image data” should be broadly understood and refers to image data representing the target objects or image data representing other cellular features that indicate the extent of the target objects.

The term “cytoplasm image data” should be broadly understood and refers to image data representing the cytoplasm or image data representing other cellular features that indicate the extent of the cell (e.g., the outer cellular membrane, which encircles the cytoplasm).

In appropriate cases, the terms “diagram,” “mask,” and the like refer to (i) the underlying image data or information, which if put onto a surface (e.g., a piece of paper or the screen of a computer monitor) would produce a drawing, graph, illustration, chart, or the like visible to the naked eye, or (ii) the drawing, graph, illustration, chart, or the like, or (iii) both (i) and (ii). Thus, terms containing “diagram,” “mask,” and the like (e.g., “nuclei influence zone diagram,” “Voronoi diagram,” “binary mask,” and the like) may refer just to the image data underlying the diagram, mask, or the like, whether or not those data are put onto any surface.

The term “cell outline” should be broadly understood, refers to the outer cell boundary of each cell, and is defined or constituted by the image data representing those boundaries. In other words, the “cell outline” encircles the cell and thereby also defines the spaces and locations between adjacent cells. The cell outline may be thought of as being consistent with the outer surface of the cellular membrane. The terms “extracellular space,” “extracellular region,” and the like (also referred to as “intercellular space” or “intercellular region”) refer to the spaces and locations between cells and therefore between cell outlines.

“Inside a cell,” “intracellular,” “intracellular space,” “intracellular region,” and the like refer to the cellular membrane and what is contained within it (e.g., cytoplasm, nucleus). Determining the presence of a target object in the cellular membrane layer itself is considered to be determining the presence of a target object “inside a cell.” “Outside a cell” and the like refer to what is outside the cell's cellular membrane (i.e., what is in the extracellular or intercellular space). The terms “extranuclear space,” “extranuclear region,” “extranuclei space,” “extranuclei region,” and the like refer to what is outside the nucleus or nuclei.

The terms “intra-object space” and the like refer to what is inside objects (e.g., cells). The terms “extra-object space” and the like refer to what is outside objects (e.g., target objects).

A “binucleated” cell contains more than one nucleus. Depending on the particular standard or algorithm used, a cell having three or more nuclei may be counted as just a single binucleated cell or as more than one binucleated cell. For example, a cell having four nuclei may be counted as one binucleated cell or as two binucleated cells depending on the standard or algorithm being used.

“Disease, condition, or syndrome” is meant broadly and includes any predisposition, biomarker, pathology or other problem that can be diagnosed or otherwise determined by or from cellular abnormalities such as the abnormal presence in the cells of things not normally present in the cells, or by the abnormal absence from the cells of things normally present in the cells, or by the presence in the cells of things normally present but in abnormal amounts (a greater than normal or lower than normal number), or by the presence in the cells of things normally present but in abnormal shapes or abnormal sizes (larger than normal or smaller than normal) or abnormal locations, or by any combination of the foregoing (each of the foregoing being an “abnormality” and two or more collectively being “abnormalities”). The diseases, conditions, and syndromes may result from known or unknown causes and may be caused by cellular aging or by any type of agent, such as chemical and/or physical and/or energy (e.g., ultraviolet radiation, carcinogenic chemicals). The diseases, conditions, and syndromes may result from the side effects of drug candidates.

“The presence and/or state of a disease, condition, or syndrome” is meant broadly and refers to whether the disease, condition, or syndrome is or is not present and, if present, its state. The “state” of a disease, condition, or syndrome is meant broadly and thus includes, for example, the stage and degree of severity of the disease, condition, or syndrome. Accordingly, determining the state of a disease, condition, or syndrome allows monitoring the progression of the disease, condition, or syndrome and/or monitoring the course of therapy. Determining the state of a disease, condition, or syndrome allows determination of the therapeutic effects and side effects (if any) of drug candidates.

“Target objects whose abnormality in cells is indicative of the disease, condition, or syndrome” includes any type of target object (e.g., micronuclei, starch granules, lipid droplets, protein inclusions, hot spots, cold spots) and any type of abnormality that may be determined by the present invention, including the target object being present in the cells in abnormal amounts (more than normal or less than normal numbers), and/or abnormal sizes (larger than normal or smaller than normal sizes), and/or abnormal shapes, and/or abnormal locations.

“Stimulus,” “stimuli,” “agent,” “agents,” and the like are meant broadly, may be used interchangeably, and refer to any energy (e.g., ultraviolet radiation) and matter (e.g., chemicals) to which cells can be exposed. For example, cells can be exposed to a drug candidate to determine (or study) the therapeutic effects and side effects of the drug candidate.

The term “stimuli-induced effects” is meant broadly and includes any effects of a single external stimulus or multiple external stimuli, for example, any and all forms of chemical and/or physical and/or energy stimuli (e.g., electromagnetic radiation such as ultraviolet radiation, infrared radiation, microwave radiation, visible light), heat, and chemicals.

The term “chemical-induced effects” is meant broadly and includes any effects of one or more chemicals, e.g., desired therapeutic as well as undesired side effects of a chemical, e.g., a drug or drug candidate. Chemical-induced effects are a type of stimuli-induced effects.

The method of this invention can, at a “very low error rate,” resolve clumps of objects into individual objects. In other words, the method of this invention can, at a “very low error rate,” resolve “cellular clumps” into individual cells (thereby allowing the outlines of the cells in the sample to be determined) and resolve “target object clumps” (e.g., “nuclear object clumps”) into individual targets (thereby allowing the outlines of the target objects in the sample to be determined). Thus, the method of this invention can, at a “very low error rate,” resolve “nuclear object clumps” into individual nuclear objects (thereby allowing the outlines of the nuclear objects in the sample to be determined). By a “very low error rate” is meant an error rate of no greater than 20%, generally no greater than 10%, often no greater than 8%, typically no greater than 6%, preferably no greater than 5%, more preferably no greater than 4%, and most preferably no greater than 3%. The error rate is equal to the Number Of Errors divided by Actual Number. The “Actual Number” is the number of individual objects (e.g., cells or target objects such as micronuclei) actually present in a volume or its two-dimensional representation (e.g., a field). Typically, the “Actual Number” is determined by visual inspection and manual counting of the sample and target objects within the sample because the manual method is regarded as the “Gold Standard.” The “Number Of Errors” is the number of errors made by the method of this invention, an error being splitting an object (e.g., a cell, a nuclear object) present in a volume or its two-dimensional representation when it should not have been split or not splitting two objects (e.g., cells, nuclei) present in a volume or its two-dimensional representation when they should have been split.

The method of the present invention can automatically, rapidly, and accurately screen large numbers of cells for the presence of micronuclei and in some cases also determine the “micronuclei rate.” The method of the present invention can also automatically, rapidly, and accurately screen large numbers of cells for the presence of other targets inside or outside of cells and/or for the size of the targets and/or their shape and/or location. The abnormal presence, absence, size, shape, and/or location of those target objects is indicative of a variety of diseases, conditions, syndromes, and stimuli-induced effects. The invention can be applied to the fields of medical diagnostics, drug efficacy screening, and drug toxicity screening.

Another advantageous feature of this invention is that it is “automatic” or “automated,” by which is meant that all of the images needed to cover the enter volume (e.g., well in a microplate) can be obtained substantially without operator intervention and then analyzed (processed), again substantially without operator intervention, to yield the required answers. The process's being “automatic” or “automated” may also include the operator's being able to place the microwell plates (or other containers in which the cells are interrogated to yield the images) in a feeder and then having the associated apparatus automatically (i.e., substantially without operator intervention) sequentially and repetitively place them in position for image acquisition. Thus, a first microwell plate could automatically be moved into position and then the camera or the plate could automatically be moved to acquire all of the required images for the entire well (e.g., images of 40 or 50 separate fields), after which the camera or plate could automatically be moved to acquire all of the required images for the next well, and so forth. After all the wells on that plate had automatically been imaged, the plate could automatically be moved out of position and the next microwell plate would automatically be taken from the feeder and automatically put into position and the process repeated until all wells of all plates had been automatically imaged, after which they would be automatically analyzed.

The many other features and advantages of the present invention will be apparent to those skilled in the art from this disclosure.

### BRIEF DESCRIPTION OF THE DRAWINGS

To aid further discussion of the present invention, the following drawings are provided in which:

FIG. 1 is a block diagram of a process of this invention, which shows in block format the equipment that may be used to implement the process;

FIG. 2 illustrates a microplate and a multi-well slide, each of which may be used in a process of this invention;

FIG. 3 illustrates a preferred user computer interface when the image acquisition portion of this invention is implemented using the preferred automated microscope;

FIG. 4 is a block diagram showing the principal steps in a preferred embodiment of the image data analysis part of this invention;

FIG. 5 is a greyscale rendition of a first digital photographic image showing clustered or clumped or aggregated groups (i.e., “clumps”) of cells and unclustered or unclumped or unaggregated cells (cells treated with Cytochalasin B) in which the cytoplasmic material has been stained;

FIG. 6 is a greyscale rendition of a digital photographic image of the same cells as shown in FIG. 5 but with the nuclear material stained instead of the cytoplasm;

FIG. 7 is an image resulting from processing the image data of FIG. 5 by converting the cytoplasm image data to 8-bit, inverting, and applying an automatic threshold;

FIG. 8 is a binary image resulting from processing the image data of FIG. 7 so that the resulting cells have a value of 1 (bright) and the background has a value of 0 (dark);

FIG. 9 is a greyscale rendition of the image data of FIG. 6 after conversion to 8-bit;

FIG. 10 is a greyscale image resulting from inverting the image of FIG. 9 and in which nuclei appear dark and the background appears bright;

FIG. 11 is a processed image showing the results of applying an automatic threshold to the image data of FIG. 9 and applying a first gate based on perimeter convex to select binuclei that are already connected or touching each other;

FIG. 12 is a processed image showing the results of applying an automatic threshold to the image data of FIG. 9 and applying a second gate based on perimeter convex to select non-connected nuclei;

FIG. 13 results from applying a slight close and erosion process to the image data of FIG. 12 to connect nearby nuclei that are from the same cell (i.e., cells that are binucleated);

FIG. 14 is derived from FIG. 13 and shows the “connected” nuclei of FIG. 13 isolated based on perimeter convex;

FIG. 15 is derived from that portion of the image of FIG. 12 remaining after the first close and erosion process (FIGS. 13 and 14) and results from applying a slight dilation, close, and erosion process to connect any remaining nearby nuclei (i.e., nuclei from the same binucleated cells);

FIG. 16 is derived from FIG. 15 and shows the “connected” nuclei of FIG. 15 isolated based on perimeter convex;

FIG. 17 is an image resulting from combining the processed nuclei of FIGS. 11 (first gating) and 14 (second gating);

FIG. 18 is an image resulting from combining the processed nuclei of FIGS. 15, 16, and 17;

FIG. 19 is an image resulting from inverting the image of FIG. 18 so that processed nuclei appear dark and the background appears bright;

FIG. 20 is a “nuclei influence zone” image resulting from applying a thinning and pruning filter to the image data of FIG. 19;

FIG. 21 is an image resulting from inverting the image of FIG. 20 and it shows the inverted nuclei influence zones;

FIG. 22 is an image resulting from applying a Boolean AND between FIGS. 8 (cytoplasm binary mask) and 21 (inverted nuclei influence zones), resulting in a cell-by-cell outline;

FIG. 23 is an image resulting from thresholding and watershed splitting the image data of FIG. 10 to separate nuclear clumps and then combining with the cell-by-cell outline of FIG. 22;

FIG. 24 is combined image resulting from imposing micronuclei (determined by gating FIG. 6 based on size) on FIG. 23;

FIG. 25 is a greyscale rendition of a second digital photographic image showing clustered or clumped groups or aggregated (i.e., “clumps”) of cells and unclustered or unclumped or unaggregated cells (cells not treated with Cytochalasin B) in which the cytoplasmic material has been stained;

FIG. 26 is a greyscale rendition of a digital photographic image of the same cells as shown in FIG. 25 but with the nuclear material stained instead of the cytoplasm;

FIG. 27 is an image resulting from processing the image data of FIG. 25 by converting the cytoplasm image data to 8-bit, inverting, and applying an automatic threshold;

FIG. 28 is a binary image resulting from processing the image data of FIG. 27 so that the resulting cells have a value of 1 (bright) and the background has a value of 0 (dark);

FIG. 29 is a greyscale rendition of the image data of FIG. 26 after conversion to 8-bit;

FIG. 30 is a greyscale rendition resulting from inverting the image of FIG. 29 and in which nuclei appear dark and the background appears bright;

FIG. 31 is a processed image of the nuclear material showing the results of applying an automatic threshold to outline the nuclei;

FIG. 32 is an image resulting from applying a binary mask to the image data of FIG. 31 (nuclei have a value of 1 (bright) and the background has a value of 0 (dark)), gating out the micronuclei based on size, and watershed splitting to separate connecting nuclei;

FIG. 33 is an image resulting from inverting the image data of FIG. 32 and in which the nuclei have a value of 0 (dark) and the background has a value of 1 (bright);

FIG. 34 is a “nuclei influence zone” image resulting from applying a thinning and pruning filter to the image data of FIG. 33;

FIG. 35 is an image resulting from inverting the image of FIG. 34 and it shows the inverted nuclei influence zones;

FIG. 36 is an image resulting from applying a Boolean AND between FIGS. 28 (cytoplasm binary mask) and 35 (inverted nuclei influence zone image), resulting in a cell-by-cell outline;

FIG. 37 is an image resulting from thresholding, watershed splitting, and applying a gate to FIG. 26 to gate out the large apoptotic nuclei and the micronuclei based on size;

FIG. 38 is an image resulting from applying a binary mask to the image data of FIG. 37;

FIG. 39 is a combined image of the cell-by-cell outline (FIG. 36) and normal nuclei (from FIG. 38); and

FIG. 40 is combined image of the cell-by-cell outline (FIG. 36), normal nuclei (FIG. 37), and micronuclei.

These drawings are for illustrative purposes only and should not be used to unduly limit the scope of the present invention.

### DETAILED DESCRIPTION OF THE INVENTION

The processes of this invention may be used to identify the presence or absence of target objects inside or outside the cells of a cell sample or portion thereof. The cell outlines are identified, typically by highlighting their cytoplasm, collecting the highlighted cytoplasm image data, and analyzing the data. The target objects are identified typically by highlighting them, collecting the highlighted target object image data, and analyzing the image data. If target objects are present, the process can determine their size and/or shape and/or location (inside or outside of the cells). By determining the presence or absence of target objects and their size, shape, and/or other characteristics if the target objects are present, the diagnosis or assessment of a disease, condition, syndrome, or stimuli-induced effect may be accomplished. For example, the presence of fat droplets in liver cells indicates fatty liver disease or steatosis (fat droplets are not supposed to be present in a healthy liver). The process may also be used to determine the effect of chemical, physical, energy, and other stimuli (agents) on cells. For example, after Chinese hamster ovary cells have been exposed to a chemical agent under controlled conditions and allowed to undergo nuclear division, the number of micronuclei detected in the cell sample allows calculation of the micronuclei frequency, which indicates whether the chemical agent has a clastogenic and/or aneugenic effect on cells. That in turn may be used to assess whether the chemical is likely to be carcinogenic. Thus, among the many possible uses for the process of this invention are assessing whether a patient has a particular disease, condition, syndrome, or chemical-induced (e.g., drug-induced) effect by analyzing the appropriate cells from the patient and assessing whether a particular chemical (e.g., a drug candidate) or other agent is likely to be carcinogenic.

When determining the presence or absence of target objects in the spaces or locations between adjacent cells of a cell sample (i.e., the extracellular or intercellular space), the cell outlines are identified, typically by highlighting their cytoplasm, collecting the highlighted cytoplasm image data, and analyzing the data. The spaces or locations between adjacent cells of a cell sample, typically not highlighted, are derived by inverting the resulting image data. The target objects are identified by highlighting them, collecting the highlighted target object image data, and analyzing the image data. A determination is made by the process as to whether the target objects are located in the extracellular space between adjacent cells. If target objects are present, the process can determine their size and/or shape and/or location. By determining the presence or absence of target objects in the extracellular space and their size, shape, and/or other characteristics, the diagnosis or assessment of a disease, condition, syndrome, or stimuli-induced effect may be accomplished. For example, the absence or decreased presence of bile salts in the bile canaliculi between adjacent hepatocytes indicates decreased bile uptake and/or efflux in hepatocytes, which is indicative of intrahepatic cholestasis disease. The process of this invention may also be used to determine the effect of chemical, energy, and other stimuli on cells (including on their cell-to-cell junctions). For example, after confluent Caco-2 human colon carcinoma cells, MDCK dog kidney cells, LLC-PK1 pig kidney cells, HepG2 human liver cells, or human hepatocytes have been exposed to a chemical (a chemical stimulus) under controlled conditions, the changes in the size and/or shape and/or location of the extracellular spaces between adjacent cells of a cell sample are indicative of the disruptive effects of the chemical on cell-to-cell contact.

The processes can be used with any type of cell and any type of target that allows the benefits of the invention to be obtained. The cells will typically be eucaryotic cells, i.e., cells having a nucleus and cytoplasm. The cells may be cells normally present in an organism that are removed to determine if target objects of interest are present in the organism's cells, or the cells may be cells maintained for testing the effect of external stimuli. Examples of the first type of cells from animals (e.g., humans) include liver cells, brain cells, kidney cells, lung cells, eye cells, blood cells, brain cells, skin cells, and intestine cells. Cells from plants may also be used. Suitable examples of the second type of cells include Chinese hamster ovary cells, Chinese hamster lung cells, V79 Chinese hamster fibroblasts, mouse lymphoma cells (e.g., L5178Y), human leukemic cells (e.g., HL-60, U937), Caco-2 human colon carcinoma cells, MDCK dog kidney cells, LLC-PK1 porcine kidney cells, baby hamster kidney (BHK) cells, HEK293 human kidney cells, COS monkey cells, HepG2 human liver cells, HEK cells, primary rat and human hepatocytes, liver cell lines, cholangiocytes, HeLa human cervical cancer cells, MCF-7 human breast cancer cells, MDA-MB breast cells, PC3 prostate cells, A459 lung cells, NIH 3T3 cells, retinal pigment epithelial cells, human lens epithelial cells, macrophages, alveolar pneumocytes, endothelial cells, primary microvessel cells, and leukocytes. Still other types of cells of either type may be used.

Target objects include any cellular component material, organelle, body, or chemical inside or outside the cell that can be highlighted. Possible target objects include, but are not limited to, cellular DNA, nuclei, nuclear fragments, micronuclei, cytoplasm, cellular membrane, lysosomes, peroxisomes, ribosomes, phagosomes, endosomes, Golgi complexes, microbodies, granules, lamellar bodies, vacuoles, vesicles, clathrin-coated vesicles, Golgi vesicles, small membrane vesicles, secretory vesicles, centrioles, endoplasmic reticulum, mitochondria, respirating mitochondria, resting mitochondria, membranes, cilia, rod outer segments, cones, microtubules, microfilaments, actin filaments, intermediate filaments, cytoskeletons, cytoplasm, carbohydrates, glycogen, glucose, monosaccharides, disaccharides, polysaccharides, amino acids, peptides, proteins, enzymes, transporters, receptors, channels, ion channels, pumps, synapses, neurotransmitters, glycoproteins, lipoproteins, antibodies, antigens, insulins, hormones, lipids, phospholipids, fatty acids, cholesterol, triglycerides, glycerol, glycolipids, isoprenoids, steroids, sterols, steroid hormones, bile salts, bile acids, nucleic acids, nucleotides, DNA, RNA, mRNA, tRNA, rRNA, DNA probes, RNA probes, nucleus, nucleolus, apoptotic bodies, mitotic bodies, chromosomes, chromosome fragments, spindles, kinetochores, centromeres, endogenous molecules, reactive oxygen species, reactive nitrogen species, antioxidants, thiols, glutathione, amines, xenobiotics, bacteria, virus, fungus, chemicals, pigments, xenobiotic residues, ingested nutrients, vitamins, ingested foreign objects or particles, endocytized foreign objects or particles, phagocytized foreign objects or particles, and infiltrated cells. Preferred target objects are cellular DNA, nuclei, micronuclei, cytoplasm, glycogen granules, lipids, phospholipids, phagocytized material, bile acids, bile salts, and mitochondria.

The detection of the presence or absence of certain target objects inside or outside cells in a cellular sample and the characteristics of the target objects (if present) can be used to diagnose or assess a condition, disease, syndrome, or stimuli-induced effect. Some diseases, conditions, syndromes, or stimuli-induced effects are indicated by the mere presence within the cells (or extracellular space) of target objects that should not be present (e.g., fat droplets in liver cells, bile salts precipitates in liver cells). Some diseases, conditions, syndromes, or stimuli-induced effects are indicated by the absence from the cells or extracellular space of target objects that should be present (e.g., rod outer segment proteins in retinal pigment epithelial cells, bile salts in bile canaliculi between hepatocytes). Other diseases, conditions, syndromes, or stimuli-induced effects are indicated when the target objects are determined to be present in the cells or extracellular space in numbers or at a frequency greater than a predetermined value (e.g., micronuclei in blood cells, peroxisomes in liver cells). Still other diseases, conditions, syndromes, or stimuli-induced effects are indicated when the target objects are determined to be present in the cells or extracellular space in numbers or at a frequency below a predetermined value (e.g., lipid surfactants in alveolar pneumocytes, bile salts in bile canaliculi). Other diseases, conditions, syndromes, or stimuli-induced effects are indicated when certain target objects are detected in cells or extracellular space but exhibit abnormal physical characteristics, such as abnormal size (e.g., enlarged lysosomes) or shape (e.g., abnormal length or thickness). Other diseases, conditions, syndromes, or stimuli-induced effects are indicated when the target objects are present in cells or extracellular space in locations in which they do not belong (e.g., glycogen inclusions in cell nuclei; foreign bacteria, virus, or chemical matter inside cells or cell nuclei). Still other diseases, conditions, syndromes, or stimuli-induced effects are indicated by a combination of one or more of the foregoing (e.g., micronuclei are target objects that can be identified as being micronuclei by their smaller than normal average size and that can indicate aneugenicity and/or clastogenicity when they are present in higher than normal frequency).

This invention concerns cellular imaging assays and, more specifically, cellular imaging assays for micronuclei and other target objects whose abnormal presence, abnormal absence, abnormal size, abnormal shape, and/or abnormal location inside or outside of cells is indicative of one or more conditions, diseases, syndromes, or stimuli-induced (e.g., chemical-induced) effects. Even more specifically, this invention concerns methods to automatically score individual cell features (e.g., micronuclei) even if the features and/or cells are aggregated.

The need to rapidly and accurately screen large numbers of chemicals and other stimuli (e.g., energy sources) for a variety of reasons has increased. Thus, candidates being considered for use as drugs must be rapidly and accurately screened to determine their carcinogenicity, and such candidates must be screened in ever increasing numbers because so many more candidates are available (e.g., from combinatorial synthesis methods). For example, one screen for carcinogenicity of drug candidates involves detecting whether they cause micronuclei formation.

Micronuclei are small “packets” of genetic material that form during cellular (and therefore nuclear) reproduction inside a cell and are separate from the cell nucleus. Micronuclei originate during the last phase of nuclear division (i.e., anaphase) from lagging chromosome fragments (because of DNA strand breakage) or whole chromosomes (because of spindle, kinetochore, or centromere damage). The “micro” portion of the word “micronuclei” refers to the packets of genetic material being smaller than normal nuclei (these small packets are typically considered to be micronuclei if they are less than one-third the average size of the nucleus of the cell in question). The frequency of micronuclei formation should be zero in perfectly healthy cells that are not subjected to any external influences that adversely affect chromosome integrity; whereas, naturally occurring chromosomal damage and chemical, physical, and other stimuli (e.g., ultraviolet radiation) can result in micronuclei formulation.

If during mitosis, that is occurring as part of cellular reproduction, an external stimulus, such as a chemical causes breakage of chromosomes (i.e., the chemical is clastogenic), or causes omission of one or more chromosomes from the genome (i.e., the chemical is aneugenic), a separate nuclear membrane will typically form inside the parent or daughter cell around the broken off or omitted genetic material. Those micronuclei can be detected and the frequency at which the external stimulus causes micronuclei formation, e.g., in a statistically valid sample of cells (i.e., a micronuclei formation frequency), can be determined. Because of the relationship of clastogenicity and aneugenicity to carcinogenicity, and because of the need to screen chemicals to determine if they would be carcinogenic in vivo (e.g., to determine the safety of such chemicals if they are to be administered to a human or other animal), in vitro micronuclei assays for clastogenicity and/or aneugenicity have become useful (as predictors of the likelihood of carcinogenicity).

The time for eucaryotic cells to reproduce in vitro is typically measured in hours (e.g., from about 6 hours to about 48 hours), depending on the cell and the environment. This has led to the use of eucaryotic cells in assays for screening chemicals for their clastogenicity and/or aneugenicity. In such assays, a cell is chosen (e.g., Chinese hamster ovary cells, Chinese hamster lung cells, V79 Chinese hamster fibroblasts) and a sufficient number of cells (e.g., 1000 to 5000) are incubated under preselected conditions with the chemical to be tested. Chemicals may be added to prevent cellular division while allowing nuclear division (e.g., Cytochalasin B). That is, Cytochalasin B blocks cytokinesis. Broadly speaking, after a sufficient amount of time, cells containing more than one nucleus (i.e., binucleated cells) and micronuclei are detected (typically visually by a technician). Binucleation in a cell treated to prevent nuclear division indicates that it has gone through at least one reproductive cycle (“binucleated,” “binucleation,” and the like refer to cells having at least two nuclei, and “mononucleated,” “mononucleation,” and the like refer to cells having one nucleus). Thus, the number of micronuclei in the binucleated cells can be determined and the micronuclei formation frequency calculated.

Until recently the only way to visually screen a sample for micronuclei within binucleated cells was manually (i.e., the technician slowly examining the sample under a microscope and counting the number of binucleated cells as well as the number of binucleated cells containing the micronuclei). As explained below, attempts to provide automated screening methods (e.g., using image analysis) have been made, but none of those methods has proved entirely satisfactory.

Because micronuclei originate from lagging chromosome fragments (from DNA strand breakage) or from whole chromosomes (from spindle, kinetochore, or centromere damage) at anaphase, which is the last phase of nuclear division, they can exist in cells only after the cells have completed nuclear division. Therefore, in a population of cells originally free of micronuclei and then treated with Cytochalasin B and allowed to go through a reproductive cycle, only those cells that are binucleated have undergone nuclear division. Consequently, only those binucleated cells could contain micronuclei. Thus, using Cytocalasin B allows identification of the sub-population of cells that have undergone nuclear division and, consequently, determination of the micronuclei frequency in that sub-population rather than in the entire population. Also, because one cannot differentiate never-divided mononucleated cells from once-divided mononucleated cells, not using Cytochalasin B (to make all cells that have reproduced be binucleated) can lead to erroneous results (e.g., false negative predictions on agents that damage chromosomes and also inhibit nuclear division to some extent). See Fenech, “A Mathematical Model Of The In Vitro Micronucleus Assay Predicts False Negative Results If Micronuclei Are Not Specifically Scored In Binucleated Cells Or In Cells That Have Completed One Nuclear Division,” Mutagenesis, volume 15, number 4, pages 329-336 (2000).

Analysis of tissue, cells, and/or cellular features (e.g., by analysis of their images) and mathematical (including graphical) methods are discussed in various documents, which are cited herein. See, e.g., U.S. Pat. Nos. 5,229,265, 5,644,388, 5,736,129, 5,858,667, 5,989,835, 6,100,038, 6,103,479, and 6,416,959; PCT Publications WO 00/50872, WO 00/72258, and WO 01/35072; Belien et al., “Confocal DNA Cytometry: A Contour-Based Segmentation Algorithm For Automated Three-Dimensional Image Segmentation,” Cytometry, volume 49, pages 12-21 (2002); Bigras et al., “Cellular Sociology Applied To Neuroendocrine Tumors Of The Lung: Quantitative Model Of Neoplastic Architecture,” Cytometry, volume 24, pages 74-82 (1996); Fenech, “A Mathematical Model Of The In Vitro Micronucleus Assay Predicts False Negative Results If Micronuclei Are Not Specifically Scored In Binucleated Cells Or In Cells That Have Completed One Nuclear Division,” Mutagenesis, volume 15, number 4, pages 329-336 (2000); Frieauff et al., “Automatic Analysis Of The In Vitro Micronucleus Test On V79 Cells,” Mutation Research, volume 413, pages 57-68 (1998); Harris et al., “Identification Of The Apical Membrane-Targeting Signal Of The Multidrug Resistance-Associated Protein 2 (MRP2/cMOAT),” Journal Of Biological Chemistry, volume 276, number 24, pages 20876-20881 (2001); Jensen et al., “Antisense Oligonucleotides Delivered To The Lysosome Escape And Actively Inhibit The Hepatitis B Virus,” Bioconjugate Chemistry, volume 13, pages 975-984 (2002); Malpica et al., “Applying Watershed Algorithms To The Segmentation Of Clustered Nuclei,” Cytometry, volume 28, pages 289-297 (1997); Nesslany et al., “A Micromethod For The In Vitro Micronucleus Assay,” Mutagenesis, volume 14, number 4, pages 403-410 (1999); Netten et al., “Fluorescent Dot Counting In Interphase Cell Nuclei,” Bioimaging, volume 4, pages 93-106 (1996); Ritter et al., Handbook of Computer Vision Algorithms in Image Algebra, 2^{nd} edition, particularly Chapter 4 (“Thresholding Techniques”), pages 137-153 (CRC Press LLC, 2001); Russ, The Image Processing Handbook, 3^{rd} edition, ISBN 0-8493-2532-3 (CRC Press, 1998); Smolewski et al., “Micronuclei Assay By Laser Scanning Cytometry,” Cytometry, volume 45, pages 19-26 (2001); Strohmaier et al., “Tomography Of Cells By Confocal Laser Scanning Microscopy And Computer-Assisted Three-Dimensional Image Reconstruction: Localization Of Cathepsin B In Tumor Cells Penetrating Collagen Gels In Vitro,” Journal Of Histochemistry And Cytochemistry, volume 45, number 7, pages 975-983 (1997); Stumm et al., “High Frequency Of Spontaneous Translocations Revealed By FISH In Cells From Patients With The Cancer-Prone Syndromes Ataxia Telangiectasia And Nijmegen Breakage Syndrome,” Cytogenetics And Cell Genetics, volume 92, pages 186-191 (2001); Styles et al., “Automation Of Mouse Micronucleus Genotoxicity Assay By Laser Scanning Cytometry,” Cytometry, volume 44, pages 153-155 (2001); Sudbo et al., “Caveats: Numerical Requirements In Graph Theory Based Quantitation Of Tissue Architecture,” Analytical Cellular Pathology, volume 21, pages 59-69 (2000); Sudbo et al., “New Algorithms Based On The Voronoi Diagram Applied In A Pilot Study On Normal Mucosa And Carcinomas,” Analytical Cellular Pathology, volume 21, pages 71-86 (2000); Verhaegen et al., “Scoring Of Radiation-Induced Micronuclei In Cytokinesis-Blocked Human Lymphocytes By Automated Image Analysis,” Cytometry, volume 17, pages 119-127 (1994); and Weyn et al., “Computer-Assisted Differential Diagnosis Of Malignant Mesothlioma Based On Syntactic Structure Analysis,” Cytometry, volume 35, pages 23-29 (1999). (All of the documents discussed or otherwise referenced herein are incorporated herein in their entireties for all purposes but none is admitted to be prior art.)

Some of the documents provided above concern dividing clusters of objects (e.g., nuclei) into subcomponents using, for example, watershed algorithms or other methods (e.g., tophat transform, nonlinear Laplacian transform, and dot label methods). See, e.g., Belien et al., “Confocal DNA Cytometry: A Contour-Based Segmentation Algorithm For Automated Three-Dimensional Image Segmentation,” Cytometry, volume 49, pages 12-21 (2002); Malpica et al., “Applying Watershed Algorithms To The Segmentation Of Clustered Nuclei,” Cytometry, volume 28, pages 289-297 (1997); and Netten et al., “Fluorescent Dot Counting In Interphase Cell Nuclei,” Bioimaging, volume 4, pages 93-106 (1996). Use of a Voronoi diagram and its subgraphs in the quantitative analysis of tissue architecture is known. See, e.g. Sudbo et al., “New Algorithms Based On The Voronoi Diagram Applied In A Pilot Study On Normal Mucosa And Carcinomas,” Analytical Cellular Pathology, volume 21, pages 71-86 (2000).

Some of those documents concern micronuclei analysis. See, e.g., U.S. Pat. Nos. 5,229,265, 5,644,388, 5,858,667, and 6,100,038; Nesslany et al., “A Micromethod For The In Vitro Micronucleus Assay,” Mutagenesis, volume 14, number 4, pages 403-410 (1999); Verhaegen et al., “Scoring Of Radiation-induced Micronuclei In Cytokinesis-Blocked Human Lymphocytes By Automated Image Analysis,” Cytometry, volume 17, pages 119-127 (1994); Frieauff et al., “Automatic Analysis Of The In Vitro Micronucleus Test On V79 Cells,” Mutation Research, volume 413, pages 57-68 (1998); Styles et al., “Automation Of Mouse Micronucleus Genotoxicity Assay By Laser Scanning Cytometry,” Cytometry, volume 44, pages 153-155 (2001); and Smolewski et al., “Micronuclei Assay By Laser Scanning Cytometry,” Cytometry, volume 45, pages 19-26 (2001).

Some of these documents disclose methods to measure micronuclei by flow cytometry (e.g., U.S. Pat. Nos. 5,229,265 and 5,644,388). Flow cytometry requires lysing the cells to release any micronuclei present so that they can be measured in suspension. Unfortunately, in such a suspension, nuclei fragments and other DNA-containing debris can be mistakenly registered as micronuclei. Another problem with flow cytometry it that it is impossible to associate any of the detected micronuclei with any particular cell. Thus, for example, one cannot determine if before lysing, one cell contained all of the detected micronuclei or if each of the detected micronuclei was in a different cell. In addition, the measured samples cannot be stored, for example, for archival preservation. See Smolewski et al., Cytometry, volume 45, at page 20.

Some of these documents concern attempts to provide methods for automated image analysis for detecting micronuclei (Frieauff et al., “Automatic Analysis Of The In Vitro Micronucleus Test On V79 Cells,” Mutation Research, volume 413, pages 57-68 (1998); Smolewski et al., “Micronuclei Assay By Laser Scanning Cytometry,” Cytometry, volume 45, pages 19-26 (2001); Styles et al., “Automation Of Mouse Micronucleus Genotoxicity Assay By Laser Scanning Cytometry,” Cytometry, volume 44, pages 153-155 (2001); Verhaegen et al., “Scoring Of Radiation-induced Micronuclei In Cytokinesis-Blocked Human Lymphocytes By Automated Image Analysis,” Cytometry, volume 17, pages 119-127 (1994)); however, each of those methods has its own shortcomings. For example, in Frieauff et al., (i) Cytochalasin B (to block cytokinesis) is not used and, therefore, a “nuclear division index” cannot be calculated, (ii) because a cytoplasm stain is not used, a researcher will not know whether micronuclei are in a cell or actually nuclear fragments or debris outside a cell, and (iii) because individual cell analysis is not performed, a researcher will not know whether micronuclei come from different cells or from the same cell (as in the case of nuclear fragmentation during apoptosis). Verhaegen et al. use a special fixation step to obtain “nearly perfect spherical cells” and require “the nuclei of the binucleated cells [to] slightly overlap, which is essential for . . . [the] detection algorithm . . . ” (Cytometry, volume 17, at page 121). Moreover, although Cytochalasin B is added to block cytokinesis, no cytoplasm image and, therefore, no cytoplasm data are available, resulting in the same failings (e.g., cannot determine if micronuclei are intracellular or extracellular, cannot determine if micronuclei are true micronuclei or nuclear fragments or debris). Although Smolewski et al. use both nuclei and cytoplasm images and also use Cytochalasin B to block cytokinesis in some of their cultures, after noting that their method mistakenly recognizes aggregates of two or three cells as single cells, they teach that low cell density and uniform spacing are required to diminish the probability of cell aggregation so that their method can be used (Cytometry, volume 45, at pages 23-24).

In fact, none of these documents discloses how to accurately resolve cell aggregates, cell clumps, or connecting cells into individual cell objects utilizing cytoplasm image data. Some believe this is a serious shortcoming because even with low cell density, it is difficult to avoid or even minimize cell aggregates, clumps, etc. Cells naturally like to be adjacent to each other because of their membrane affinity for each other. In some cases, the conditions, diseases, syndromes, or stimuli-induced (e.g., chemical-induced) effects of interest can be manifested only when cells are adjacent. Tight junctions can form only when cells are adjacent, bile canaliculi can form only when liver cells (e.g., hepatocytes) are adjacent, direct cell-to-cell communication can occur only when cells are adjacent, and so forth.

Not being able to resolve aggregates, clumps, etc. into individual cells can cause significant errors in the cell count and thereby adversely affect the results. Separate and apart from that source of error, not being able to resolve aggregates, clumps, etc. into individual cells makes it impossible to perform cell-by-cell analysis of target objects (i.e., what target objects, if any, are between given cells or are in each cell). Thus, as indicated above, not being able to perform a cell-by-cell analysis has many drawbacks, for example, a researcher cannot determine on a cell-by-cell basis if a cell contains, for example, multiple nuclei (i.e., if the cells are multinucleated or polychromatic cells, in other words, if they are binucleated) or a single nucleus (i.e., if the cells are mononucleated or normo-chromatic). Indeed, in Styles et al., Cytometry, volume 44, at page 155, it is stated that “[w]hile the mouse micronucleus assay is usually performed on polychromatic erythrocytes, our own studies deliberately made no discrimination between normo- and polychromatic erythrocytes.” That is because their method could not do so accurately. Styles et al. conclude that laser scanning cytometry “might also offer a suitable method for the fast or preliminary screening of samples prior to the more detailed analysis of micronuclei in polychromatic erythrocytes and similar toxicological models” (id.), again admitting the deficiencies of their method.

In addition to the failings of those suggested methods, none of them is an in vitro micronucleus assay that can be conducted directly with a multiwell microplate (e.g., a 96-well plate, which is the preferred format for pharmaceutical compound screening). That is, none of them can acquire and analyze image data for an assay directly from a multiwell microplate, much less in an automated manner.

Separate and apart from micronuclei screening, various conditions, diseases, syndromes, and stimuli-induced (e.g., chemical-induced) effects may be diagnosed by examining cells from a mammal (e.g., a human) or other animal or a plant for abnormalities. For example, examination of liver cells from a human may reveal the abnormal presence of lipid droplets, which indicates fatty liver. Liver cells may also be grown in the lab for testing a compound's ability to induce lipid droplets in liver cells, with the goal of predicting a compound's ability to induce fatty liver side effects in man.

It is expected that in the future ever increasing examination of cells from either in vitro (e.g., cells grown in the lab for testing compounds) or in vivo (e.g., cells obtained from patients) system will occur for target objects whose abnormal presence, abnormal absence, abnormal size, abnormal shape, and/or abnormal location inside or outside the cells is indicative of one or more conditions, diseases, syndromes, or stimuli-induced (e.g., chemical-induced) effects.

As is evident, the need remains for an automatic, rapid, and accurate method of screening large numbers of cells for micronuclei and other target objects and the need remains for such a method that can automatically, rapidly, and accurately score individual cell features (e.g., micronuclei) even if the cells and/or features are aggregated.

The therapy for a disease, condition, or syndrome may be monitored by determining the state (e.g., stage or severity) of the disease, condition, or syndrome before, during, and/or after a course of therapy. Thus, for example, a decrease in the frequency of specified cellular target objects that should not be present in the cells and/or in the extracellular space may indicate that the therapy is succeeding (e.g., a decrease in the frequency of infiltrating lymphocytes in hepatocytes as well as in spaces extracellular to hepatocytes indicates the anti-inflammatory therapy is succeeding).

The process can be used to determine the effect of one or more stimuli on cells in a cellular sample (including the effect on the extracellular space of the cells) when the cells are known to normally have certain characteristics when they have not been exposed to the stimuli. Thus, the process can determine whether a stimulus will produce or inhibit the formation of detectable target objects inside or outside the cells or affect the normal physical characteristics of target objects in the cells. Examples of stimuli whose effect alone or in combination may be examined by the process are: the addition to or elimination of chemical agents from the cells' environment (e.g., incubating the cells with a chemical agent to be tested); exposure of the cells to, or shielding from, electromagnetic radiation (e.g., ultraviolet light, microwave radiation); exposure of the cells to heat or cold; and physical manipulations of the cell sample (e.g., agitation, sonication).

The stimulus can be any type of stimulus whose effect on cells (including on their extracellular space) is desired to be studied. As will be understood by one skilled in the art, the exposure of the cells to the stimulus may be varied in all ways possible, e.g., type of stimulus, intensity, total amount, duration of exposure, frequency of exposure, as well as all other conditions (temperature, pressure, chemical environment, etc.). The cells may be exposed to multiple stimuli simultaneously or sequentially. Two or more types of cells may be mixed together or kept separate and exposed simultaneously or sequentially.

Those skilled in the art will understand that the selection and preparation of cells for use with the process of this invention will depend on what information is desired (e.g., do the patient's liver cells contain substances they should not, is a drug candidate clastogenic or aneugenic) and that the selection and preparation is not critical so long as the cells are selected and prepared in a way that is likely to provide the desired information when the present invention is employed.

After exposure to the one or more stimuli under the desired conditions, the cells may be examined according to the present invention to determine what effect, if any, is produced by exposure to the stimuli (e.g., a chemical agent) and, for example, how the effect varies with the amount of the stimuli to which the cells are exposed (e.g., concentration of chemical agent and duration of incubation). Particular effects of one or more stimuli on cells that may be determined by the present invention are clastogenicity and aneugenicity (micronuclei frequency), which in turn may be used to assess the carcinogenicity of the one or more stimuli. That has particular value in screening new drug candidates in a drug discovery program because candidates that appear to be carcinogenic (which may be inferred from their aneugenicity and/or clastogenicity) may be eliminated from further consideration. Other stimuli (e.g., electromagnetic radiation of a given frequency) may also be screened for clastogenic and/or aneugenic effects.

Diseases, conditions, syndromes, and stimuli-induced effects that may be assessed (and the target objects for assessing them) using the processes of this invention include, for example:
1. Steatosis (commonly known as “fatty liver”), where increased presence of neutral lipid droplet inside cells is indicative of fatty liver disease or chemical-induced fatty liver side effects. 2. Phospholipidosis, where increased presence of phospholipid droplets inside cells is indicative of phospholipid storage disease or chemical-induced phospholipidosis side effects. 3. Diminished or lack of exocytosis, where the retention of exocytic materials inside cells is indicative of exocytosis disease (e.g., respiratory distress syndrome) or chemical-induced exocytosis side effects (e.g., chemical-induced pulmonary toxicity). 4. Diminished or lack of endocytosis, where absence of endocytized material inside cells is indicative of endocytosis disease (e.g., respiratory distress syndrome) or chemical-induced endocytosis side effects (e.g., chemical-induced pulmonary toxicity). 5. Diminished or lack of phagocytosis, where absence of phagocytized material inside cells is indicative of phagocytosis disease (e.g., retinal degeneration), or chemical-induced phagocytosis side effects (e.g., chemical-induced retinal toxicity). 6. Increased lysosomal storage, where increased presence of lysosomes inside cells is indicative of lysosomal storage disease or chemical-induced lysosomal side effects. 7. Increased glycogen storage, where increased presence of glycogen deposits inside cells is indicative of glycogen storage disease or chemical-induced glycogen storage side effects. 8. Peroxisome proliferation, where increased presence of peroxisomes inside cells is indicative of peroxisome proliferation of chemical-induced peroxisome proliferation side effects. 9. Infection of foreign material, where presence of foreign material in cells or their extracellular space is indicative of infection. Foreign material includes bacteria, virus, fungus, and other biological material (e.g., proteins, peptides, nuclei acids, etc.). Increased presence of bacteria or virus or fungus inside cells is indicative of infectious disease. Decreased presence of bacterial or virus or fungus inside cells is indicative of recovery or successful anti-bacterial/anti-viral/anti-fungal therapy. 10. Inflammation, where presence of infiltrating inflammatory cells (e.g., lymphocytes) or products thereof (e.g., reactive oxygen species, reactive nitrogen species, inflammatory molecules) in cells or extracellular space is indicative of inflammation. Increased presence of inflammatory cells is indicative of inflammatory disease. Decreased presence of infiltrating inflammatory cells is indicative of recovery or successful anti-inflammatory therapy. 11. Metastasis, where presence of infiltrating tumor cells in otherwise normal cells or extracellular space is indicative of tumor progression. Increased presence of infiltrating tumor cells or products thereof is indicative of tumor metastasis. Decreased presence of tumor cells or products thereof is indicative of recovery or successful anti-tumor therapy. 12. Chemical exposure and/or chemical clearance, where presence of one or more chemicals of interest in cells and/or extracellular space is indicative of the exposure of the cells or their originating tissues or bodies (i.e., the tissues or bodies from which the cells originate) to the one or more chemicals. Increased presence of chemicals, chemical particles, or chemical granules is indicative of chemical exposure (e.g., soot particles in a smoker's lung cells). Decreased presence of chemicals inside cells and/or extracellular space is indicative of recovery or chemical clearance from cells/tissues/bodies. 13. Bile deposit inside hepatocytes, where increased presence of inspissated bile casts in liver cells is indicative of cholestasis disease or chemical-induced cholestasis side effects. 14. Bile salts inside the canaliculi between hepatocytes, where presence of bile salts in canaliculi is indicative of normal bile flow in hepatocytes and diminished presence of bile salts is indicative of a cholestasis condition or chemical-induced cholestasis side effects. 15. Mitochondria activity inside cells, where decreased mitochondria activity in cells (e.g., decreased oxidative phosphorylation, decreased lipid oxidation, etc.) is indicative of mitochondria disease or chemical-induced mitochondria side effects. 16. Reactive species inside cells or extracellular space, where increased presence of reactive species (e.g., reactive oxygen species, reactive nitrogen species, reactive thiol species, radicals) is indicative of oxidative stress. Oxidative stress can lead to oxidative damage in tissues (e.g., CNS toxicity, liver toxicity, kidney toxicity, ocular toxicity). 17. Exposure and disposition of therapeutic agents in cells, where the amount and the location of the therapeutic agents inside cells can be used as to monitor the uptake, metabolism, disposition, and clearance of the therapeutic agents. The therapeutic agents can be chemicals, natural products, or macromolecules such as peptides, oligonucleotides, oligosaccharides, or fatty acids. For example, fluorescently labeled oligonucleotides can be used to highlight the presence of antisense oligonucleotides with regard to lysosome, cytosol, and nuclei inside HepG2 cells (Jensen et al., “Antisense Oligonucleotides Delivered To The Lysosome Escape And Actively Inhibit The Hepatitis B Virus,” Bioconjugate Chemistry, volume 13, pages 975-984 (2002)). 18. Abnormal protein or peptide exposure to the cells, where increased presence of abnormal protein or peptide is indicative of disease or syndrome (e.g., beta-amyloid deposit inside neurons in Alzheimer's disease). 19 Abnormal protein trafficking in cells, where abnormal location of an endogenous protein is indicative of disease or syndrome (e.g., failure of MRP2 protein trafficking and insertion into the apical membrane of hepatocytes frequently found in Dubin-Johnson syndrome). 20. Abnormal cytoskeleton architecture in cells, where abnormal location and/or aggregation of cytoskeleton components in cells is indicative of diseases or syndromes related to abnormal cytoskeleton structure and function. 21. Swollen mitochondria, where enlarged mitochondria is indicative of mitochondria storage disease or chemical-induced mitochondria side effects (e.g., accumulation of cationic amphiphilic drugs in the mitochondria. 22. Swollen lysosomes, where enlarged lysosomes are indicative of lysosomal storage disease or chemical-induced lysosomal side effects (e.g., accumulation of cationic amphiphilic drugs in the lysosomes). 23. Organelles in blebs, where intracellular organelles exhibit intracellular blebs characteristic of apoptosis. 24. Nuclear fragments or chromatin fragments, where degraded chromatin exhibits itself as nuclear fragments characteristic of apoptosis. 25. Osmotic changes of cells, where shrunken cell volume and enlarged extracellular space is indicative of osmotic changes across the cellular membrane. 26. Osmotic changes of cells, where enlarged cell volume and shrunken extracellular space is indicative of osmotic changes across the cellular membrane (e.g., osmotic swelling of lens cells can lead to cataracts). 27. Anti-oxidants status inside cells or in extracellular space, where decreased presence of anti-oxidants in organelles, cytosol, nuclei, and extracellular space (e.g., decreased glutathione levels in mitochondria) is indicative of oxidative stress. Such oxidative stress can lead to oxidative damage in tissues (e.g., CNS toxicity, liver toxicity, kidney toxicity, ocular toxicity). 28. Membrane potential across cellular and organelle membranes, where altered membrane potential is indicative of one or more diseases or syndromes (e.g., decreased mitochondria membrane potential in chemical-induced mitochondria side effects, altered acting potential across cardiac myocytes in QT prolongation syndrome or chemical-induced QT prolongation side effects). 29. Abnormal ion concentrations across cellular and organelle membranes, where altered ion concentration is indicative of one or more diseases or syndromes (e.g., increased calcium ion concentration in the cytosol during apoptosis, altered potassium ion gradient across cardiac myocytes in QT prolongation syndrome or chemical-induced QT prolongation side effects, altered chloride ion gradient across cholangiocytes and other cell types in Cystic Fibrosis syndrome). 30. Heat generation in cells, where local heat generation (e.g., by mitochondria oxidative phosphorylation) inside cellular organelles of individual cells can be highlighted by thermal imaging. Defects in energy production in the form of heat generation can be used as an indicator for diseases and syndromes related to cellular energy production.

Yet other diseases, conditions, syndromes, and stimuli-induced effects (and appropriate respective target objects) will be apparent to those skilled in the art. After the cells that may possibly contain target objects of interest are in hand (e.g., cells removed from an organism or cells that were exposed to a stimulus whose effects are being assessed), the cells must be treated in a manner that will highlight the target objects to be detected. The purpose of highlighting the target objects is to allow the appropriate images to be obtained and processed in accordance with the invention. Highlighting of target objects can be accomplished by any methods known in the art, either alone or in combination. The highlighting may be permanent, semi-permanent, or transitory. For example, the cells may be exposed to electromagnetic radiation that highlights (e.g., preferentially reveals the presence of) the target objects only during the exposure. Thus, for example, illuminating the cells of interest with a certain frequency of light (whether visible or not) may temporarily highlight certain proteins within the cells if the proteins are present. Parts of the cells that are not the target objects (e.g., the cytoplasm or the inner or outer surface of the cellular membrane) may also be highlighted to aid in the detection of the target objects (e.g., to help discriminate the target objects from other things within the cells) or for any other appropriate reason.

A preferred highlighting method is exposing the cells to one or more chemical highlighting agents that alone or in combination with other highlighting agents (whether chemical or otherwise) preferentially color (e.g., stain or dye) the target objects being sought. Other parts of the cells that are not the target objects but that are to be highlighted (because, e.g., they indirectly indicate the target objects of interest) are preferably highlighted in the same manner (i.e., using one or more chemical highlighting agents alone or in combination with other highlighting agents).

Coloring agents and methods are well known and the cell sample can be stained with multiple dyes in order to detect multiple target objects within the cell sample as well as to characterize those target objects. Coloring agents used to color anything inside a cell must be able to penetrate into the cell and once inside the cell must be able to contact the target objects or other cell features to be colored. Once the target objects or other cell features have been stained or otherwise colored, the sample containing the cells is exposed to a light source that allows the contrast between the stained and unstained portions of the cells to be detectable visually, but any detection method may be used. With some coloring agents, the contrast may be detectable only when non-visible portions of the electromagnetic spectrum (e.g., ultraviolet light) are used, in which case the contrast is detected by sensors adapted to the appropriate portion of the electromagnetic spectrum. One of skill in the art will be familiar with the combinations of coloring agents and light sources required to highlight the various target objects and other cell features on a permanent, semi-permanent, or transitory basis.

In addition to staining and dyeing, the target objects or other cell features of interest may be labeled with chromophores, fluorophores, lumiphores, and the like and then exposed to chemical or other agents to develop the contrast (if necessary) and/or make it detectable. One method uses antibodies that act against specific target object and/or specific cellular feature antigens to label those objects and/or features, even when they are localized to specific portions of the cell. For example, antibodies against cytoplasmic antigens may be used to label the cytoskeletal proteins actin, tubulin, and cytokeratin. Another highlighting method is to use protein chimeras or mutants thereof to label the target object or cellular feature. A protein chimera consists of a protein that is specific to the target object or cellular feature and is genetically fused to an intrinsically luminescent protein, such as a green fluorescent protein.

Thus, highlighting agents include stains, dyes, fluorochromes, reactive and conjugated probes, nucleic acid probes, and fluorescent proteins, such as fluorescein; fluorescein diacetate; phycoerythrin; Tricolour; PerCP; TRITC (Rhodamine); X-rhodamine; lissamine rhodamine B; coumarin; hydroxycoumarin; aminocoumarin; methoxycoumarin; allophycocyanin (APC); APC-Cy7; Cascade Blue; Red 613; Red 670; Quantum Red; Hoechst 33342 (e.g., for DNA); Hoechst 33258 (e.g. for DNA); DAPI (e.g., for DNA); Chromomycin A3 (e.g., for DNA); propidium iodide (e.g., for DNA); ethidium bromide (e.g., for DNA); TO-PRO-1; TO-PRO-3 (e.g., for DNA); Sytox Green (e.g., for DNA); Sytox Blue; Sytox Orange; SNARF-1; Indo-1; Fluo-3; Rhodamine 123 (e.g., for mitochondria); monochlorobimane (e.g., for glutathione); Lucifer Yellow; NBD; R-Phycoerythrin (PE); PE-Cy5 conjugates; PE-Cy7 conjugates; BODIPY-FL; Cy3; TRITC; PerCP; Texas Red; TruRed; Cy5; Cy7; APC-Cy7 conjugates; Chromomycin A3; mithramycin; YOYO-1; 7-AAD; acridine orange; thiazole orange; TOTO-1; TOTO-3; LDS 751; Y66F; Y66H; EBFP; GFPuv; ECFP; Y66W; S65A; S65C; S65L; S65T; EGFP; EYFP; DsRed; monochlorobimane; calcein; and iodine (e.g., for starch); all of which are known to those skilled in the art. These skilled in the art know how to obtain such reagents. For example, some materials are available from Molecular Probes, Inc. (Eugene, Oreg., US), Amersham Pharmacia Biotech Inc. (Piscataway, N.J., US), Sigma Chemicals (St. Louis, Mo., US), and Avanti Polar Lipids, Inc. (Alabaster, Ala., US).

For nuclear material, highlighting agents include nucleic acid-specific luminescent reagents, such as cyanine-based dyes (e.g., TOTO, YOYO, BOBO, and POPO dyes), dimeric cyanine-based dyes (e.g., TO-PRO, YO-PRO, BO-PRO, PO-PRO, and SYTO dyes), phenanthidines and acridines (e.g., ethidium bromide, propidium iodide, acridine orange, acridine homodimer and ethidium-acridine heterodimer), indoles and imidazoles (e.g., Hoeschst 33258, Hoechst 33342, and 4′,6-diamidino-2-phenylindole), and other reagents (e.g., 7-aminoactinomycin D, hydroxystilbamidine, and psoralens), labeled antibodies to nuclear antigens, and protein chimeras fused to luminescent proteins.

For cytoplasm, highlighting agents include fluorescent dyes having a reactive group (e.g., monobromobimane, 5-chloromethylfluorescein diacetate, carboxyl fluorescein diacetate succinimidyl ester, chloromethyl tetramethylrhodamine), polar tracer molecules (e.g., Lucifer Yellow and Cascade Blue-based fluorescent dyes), labeled antibodies, and fluorescent protein chimeras, and other reagents that non-specifically label RNA, protein, carbohydrates, or lipids (e.g., acridine orange, Texas Red, BODIPY, propidium iodide, conjugates of carbohydrate-binding proteins, DiO, Dil, and DiD reagents).

For intracellular and extracellular surfaces, highlighting agents include fluorescent molecules (e.g., succinimidyl ester, intracellular components of the trimeric G-protein receptor, adenylyl cyclase, and ionic transport proteins), derivatives of fluorescent dyes (e.g., fluoresceins, rhodamines, and cyanines), fluorescently labeled macromolecules with a high affinity for cell surface molecules (e.g., fluorescently labeled lectins), fluorescently labeled antibodies with a high affinity for cell surface components, and fluorescent protein chimeras.

For lysosomes, highlighting agents include luminescent molecules (e.g., neutral red and N-(3-((2,4-dinitrophenyl)amino)propyl)-N-(3-aminopropyl)methylamine), LysoTracker probes, LysoSensor probes, fluorescently labeled dextrans or low density lipoproteins or phospholipids, antibodies against lysosomal antigens, and protein chimeras (e.g., a lysosomal protein fused to a luminescent protein).

For mitochondria, highlighting agents include luminescent reagents (e.g., rhodamine 123, tetramethyl rosamine), MitoTracker probes, MitoFluor probes, CC-1, JC-1, JC-9 stains, antibodies against antigens such as DNA, RNA, histones, DNA polymerase, RNA polymerase, and mitochondrial variants of cytoplasmic macromolecules, and protein chimeras (e.g., a mitochondrial protein fused to a luminescent protein).

For endoplasmic reticulum, highlighting agents include luminescent reagents such as short chain carbocyanine dyes, long chain carbocyanine dyes, ER-Tracker dyes, and luminescently labeled ceramides, sphingolipids, lectins, antibodies against endoplasmic reticulum antigens, and protein chimeras (e.g., an endoplasmic reticulum protein fused to a luminescent protein).

For Golgi bodies, highlighting agents include luminescent reagents (e.g., luminescently labeled macromolecules such as wheat germ agglutinin, and fluorescently labeled sphingomyelin), antibodies against Golgi antigens, and protein chimeras (a Golgi protein fused to a luminescent protein).

For lipid droplets, highlighting agents include luminescent reagents (e.g., Oil Red O, nile red, and BODIPY).

For phospholipid inclusions, highlighting agents include luminescently labeled phospholipid reagents (e.g., BODIPY-PE, NBD-PE) and luminescent reagent such as nile red.

For exocytosis, highlighting agents include luminescent reagents such as rhodamine-PE, surfactant protein A, LysoTracker Green, and Fura-2 AM.

For endocytosis, highlighting agents include luminescent reagents such as rhodamine-PE, surfactant protein A, LysoTracker Green, and Fura-2 AM.

For phagocytosis, highlighting agents include luminescently labeled macromolecules such as FITC-labeled retinal rod outer segments and FITC-labeled E. coli particles.

For glycogen inclusions, highlighting agents include luminescent reagents such as PAS.

For peroxisomes, highlighting agents include luminescent reagents, such as luminescently labeled antibodies against peroxisome antigens, and protein chimeras (a peroxisome protein fused to a luminescent protein).

For foreign materials such as bacteria, virus, fungus, chemical particles, highlighting reagents include antibodies against specific bacteria, virus, or fungus, and DNA probes or RNA probes against specific bacteria or virus. Chemical particles inside cells may be highlighted by specific light emitted by such chemical (fluorescence, radioactivity, chemiluminescence, etc.).

For infiltrating cells such as lymphocytes or tumor cells, highlighting reagents include antibodies against specific infiltrating cells and/or cellular organelles.

For bile salts or bile acids, highlighting reagents include fluorescently labeled bile salts (e.g., cholyl lysyl fluorescein, cholyl lysyl NBD, deoxycholy lysyl NBD, chenodeoxycholyl lysyl NBD, and FITC-taurocholate).

For reactive oxygen species, highlighting reagents include dichlorodihydrofluorescein, dichlorofluorescin or its derivatives, dihydrorhodamine or its derivatives, dihydrocalcein AM or its derivatives, BODIPY dyes, Leuco dyes, OxyBurst dyes, reduced MitoTracker probes, dihydroethidium or its derivatives, RedoxSensor CC-1 stains, and antibodies against specific oxidation products of macromolecules such as DNA, proteins, and lipids.

Other highlighting agents that may be used for these and other target objects and other cell features will be known to those skilled in the art. See, e.g., the web edition of the Handbook of Fluorescent Probes and Research Products from Molecular Probes, Inc., which contains up to date information on highlighting agents that can be used for various target objects and other cell features (http://www.probes.com/handbook/).

Those skilled in the art will appreciate that the means employed for highlighting the target objects and other cell features (e.g., cytoplasm, cellular membrane, nuclear material, nuclear membrane) will depend on what information is desired (e.g., do the patient's liver cells contain substances they should not, is a drug candidate clastogenic or aneugenic) and that the highlighting (including selection of one or more highlighting agents) is not critical so long as highlighting is done in a way to provide the desired information when the present invention is employed.

After highlighting the target objects and other cell features, individual or multiple images of the highlighted target objects and other cell features are acquired so that they can be further processed in accordance with the present invention. The images of the highlighted cellular features may be acquired by any known method or device capable of acquiring an image in which the image data (e.g., intensity, color, greyscale) are ultimately in addressable locations, preferably individually addressable locations (e.g., pixels). The images may be acquired directly in a format in which the image data are in individually addressable locations. For example, images of highlighted target objects may be acquired with an image recorder (e.g., a charge coupled device (“CCD”) or a photo multiplier tube) and any necessary peripheral equipment. Other digital imaging devices (e.g., cameras using complimentary metal oxide semiconductors (“CMOS”)) may be used. Alternatively, the images may be acquired by converting an image from another format into one where the image data are in individually addressable locations. For example, an analog image of highlighted target objects (e.g., a photograph) may be converted to a digital format by processing with a scanner. Image conversion is well known in the art and may be accomplished by any known method. A preferred method is to acquire images of the target objects (e.g., micronuclei) and the cell's highlighted cellular features (e.g., cytoplasm) with a CCD digital camera attached to a scanning microscope. Acquired images may be stored temporarily or permanently prior to image analysis.

The ArrayScan II automated microscope and computer system, made by Cellomics Inc. (Pittsburgh, Pa., US), has been successfully used and is preferred for image acquisition. The ArrayScan II system consists of a scanning microscope, microplate handler and reader, and attached computer system. The microscope itself is an automated microscope of the Zeiss type and uses a Mercury-Argon light source. The microscope has standard objectives and a magnification range of 5× to 200×. The ArrayScan II system has automated components such as robotic arms, plate handlers, and an automatic routine to focus on a biological sample in a microplate. Other types of microscope systems (e.g., laser microscopy systems) may also be used for acquiring images. For example, the OPERA automated confocal microscope made by Evotec Technologies GmbH (Berlin, Germany) may be used. The EIDAQ 100 automated microscope, made by Q3DM (San Diego, Calif., US), Universal Imaging Corporation's (Downingtown, Pa., US) Discovery-1 Screening System, which is an integrated platform of high speed optics, wavelength changers, an automated stage, and digital camera, and the AutoLead Analyzer, made by Imaging Research Inc. (St. Catharines, Ontario, Canada), may also be satisfactory. Automated laser scanning cytometers can replace automated microscopes in generating satisfactory cell images. Therefore, a LEADseeker™ laser scanning cytometer, made by Amersham Pharmacia Biotech (Piscataway, N.J., US), and LSC® and iCyte® laser scanning cytometers, both made by CompuCyte Corporation (Cambridge, Mass.), may also be satisfactory.

The cells in the cell sample are introduced into the device or devices for acquiring the desired image or images using any convenient method, and the method is not critical. When a microscope is used to acquire the image(s), the cell sample will typically be located on a microplate (microwell plate) or multi-well slide. Use of such carriers for the cell samples is consistent with the use of small quantities of cells. In drug discovery programs, the total quantity of each discovery candidate made (e.g., using combinatorial chemistry) is typically only a few milligrams and, therefore, the number of cells that can be adequately exposed to the candidate (e.g., in a high enough concentration) is small (particularly after removing some of those few milligrams of the candidate for other screening procedures).

Broadly speaking, after the microscope or other device acquires the one or more desired images, the image data are processed to determine the presence or absence of target objects and, if they are present and further information is desired, their size, shape, location, etc. The preferred scheme for doing this is further described below.

With this background, we turn to the drawings. Legends used herein are not meant to limit the language which describes the drawings.

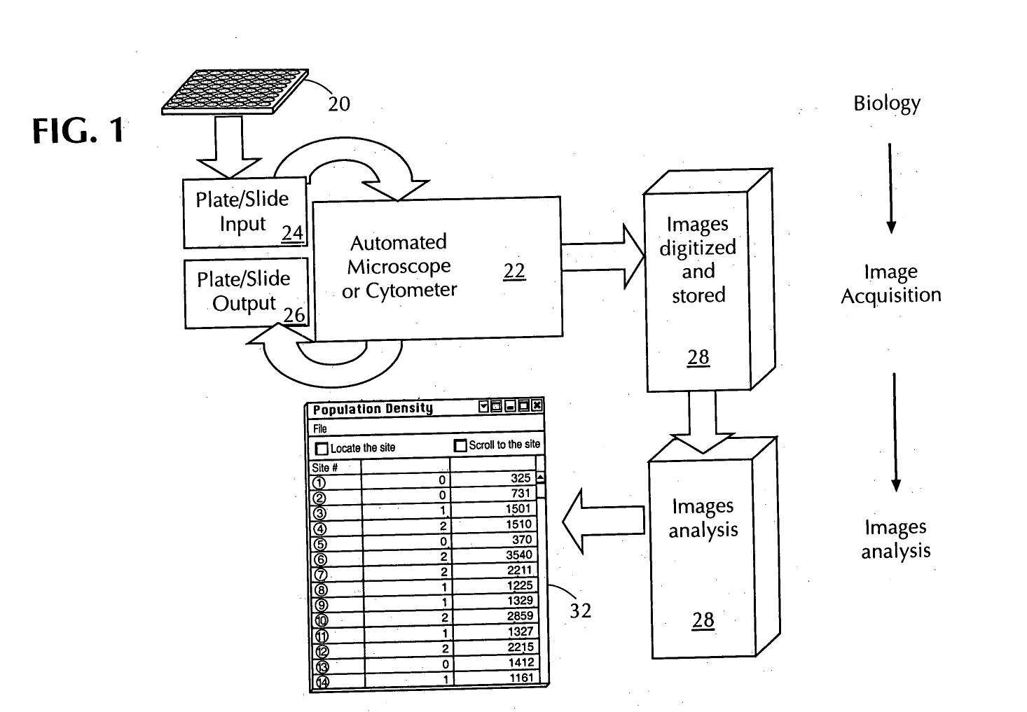

FIG. 1 This figure presents an overview of what has been previously discussed. In a first phase, which may be referred to as the “Biology” phase, the wells of microwell plate 20 each contain a cell sample. As discussed above, the cells may have been taken from a patient or the cells may be maintained in the laboratory and may have been exposed to a stimulus (such as a discovery drug candidate) under controlled conditions. To simplify further discussion of the working examples, we will assume some or all of the microwells contain Chinese hamster ovary cells that have been incubated with discovery drug candidates for micronuclei screening, but it will be understood that the invention is not in any way so limited. Some of the microwells may contain either positive or negative standards or controls, and there may be two or more microwells containing independent replicates (i.e., independently prepared samples of the same cell line may have been independently incubated with aliquots of the same drug discovery candidate and placed in separate microwells). A set of wells on microwell plate 20 may contain identical samples of the same cell line that have been incubated with different concentrations of the same discovery drug candidate or those wells may contain mixtures of different cells that have been incubated with the same discovery drug candidate. As will be understood by one skilled in the art, other variations are possible.

Continuing with the example, each well (other than wells that are not to contain any cells) will usually be seeded with anywhere from 1,000 to 5,000 cells for micronuclei screening (with about 2,500 being most preferred). A small quantity of a discovery drug candidate will be added to each well (the amount will usually be in the range of from 0 micrograms to about 500 micrograms and often in the range of from 0 micrograms to about 100 micrograms), desirably in a carrier medium containing DMSO (dimethyl sulfoxide), ethanol, methanol, acetonitrile, and/or water.

A mixture such as one containing amino acids (e.g., L-glutamine), serum (e.g., 5% fetal bovine serum), and glucose will be added to the wells to provide an aqueous growth medium for the cells. If the discovery drug candidates are to be screened for their clastogenicity or aneugenicity, a compound that allows nuclear division but prevents cellular division will preferably be added (e.g., Cytochalasin B or CYB, Cytochalasin D or CYD, colchicines, etc.). Because micronuclei formation occurs during nuclear division (if any micronuclei are going to form), one way to know that nuclear division has in fact occurred (so as to give the discovery drug candidate an opportunity to cause a “problem,” i.e., to cause breakage or omission of nuclear material) is to prevent cellular division while allowing nuclear division and then to verify the presence of binucleation (i.e., the presence of cells containing two or more nuclei). The presence of binucleated cells in the microwell at the end of the process is proof that nuclear division occurred in the presence of the discovery drug candidate.

Other substances can be added to the wells. For example, mammal liver (or other organ) microsomes can be added to generate liver (or other organ) metabolites of the drugs or drug candidates in the wells. Thus, mammal liver S9 fractions added to the culture medium will result in the production of liver metabolites of the drugs or drug candidates. Other type of cells added to the culture medium (e.g., co-culture of liver cells and epithelial cells or lymphocytes) will generate their respective types of metabolites.

The cells in culture medium are typically mixed thoroughly by pipeting up and down and then seeded into microwell plates by dispensing equal volumes into each well (typically 100 microliters into each well of a 96-well plate). This is usually performed in a parallel and automated fashion using automated liquid handlers with multiple liquid transfer channels. After seeding, the cells are distributed or spread out at the bottom of the plate by gently shaking the plate a few times in a back and forth and side to side manner. The cells are then allowed to attach to the bottom of the plate with as little disturbance as possible.

After the cells become attached to the plate bottom, a chemical stimulus (agent) such as a discovery drug candidate can be added to each well. The chemical agent of interest in its carrier (e.g., DMSO) is mixed with additional carrier to a 100× (one hundred times) dilution or 100×strength and then is further diluted into cell culture medium to a 2× dilution or 2×strength. By adding a volume of the 2× dilution or 2×strength equal to the volume of the mixture already in the microwell plates, a final of 1× dilution or 1×strength of the chemical is in the contact with the cells. The cells in contact with the discovery drug candidate in the aqueous medium are then incubated under controlled conditions for a period typically of 24 hours. The controlled conditions comprise temperatures in the range of 20 to 40 degrees Centigrade (preferably about 37 degrees Centigrade), ambient pressure, carbon dioxide concentration in the 1% to 10% range (preferably about 5%), and humidity in the 80% to 100% range (preferably 95%). The medium containing the discovery drug candidate is then removed and the cells adhering to the microwell wall are washed, typically with phosphate buffered saline or other balanced salt solutions (the cells adhere to the microwell surface, so a majority of them continue to adhere to the microwell wall during the addition and removal of the various liquids).

The cells remaining in the microwell are fixed to the bottom of the microplate by adding 3.7% formaldehyde solution (preferably made fresh each time) and incubating at room temperature, usually for about 60 minutes. To remove the formaldehyde solution, the cells are typically washed 3 times with phosphate buffered saline or other balanced salt solutions.

The cells are then briefly treated with a detergent to permeabilize them, for example, by contacting them with 1% Triton for 90 seconds at room temperature. To remove the detergent, the cells may be washed 3 times with phosphate buffered saline or other balanced salt solutions. The permeabilization is needed to allow the colorants for the nuclear and cytoplasmic material to enter through the various membranes so that the desired staining can occur.

Next, the cells are sequentially exposed to two coloring agents, one to stain the nuclear material (e.g., Hoechst 33342) and one to stain the cytoplasm (e.g., acridine orange), with separation and wash steps in between. Working stocks of Hoechst 33342 (10 mg/ml in water) and acridine orange (10 mg/ml in water), which are preferred colorants, may be kept in the refrigerator for up to 6 months. On the day of usage, they are diluted with phosphate buffered saline supplemented with 40 mM Hepes buffer with a pH typically of about 8.5. For the Hoechst 33342, a dilution factor of 1:1,000 may be used, and for acridine orange, a dilution factor of 1:10,000 may be used. The cells are first exposed to the Hoechst 33342 for about 30 minutes at room temperature and then the cells are washed 3 times with phosphate buffered saline or other balanced salt solutions to remove the colorant. The cells are then exposed to the acridine orange at room temperature for a brief period, typically of 90 seconds and then the cells are washed 3 times with phosphate buffered saline or other balanced salt solutions to remove the colorant.

After staining, about 200 microliters of phosphate buffered saline or other balanced salt solution is added back to each well of the microwell plates, which are then sealed with a transparent plastic film, e.g., TopSeal made by Packard (Meriden, Conn., US). The plates are now ready to be imaged (e.g., by an automated microscope) or stored at 4° C. for later imaging during the next few days.

In the second phase, which may be referred to as the “Image Acquisition” phase, the image is acquired, preferably by using the ArrayScan II microscope system. As indicated above, other devices (e.g., laser scanning cytometers) may also be used.

Desirably, the number of cells placed in each well at the start of seeding for micronuclei screening will be from 1,000 to 5,000, with about 2,500 being preferred. A minimum of approximately 1,000 cells are usually needed for the process of this invention to give statistically valid results for micronuclei detection, but a higher number of cells (e.g., 2,500) is preferred. (Micronuclei formation occurs only rarely (e.g., in only about 1-2% of cells) even in the presence of most aneugenic and clastogenic chemicals, so a higher number of cells is preferred.) Thus, to have the preferred number of cells (i.e., a minimum of 1,000) in a microwell at the end of the “Biology” phase usually requires starting with about 2,500 cells in the microwell because of the significant loss of viable cells that may occur during the “Biology” phase. For example, DMSO, which is typically used as part of the carrier transporting the discovery drug candidate to the microwell, can destroy the viability of some cells, and the discovery drug candidates themselves may often kill a number of cells, particularly when the candidates are at higher concentrations. Furthermore, not all the cells in a microwell are firmly adhered to its wall, so removal of the various liquids that must be added during the “Biology” phase also removes some of the cells.

Altogether, the loss of viable cells from a microwell (whether from actual removal during a liquid removal step or from cell lysis) can sometimes reach as high as about 50%. If the loss exceeds about 50%, any results may be suspect (e.g., because the discovery drug candidate may be so potent that most cells affected by the discovery drug candidate have been lysed). Accordingly, the process of the invention preferably takes into account the decrease in the number of viable cells, and if there is more than a 50% reduction, that result is reported for that microwell. Those skilled in the art can easily determine how many cells to use for other target objects and what percentage reduction in the number of viable cells would make the results questionable.

As shown in FIG. 1, in the “Image Acquisition” phase, microwell plate 20 is automatically placed into ArrayScan II microscope 22 by automated apparatus 24 (e.g., including robotic arms), the requisite images are acquired, and the microwell plate is removed by automated apparatus 26 (which may share common elements with apparatus 24).

The ArrayScan II microscope is desirably set for a magnification of 200× (200 times). That is because with a lower magnification (e.g., 50× to 100×), some micronuclei might have a size of only 1 pixel and for micronuclei detection, the process of this invention is generally more accurate if micronuclei are larger than 1 pixel. At a magnification of 200×, the number of pixels for a normal nucleus in Chinese hamster ovary cells will be in the range of about 300 to about 800 pixels and the number of pixels for a micronucleus will be in the range of about 2 to about 100 pixels.

With the two coloring agents mentioned above (Hoechst 33342 and acridine orange), two complete “pictures” of each microwell are taken. First, a light source having a wavelength of 352 to 461 nanometers is used to illuminate and capture the highlighting of the micronuclei resulting from the Hoechst 33342 stain when the microwell is exposed to that light, and then a light source having a wavelength of 500 to 526 nanometers is used to illuminate and capture the highlighting of the cytoplasm resulting from the acridine orange stain when the microwell is exposed to that light. With 200× magnification and a microwell having a circular opening measuring about 7 mm in diameter, each well will actually be composed of about 40 to 60 separate contiguous images (fields), each measuring about 170 microns by about 170 microns. Typically, about 40 contiguous images are needed to image at least 1,000 cells attached to the bottom planar surface of a microwell under the minimum seeding density and microwell size. As discussed above, one skilled in the art may vary any or all of these devices, methods, and parameters, starting with the source and type of cells used and including the target objects being sought, the highlighting agent(s) used, the number of microwells on the plate, the size of the microwells, the type of image acquisition device used, etc.

After the images are acquired by microscope 22, the images are digitized and the digitized images are stored in one or more devices collectively referenced by numeral 28, which devices together typically constitute a computer. That computer may be part of the microscope system or other device used to acquire the image(s) or it may be a separate computer. In the case of the ArrayScan II microscope system, the computer is part of the system.

In the third and final phase of the process, which may be referred to as the “Image Analysis” phase, the digitized images are processed and results are obtained. Image data processing is indicated by reference numeral 30, which processing will typically be performed by one or more devices, e.g., a computer. Those devices or computer may be the same as or different from the devices used for digitizing the images and storing the image data. The locations of the functionalities that digitize the images, store the image data, and process the image data to produce the desired results are not critical. For example, the digitizing function may be automatically performed by the automated microscope and the data storage function may be performed by the same device that processes the data.

In FIG. 1, table 32 shows typical output resulting from the process of this invention. For each field (a field being, e.g., one of the images that with the other images constitute the entire picture of a microwell), a count of the number of objects (e.g., cells) within that field at each site is provided (a “site” is one subdivision of a field that with the other sites constitutes the entire field). The purpose of the analysis and the type of target objects will determine the nature of the results reported. For micronuclei screening, what may be reported for each field or for each site is the number of normal nuclei within cells in the field or site, which of the cells are binucleated, and how many micronuclei are within the cells in the field or site. The number of cells within the field may also be reported.

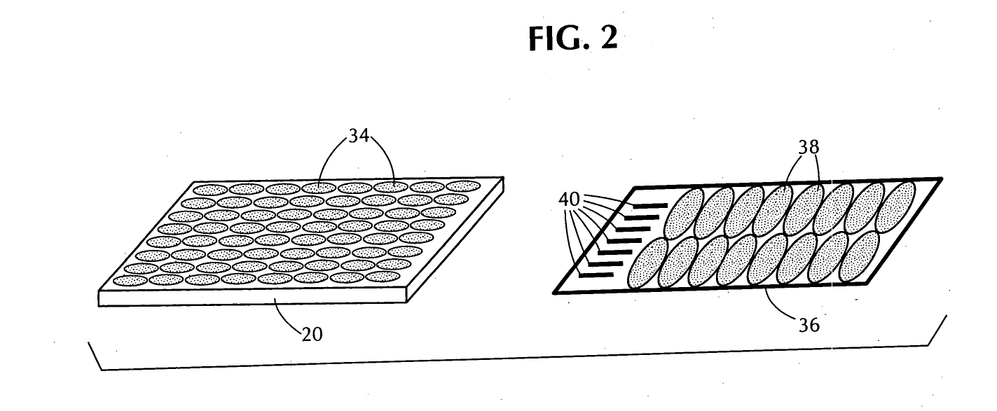

FIG. 2 This figure is an enlarged view of microwell plate 20 showing wells 34 (the preferred microwell plate has 96 wells). Instead of microwell plate 20, multi-well slide 36 having wells 38 and indicia 40 (e.g., bar code indicia) may be used. Indicia 40 help the automated microscope system keep track of the slide and identify which cells and drug discovery candidate are in each well on the slide. The invention is not limited to using any particular means of introducing the cells treated to highlight the target objects into the device for acquiring the images and any means may be used, although microwell plates and multi-well slides will usually be preferred.

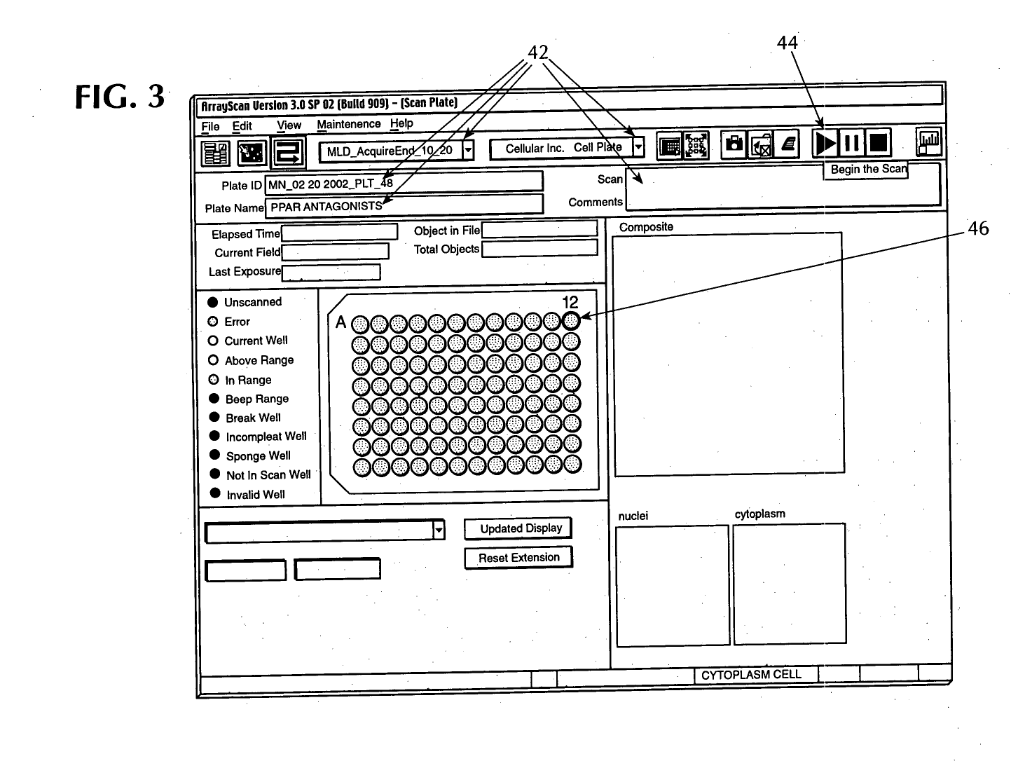

FIG. 3 This figure is a screen print of the preferred Array Scan II system's user interface control screen showing information concerning a microwell plate that is to be scanned (i.e., from which images are to be acquired). Reference numeral 42 indicates various user inputs. When a plate is brought to the machine, the user is requested to supply a plate identification code, a plate name, optional comments, the manufacturer of the microwell plate (e.g., Cellomics, Inc., Pittsburgh, Pa.) and its type (e.g., CellPlate-96), and the channel through which the image information acquired by the microscope will flow to the computer (e.g., MCD_AcquireOnly_{—}10x_p2.0). Pushing (clicking on) button (icon) 44 starts the scan of the microwell plate. The name of the manufacturer of the microwell plate and its type and the channel may be selected from pull-down menus accessed by pushing the respective down-pointing arrows 42. Well indicator 46 indicates which of the 96 wells on the microwell plate is being read (in this case, well A12 is being read). The ArrayScan device is equipped with a standard Hg—Ar light source, an Omega XF100 filter, automated focus algorithms, and automated exposure algorithms. One automated focus algorithm calculates the sharpness for a series of images taken at consecutive Z planes and determines the sharpest image for each nuclei image. The device then captures an image of the cytoplasm at the Z plane producing that sharpest image. The automated exposure algorithm adjusts the exposure time for each coloring (highlighting) agent to ensure a high quality image from each channel (e.g., for 30% of camera saturation level of light reaching the camera).

To specify the initial setting for a run, an operator (a) chooses the plate type from the pull-down menu (e.g., Cellomics CellPlate-96), (b) chooses the magnification (e.g., 200×), (c) chooses the number of fields to scan each well (e.g., 40), (d) chooses the filter settings for Hoechst 33342 (dye 1) and acridine orange (dye 2), (e) verifies that the focus and exposure control settings are left at AutoFocus and AutoExpose, respectively, (f) enters a Plate ID (identification), Plate Name, and any comments (see reference numeral 42 in FIG. 3), and (g) clicks on start button 44 in FIG. 3. Steps (a) to (e) can usually be set ahead of time and saved using a pull-down menu. Thus, the operator usually needs to enter only steps (f) and (g) to start a typical run.

The ArrayScan device can provide additional information concerning a well being read or scanned (i.e., a well from which an image is being acquired), such as when the well contains too many cells (“Above Range”) or too few cells (“Below Range”). This option is not usually needed when acquiring images from a well and, therefore, in a typical AcquireOnly run, only Plate ID, Well ID, Field ID, and corresponding images are displayed at run time on the computer screen.

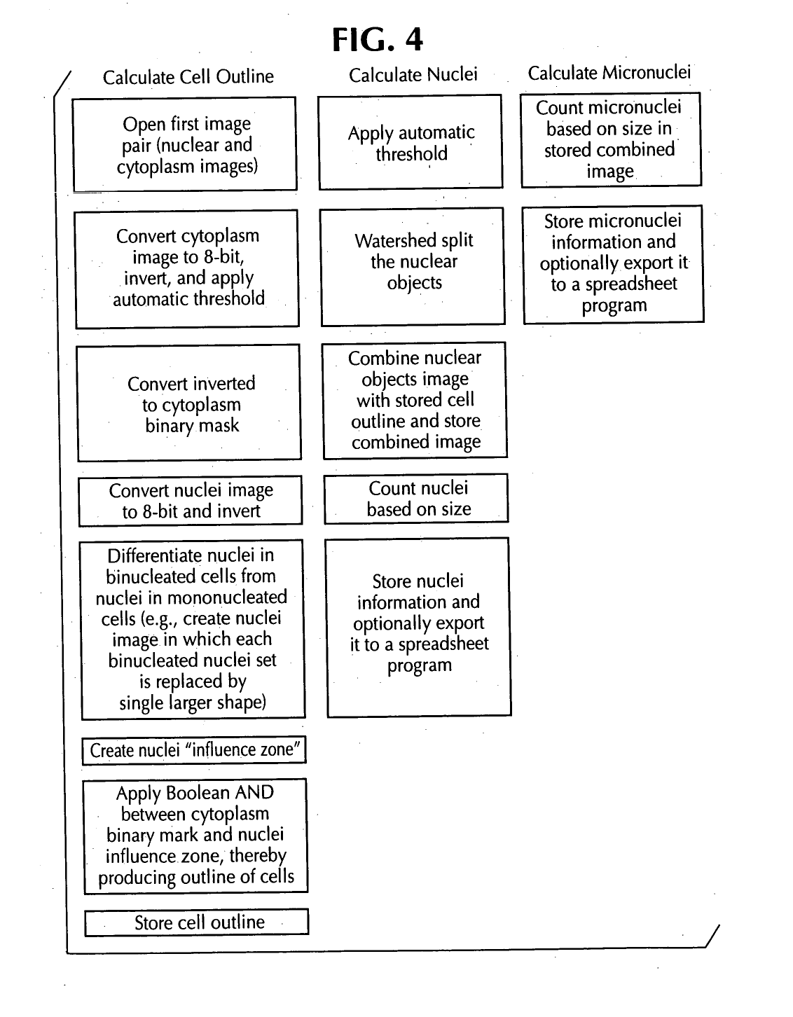

FIG. 4 This figure is a block flow diagram of the “Image Analysis” phase, in which image data are processed (see also FIG. 1) and will be further discussed below.

Using the protocol discussed above, one of the wells in a microwell plate was inoculated with 2,500 Chinese hamster ovary cells in a growth medium containing Cytochalasin B, incubated with 50 ng/ml (nanograms/milliliter) of mitomycin C (as the chemical stimulus) for 24 hours at 37 degrees Centigrade, washed, fixed, permeabilized, sequentially treated with Hoechst 33342 and acridine orange, and washed. The microwell plate containing this well was then read by the ArrayScan II automated microscope using 200× magnification to acquire the images for each different wavelength of light used (i.e., a given number of images were acquired when the microwell was illuminated with UV light to highlight the nuclear material and the same number of corresponding images were acquired when the microwell was illuminated with green light to highlight the cytoplasmic material). The image data were digitized and stored in the computer that is part of the ArrayScan II microscope system. Any appropriate software and algorithms may be used for digitizing the images, and the particular software and algorithms are not critical provided the software and algorithms allow the benefits of this invention to be achieved.

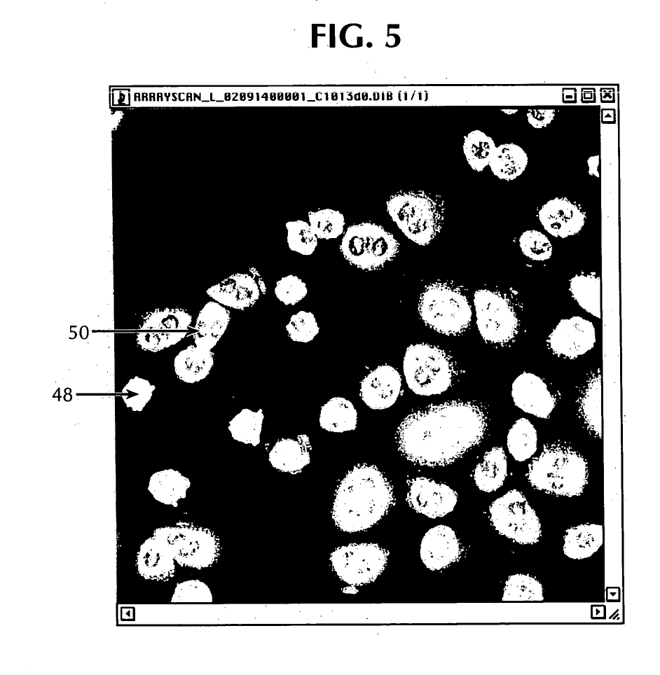

FIG. 5 This figure is a digitized version (reference numeral 28 in FIG. 1) of one of the images acquired by the ArrayScan II automated microscope (reference numeral 22 in FIG. 1) showing stained cytoplasmic material. A black background provides additional contrast with the cell features (a white background could also have be used, in which case the rest of FIG. 5 would preferably be inverted on the greyscale, i.e., white in FIG. 5 would appear black). Reference numeral 48 indicates a single cell in FIG. 5 and reference numeral 50 indicate a clump of cells (a cellular clump). Such clumps in the microwell occur for several reasons, including because of the large number of cells that are preferably present in the microwell to provide statistically valid results (e.g., for micronuclei screening, preferably about 2,500 viable cells at the end of the “Biology” phase and desirably at least 1,000) and because of the natural affinity of the cells for one another, both of which affect the distribution of the cells on the microwell wall when the well is first seeded. As is evident in FIG. 5, many of the cells are clumped together and are not completely discrete objects, i.e., many of the cells are not free from contact with other cells.

Cellular clumps pose significant problems for image processing because image processing algorithms typically have difficulty in determining where one cell begins and another ends when the cells are touching. The inability to determine cell boundaries with any degree of accuracy (or to even distinguish one cell from another) can significantly affects the results. For example, if the algorithm cannot distinguish most of the cell boundaries, the cell count may be grossly inaccurate (i.e., the number of cells determined will be lower than the true number of cells). For micronuclei screening, that in turn will make it difficult to determine how many nuclei are in each cell, in other words, it will be difficult to correctly determine which cells are binucleated (i.e., the number of binucleated cells determined will be higher than the true number of binucleated cells), yet as discussed above, the binucleated cells are desirably identified so the presence of any micronuclei in them can be determined. The error of determining that the number of binucleated cells is higher than in actuality will result in erroneously underestimating the micronuclei frequency when that frequency is expressed as the number of micronuclei per binucleated cell (which is the preferred way of expressing it). That in turn could cause a drug candidate to be erroneously determined to be non-aneugenic/non-clastogenic.

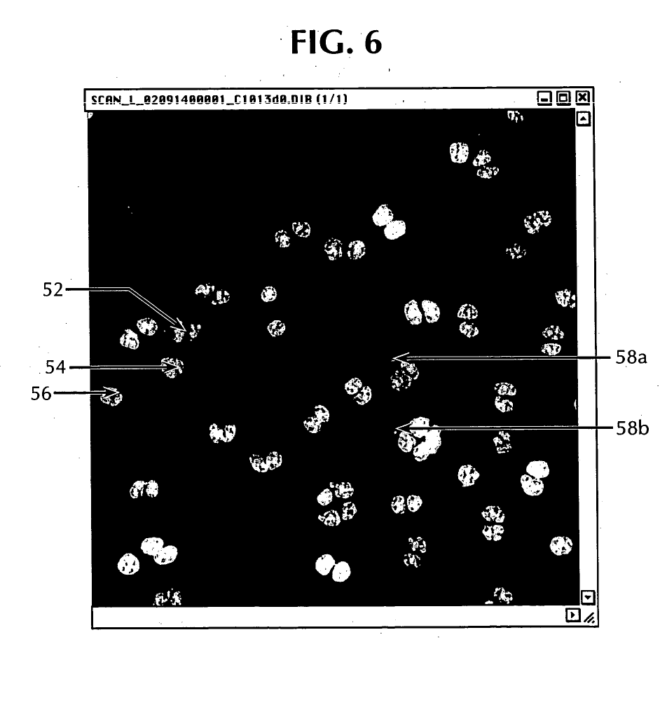

FIG. 6 A second and separate “clumping” problem is evident in FIG. 6, which is a digitized image (reference numeral 28 in FIG. 1) of the same field shown in FIG. 5 but showing highlighted (stained) nuclear material (i.e., nuclear objects) rather than highlighted (stained) cytoplasmic material. Comparison of the two figures confirms that it is the same field for the two images (e.g., the inner round portions of the cells of clump 50 in FIG. 5 correspond to clumped nuclear material 52 in FIG. 6). FIG. 6 also contains unclumped or single pieces of nuclear material, e.g., indicated by reference numerals 54 and 56. As will be discussed below, FIG. 6 also contains two micronuclei, indicated by reference numerals 58a and 58b. In FIG. 6, a black background provides additional contrast with the nuclear material (a white background could also have been used, in which case the rest of FIG. 6 would preferably be inverted on the greyscale, i.e., white in FIG. 6 would appear black). As in FIG. 5 (in which cells are clumped together), FIG. 6 shows that nuclear objects can also appear to be clumped or clustered together, making it difficult to determine how many nuclear objects are within a cell. That in turn makes it difficult to determine whether a cell contains more than one nuclei (i.e., is binucleated) and/or whether it contains a micronucleus in addition to one or more nuclei.

It is an important feature of this invention that it can rapidly and with a very low error rate resolve cellular clumps into individual cells, thereby allowing the outlines of the cells in the sample or portions thereof to be determined. It is also an important feature of this invention that it can rapidly and with a very low error rate resolve nuclear object clumps (or clumps of other target objects) into individual nuclear objects (or into individual target objects), thereby allowing the outlines of the nuclear objects (or of individual target objects) in the sample or portions thereof to be determined. Both features are quite significant and advantageous.

To implement the preferred image analysis algorithms, an image processing language, IPBasic (developed and marketed by Media Cybernetics (Silver Spring, Md., US) as Image-Pro Plus version 4.1 for Windows), is used to instruct a computer with a Windows-based operating system to implement the automated image processing and analysis method. The IPBasic commands are a subset of the BASIC language and conform to Visual Basic syntax. Prefereably, there is one set of IPBasic and Visual Basic codes for counting micronuclei in CYB-treated (binucleated) cells and a set of IPBasic and Visual Basic codes for counting micronuclei in non-CYB-treated (mononucleated) cells are part of this application and are contained in the Computer Program Listing Appendix. From the disclosure of this application, including the disclosure of the image processing strategies and image analysis methods, it will be apparent to those skilled in the art that other computer languages (e.g., C, C++, Java, MatLab) can be used to implement these or similar image processing strategies and image analysis methods.

The purposes of image processing include correcting image defects (e.g., background noise), image enhancement (e.g., enhancing signal to noise ratio), segmentation and thresholding to create binary images, and further processing of binary images. The purposes of image analysis include determination of image measurements (counts, size, etc.) and further processing of these measurements (calculating sum, mean, standard deviation, ratio, etc.). This invention applies a variety of these tools in a logical combination to automatically resolve cell clumps into individual cells and count the number of regular-sized nuclei, micronuclei, and other target objects on a cell-by-cell basis.

With reference again to FIG. 4, and keeping in mind that nuclear objects are either nuclei or micronuclei, the preferred algorithm of this invention may for micronuclei screening be considered to have three main functionalities: the determination (or calculation) of the individual cell outlines (the left column in FIG. 4), the determination (or calculation) of regular nuclei (the middle column in FIG. 4), and the determination (or calculation) of micronuclei (the right column in FIG. 4). The first two steps of the image processing routine are to open a digitized and stored image of the cytoplasm of a field (e.g., FIG. 5) and a digitized and stored image of the nuclear objects of the same field (e.g., FIG. 6).

As is known to one skilled in the art, one typically needs to examine up to a hundred of representative or test set images to derive an image processing and analysis strategy. These representative or test set images are typically obtained during a testing phase by following the biological protocol but varying one key variable, for example, the concentration of a control compound whose experimental outcome is largely known. Once a set of test images is obtained under controlled conditions, it is assumed that if one skilled in the art were to repeat that experiment, the images obtained would be largely similar or analogous. Therefore, the image processing and analysis solutions designed, tested, and found to be satisfactory during the testing phase can be similarly implemented for testing unknowns. Unexpected outcomes do occasionally occur, in which case the biological protocol and/or image processing and analysis solutions need to be changed (i.e., fine-tuned). One skilled in the art will know how to modify the preferred micronuclei image processing and analysis solutions being described in connection with FIG. 5 et seq. for other cell types, other highlighting agents, other targets, etc.

For example, in some methods of setting the image intensity threshold (for thresholding operations), a computer algorithm may be used to compute the threshold and that algorithm may be obtained from one or more previously collected analogous images. “Analogous images” are images that one skilled in the art would recognize as being similar enough to provide meaningful data for establishing procedures, solutions, constants, or other required information. Thus, if a particular type of cell, particular coloring agents, and a specific microscope are to be used for screening proposed drug candidates for micronuclei formation, one skilled in the art would recognize that several images could be acquired in advance using exactly the same methods and materials but with positive and negative controls instead of the candidates (or with serial dilutions of the positive control from a maximum concentration down to zero) and that those images could be used as the “analogous images.”

With reference again to FIGS. 5 (cytoplasm image) and 6 (nuclei image of the same field), one skilled in the art may use any known methods to correct defects in these images. For example, one can apply background subtraction, smooth images by applying mathematical filters, and/or enhance the images by linearly combining the cytoplasm image and nuclear objects image location by location (i.e., pixel by pixel). Combining the two images from the same image field may be important for other cell types or highlighting reagents whose cytoplasm images contain very dim signals in the nuclear regions.

For the cytoplasm image shown in FIG. 5 (and in the case when CHO cells and acridine orange are used), the cytoplasm signal contain strong signals throughout the cytoplasm and nuclear regions. Accordingly, the cytoplasm image is preferably converted to an 8-bit scale (i.e., a scale having 256 gradations, which are the whole numbers in the range of from 0 to 2⁸−1, or 255) and is accomplished by setting 1.5 times the dimmest pixel in the original cytoplasm image to the new minimum of 0 in the 8-bit image and also setting the mean pixel value of the original image plus an offset of 100 to the new maximum of 255 in the 8-bit image. This conversion is desirable for the micronuclei analysis described in connection with FIG. 5 et seq. because it conserves storage space, minimizes the background in the 8-bit image, and maximizes the cytoplasm signal in the new 8-bit image, thereby preparing the image for automatic thresholding (which is described below). “A constant times the dimmest pixel” and “mean plus a constant offset” are deemed appropriate for the experimental conditions disclosed herein (cells used, stains and staining conditions used, type of image acquisition machine used, etc.); however, it will be apparent to one skilled in the art that the values of the constant and of the offset may be altered depending on the experimental conditions used. For converting both nuclear object and cytoplasm images, constants other than 1.5 or 2.0 maybe used. One may optionally multiply by a constant in the range of from 1 to 3. Furthermore, and more generally, an “n-bit” scale could be used (e.g., a 12-bit scale). One skilled in the art will know how to convert image data (whether cytoplasm image data, nuclear objects image data, or, more generally, target objects image data) to an n-bit scale.

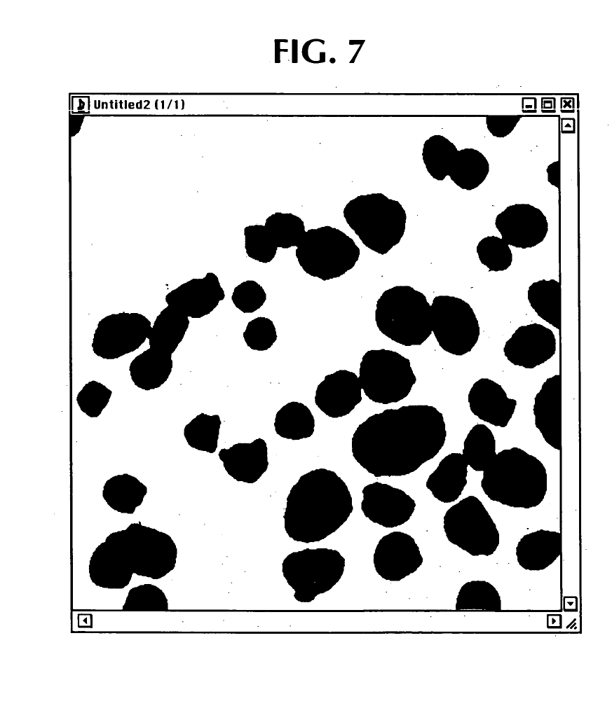

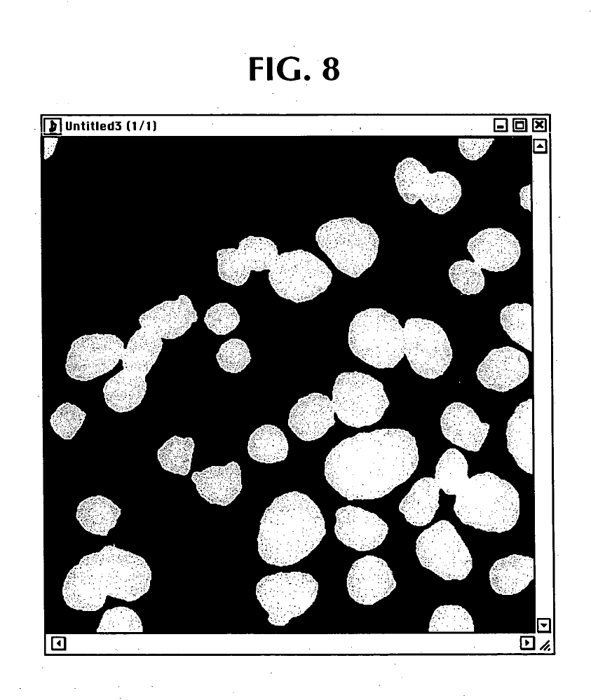

FIG. 7 The 8-bit image of the cytoplasm (resulting from converting the image data shown in FIG. 5 to 8-bit) is inverted (i.e., the background becomes bright and the cytoplasm signals become dark) and an automatic dark threshold command from Image-Pro Plus is applied (FIG. 7). Another thresholding operation results in the image becoming a binary image in which intracellular space becomes 0 and extracellular space becomes “1” (or vice versa). The binary image, which is shown in FIG. 8, may also be referred to as a “binary mask.”

FIG. 8 Various methods are known in the art for determining an appropriate intensity threshold value. See, e.g., Ritter et al., Handbook of Computer Vision Algorithms in Image Algebra, 2^{nd} edition, particularly Chapter 4 (“Thresholding Techniques”), pages 137-153 (CRC Press LLC, 2001). Selecting an intensity threshold usually involves examining the image itself (i.e., examining the image data themselves, which may be in the form of a histogram). For example, the threshold value may be selected by using the mean and standard deviation values that are intrinsic to the image being processed, by determining the maximum negative slope of the histogram, by using the inflection points of the histogram, by using a bi-modal separation, by using triangulation, by using merge/split continuity algorithms, by subtracting a fixed percentage from the highest value in the histogram, or by using any of the foregoing to which an offset value is added. Because in the method being described in connection with the figures the cytoplasm signals are maximized by converting the mean pixel value of the original image (plus the offset of 100) to 255 in the 8-bit image, an automatic dark threshold command from Image-Pro Plus is sufficient to segment (separate or distinguish) the intracellular space (light region in FIG. 8) and the extracellular space (dark region in FIG. 8). Therefore, this invention provides a method to quantify the count, size, and location of target objects within cells (in the intracellular space) as well as target objects outside the cell (in the extracellular space).

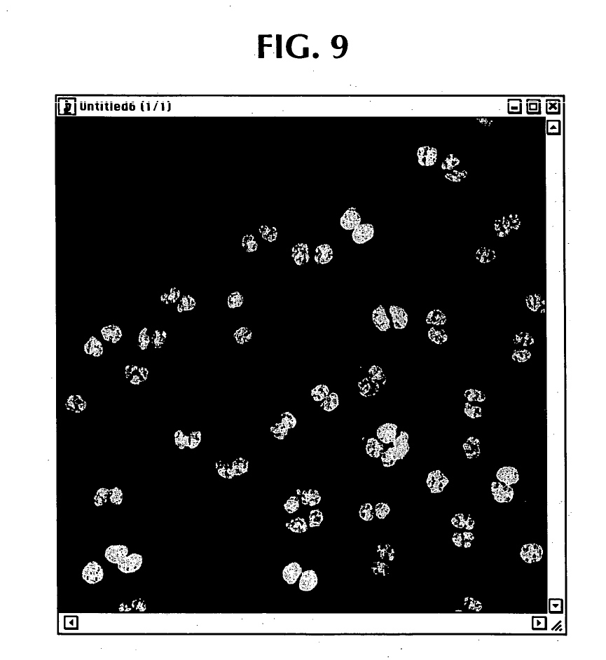

A similar method is used to convert the digitized nuclei image of FIG. 6 to an 8-bit image (shown in FIG. 9). Twice the dimmest pixel in the original nuclear objects image is set to zero and twice the mean pixel value of the original nuclear objects image (without adding any offset) is set to the new maximum of 255. This minimizes background impulse noise and maximizes nuclear object or target object signal. Other image processing tools (as discussed above for the cytoplasm images) can be used instead for this purpose.

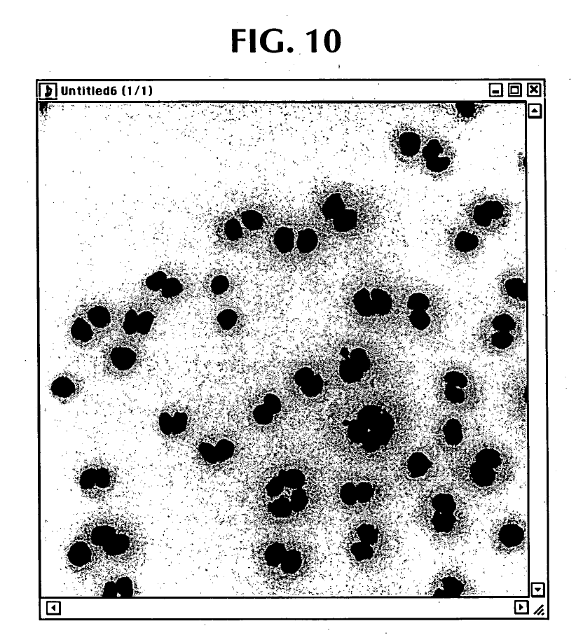

FIGS. 9 & 10 The image data of FIG. 9 are then inverted, and the resulting image is shown in FIG. 10. As shown in those two figures, the bright nuclear objects in FIG. 9 become the dark nuclear objects in FIG. 10, and the dark “extranuclei region” in FIG. 9 becomes white in FIG. 10. The digitized image of FIG. 10 is now ready for automatic thresholding and image segmentation.

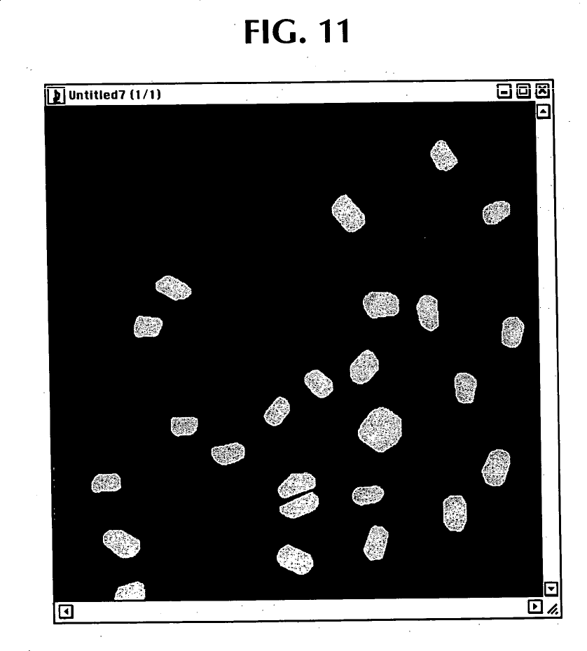

FIGS. 11 to 16 These figures result from a series of image segmentation steps for differentiating nuclei in binucleated cells (i.e., cells with two or more nuclei) from nuclei in mononucleated cells (i.e., cells with a single nuclei). A valuable feature of this invention is that it allows differentiating binucleated cells from mononucleated cells, which is particularly valuable when the process of this invention is used for micronuclei screening. Broadly speaking, nuclei in a binucleated cell are closer to each other than nuclei in separate single nucleated cells and that difference may be utilized when imaged with sufficient magnification (e.g., 200×). The present invention utilizes this difference in an iterative process to select, isolate, and differentiate nuclei in binucleated cells from nuclei in mononucleated cells.

In FIG. 11, which illustrates the first iterative gating process, those binuclei that are already connected or touching each other are selected based on perimeter convex (in all of FIGS. 11 to 18, the nuclei and background are inverted as compared to FIG. 10). By utilizing perimeter convex, a smooth spherical shaped object is created around an irregularly-shaped object and the perimeter of the convex object is calculated. Binuclei (i.e., two or more nuclei) that are touching each other together have a much larger perimeter convex than a single nucleus. Comparing FIG. 11 to FIG. 10 shows the result of this step, namely, the substitution in FIG. 11 of a convex shape for the nuclei shown in FIG. 10 that are determined to be sufficiently close to be touching or connected to each other and the absence of any shape in FIG. 11 for those nuclei of FIG. 10 that do not meet that criterion.

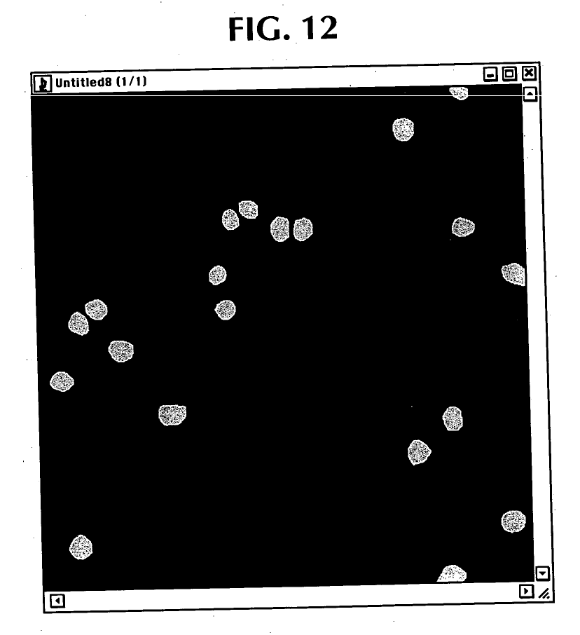

FIG. 12 shows the result of the second gating process, namely, those nuclei of FIG. 10 that are determined (from their smaller perimeter convex) not to be sufficiently close to be touching or connected to each other. These non-touching/unconnected nuclei are either independent nuclei (i.e., nuclei in separate cells) or nuclei from the same cell that are not touching but still may be close to one another (although not sufficiently close to be selected by the first gating process). Together the shapes shown in FIGS. 11 and 12 account for all of the nuclei shown in FIG. 10 that are sufficiently within the field (e.g., the two small parts of nuclei shown along the right edge of FIG. 10 are not accounted for in either FIG. 11 or 12 because they are not sufficiently within the field).

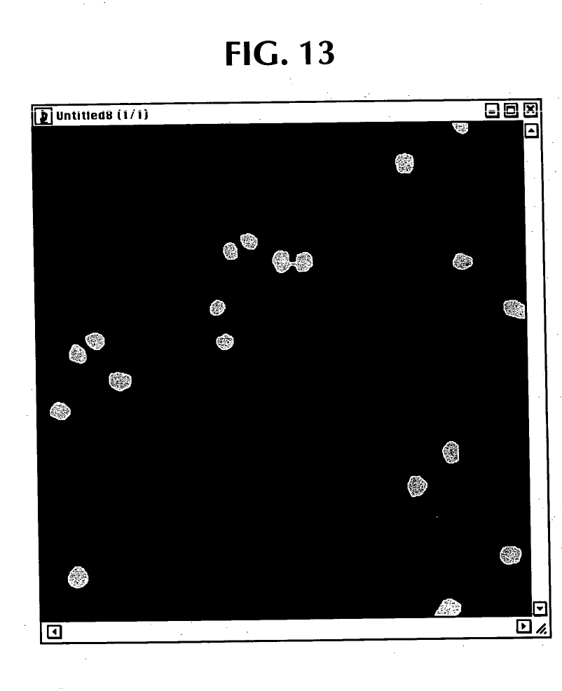

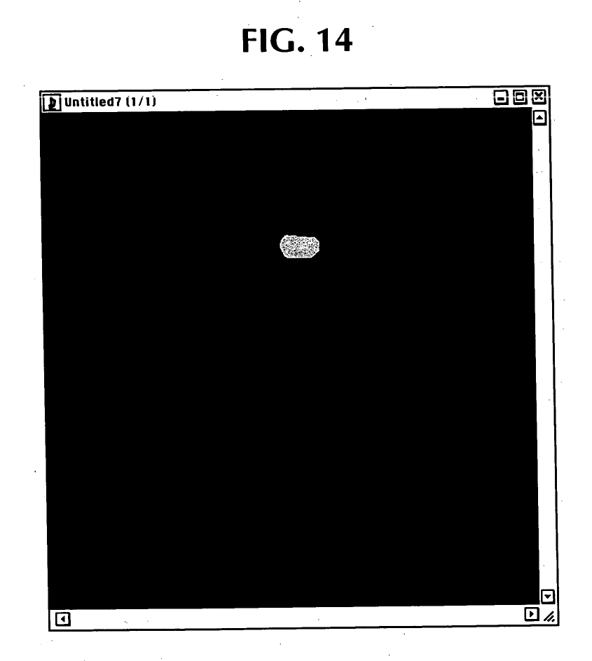

FIG. 13 shows the results of applying a first close and erosion process to the image data of FIG. 12 to connect close-by nuclei (i.e., nuclei that are presumed to be from the same cell). As shown in FIG. 13, one pair of nuclei has been connected (in the upper middle of the drawing). This assemblage of connected nuclei is selected (gated out) based on its larger perimeter convex (FIG. 14).

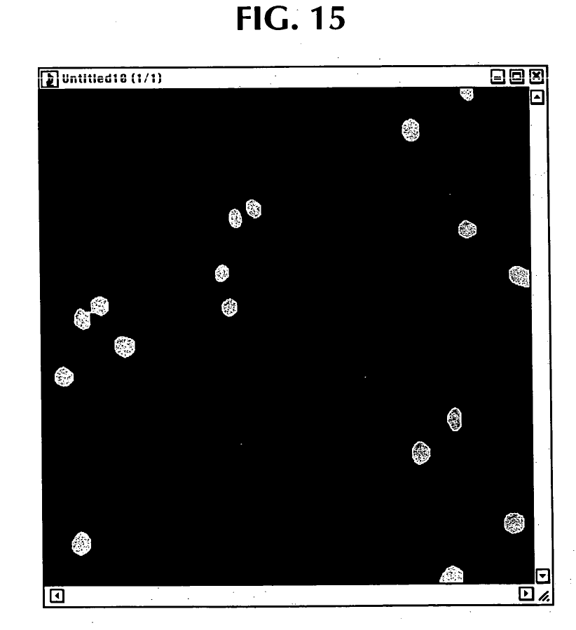

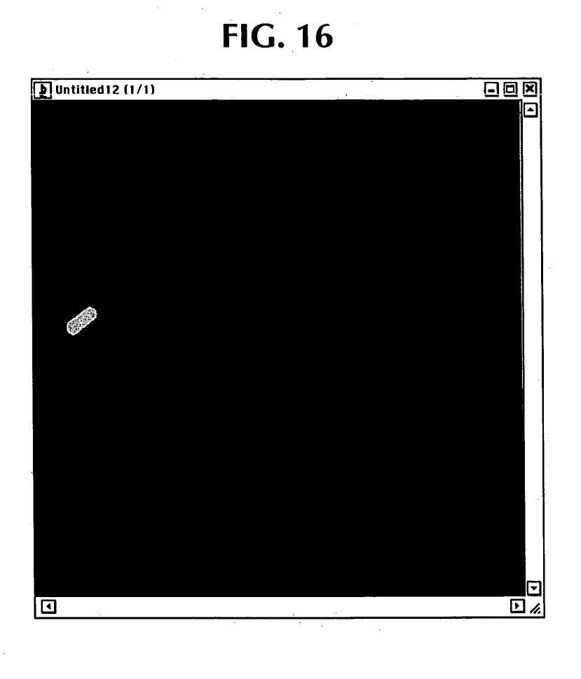

A second slight close and erosion process is performed on the remaining nuclei in FIG. 13 (i.e., those nuclei not gated out from FIG. 13 to produce FIG. 14) to connect close-by nuclei (i.e., nuclei that are presumed to be from the same cell). One such pair of nuclei near the middle of the left portion of FIG. 15 has been connected and that assemblage is selected (gated out) based on its larger perimeter convex (FIG. 16).

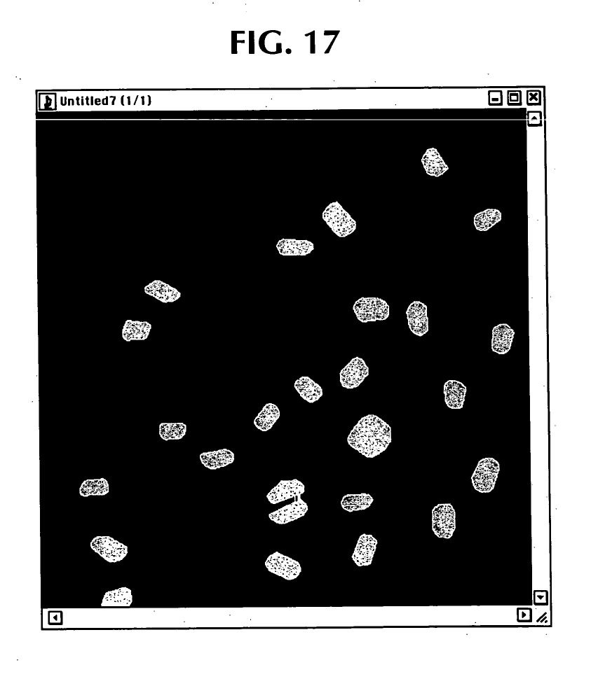

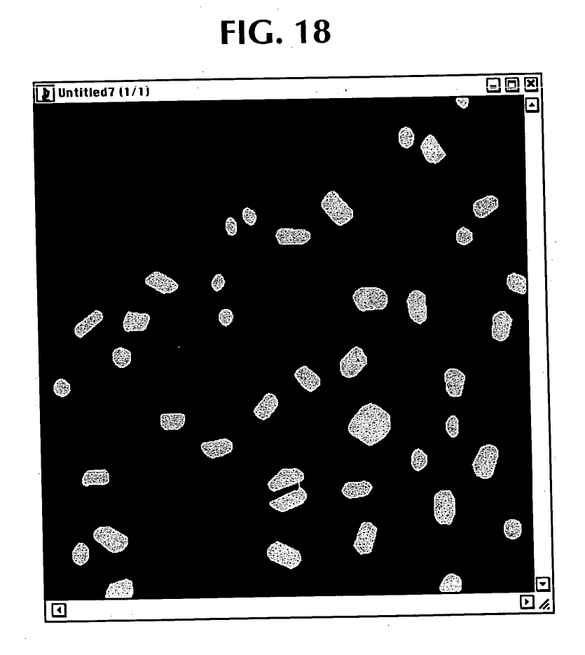

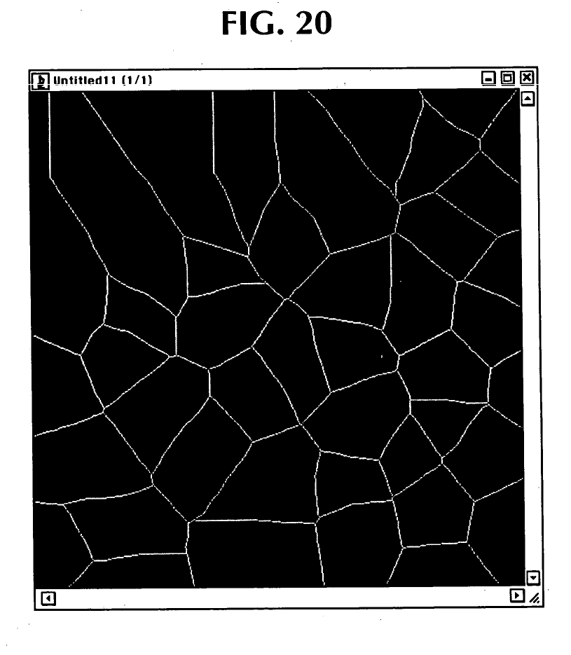

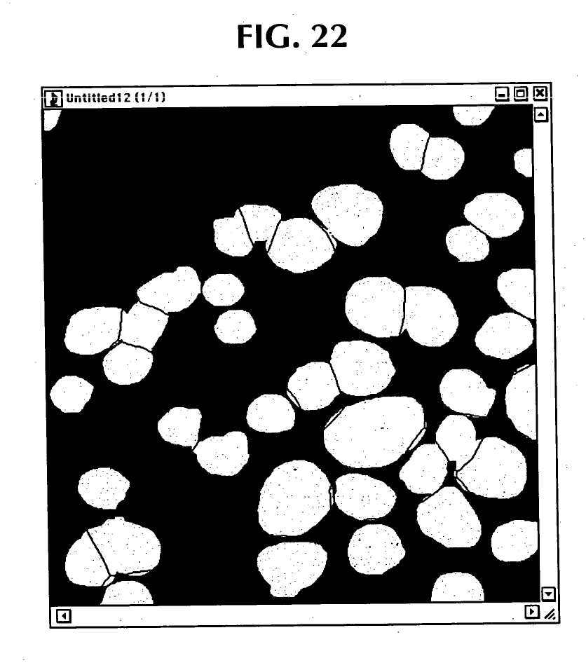

FIGS. 17 and 18 These figures show the results of combining or reconstructing the segmented nuclei images of FIGS. 11, 14, 15, and 16. As noted above, a valuable feature of this invention when used for micronuclei screening is that it allows differentiating binucleated cells from mononucleated cells. FIG. 17 represents a combination of the image data of FIGS. 11 and 14 and contains shapes representing nuclei in cells that have been determined to be binucleated because they are connected or because they are sufficiently close. FIG. 18 represents a combination of the image data of FIGS. 15, 16, and 17 and contains all of the nuclei shown in FIG. 10 (except for those nuclei that are not sufficiently within the field) but with larger convex shapes substituted for all sub-groups of nuclei that have been determined to be in cells that are binucleated (the nuclei of FIGS. 11, 14, and 16). In other words, the result of this iterative process is that each discrete white object in FIG. 18 represents the one or more nuclei of a discrete cell. As explained below, these discrete objects of FIG. 18 are used in subsequent steps to create an influence zone diagram (FIG. 20) and ultimately a cell-by-cell outline (FIG. 22).

Using these image segmentation steps, each group of nuclei that were connected or close-by to one another have been replaced a single substantially convex shape. For example, the four connected nuclei in FIG. 10 (to the lower right of the center of the field) have been replaced a single larger substantially convex shape in FIG. 11, which is also shown in the “summation” figure, FIG. 18. The two close-by nuclei of FIG. 13 have been replaced by a single convex shape, which is shown in FIG. 14 and then in the “summation” figure, FIG. 18. Similarly, the two close-by nuclei of FIG. 15 have been replaced by a single convex shape, which is shown in FIG. 16 and then in the “summation” figure, FIG. 18. All of the connected and close-by nuclei are combined with the single nuclei to produce the “summation” figure, FIG. 18. As will be discussed below, that figure is used to create the “nuclei influence zone” data (FIG. 20), which are needed to determine the cell outlines (i.e., to resolve the cellular clumps).

In a preferred embodiment, the separate steps for determining which nuclei are sufficiently close to other nuclei to be “replaced” by a single substantially convex object may be combined. In other words, the steps resulting in the image data depicted in FIGS. 14 (from a first close and erosion operation) and 16 (from a second close and erosion operation) may be carried out in a single operation. That streamlined scheme is what is used in the preferred computer program in the Computer Program Listing Appendix and gives essentially the same ultimate results as the scheme reflected in FIGS. 11 to 18.

As will be understood by one skilled in the art, for any given nucleus in an image field, the Voronoi polygon is the locus of points that are closer to the given nucleus than to any other nucleus in the image field. The Voronoi diagram is also commonly known as an “influence zone” diagram or a “zone of influence” diagram. As indicated below, the Voronoi technique is only one way to create an influence zone diagram. Essentially all programming languages will support the Voronoi diagram. For example, C programming language can be used to create a Voronoi diagram to supplement the diagnosis of malignant tumors (Weyn et al., “Computer-Assisted Differential Diagnosis Of Malignant Mesothlioma Based On Syntactic Structure Analysis,” Cytometry, volume 35, pages 23-29 (1999)).

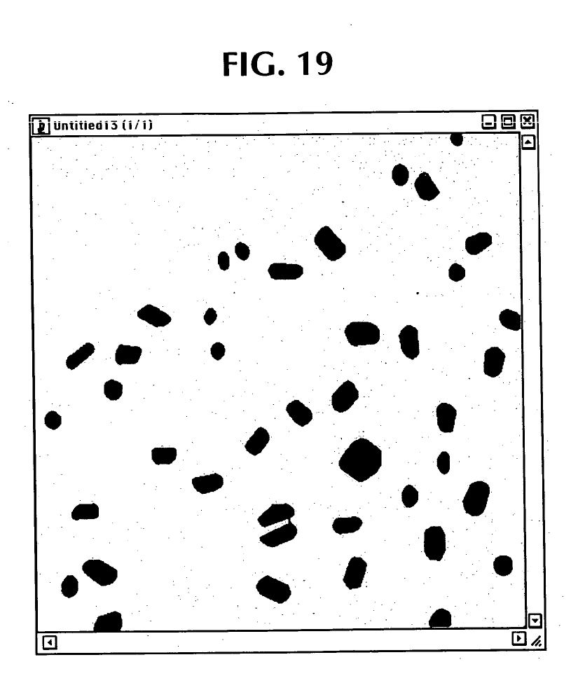

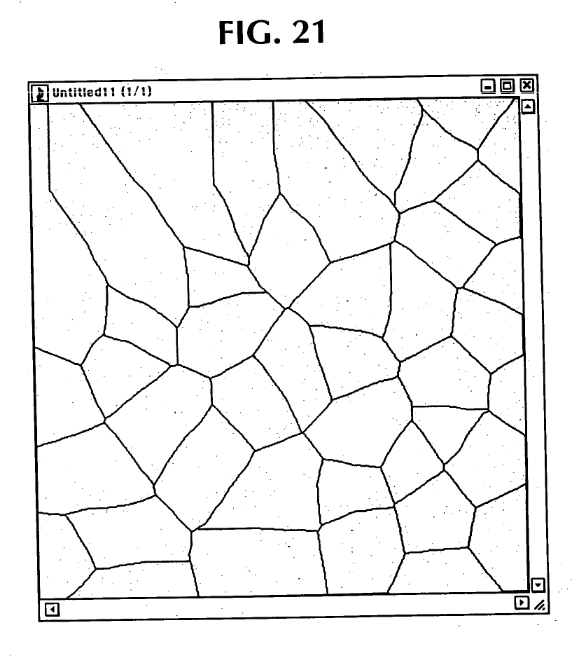

FIGS. 19-21 In IPBasic or Image-Pro Plus (being used here), a Voronoi-type diagram can be “constructed” using the following image processing steps. First, the nuclei image of FIG. 18 is inverted so that extranuclear space is now bright and every nucleus in dark or black. The inverted image is shown in FIG. 19. Then a thinning and pruning filter is applied to the inverted image. The thinning filter reduces an image (in this case, the extranuclear space) to its skeleton. The pruning filter eliminates projecting arms from an object (in this case, any small projecting arms (noise) in the skeleton). FIG. 20 shows the result of the thinning and pruning operation (a modified Voronoi operation) and is a nuclei influence zone diagram. Fig. 20 is inverted to yield FIG. 21. There are many ways to apply a thinning and pruning filter. The present invention preferably uses a modified Voronoi procedure. In some cases, depending on the objects for which an influence zone diagram is to be created, thinning alone or pruning alone may be used.

FIG. 22 To resolve cellular clumps into individual cells, in other words, to prepare a cell-by-cell outline, a Boolean AND operation is applied between the inverted nuclei influence zone (FIG. 21) and the cytoplasm binary mask (FIG. 8). The result of this AND operation is a cell-by-cell outline and is shown in FIG. 22. Comparison of FIGS. 22 and 5 (cellular image with stained cytoplasm) shows the significant progress that has been made to resolve (or split) the cellular clumps of FIG. 5. FIG. 22 is saved for further image processing and analysis of cell-by-cell data of target objects. That completes the steps in the left column of FIG. 4 (the determination (or calculation) of the individual cell outlines).

As previously noted, a valuable feature of this invention is its ability to resolve cellular clumps into individual cells. Although preparing an influence zone diagram using a modified Voronoi operation is the preferred method of doing this, other strategies may be used. For example, one can used limited erosion, dilation, and closing to split connected cells that have a generally round or spherical shape. Another useful method is using contour-based segmentation algorithm that also works well for objects that have a generally round or spherical shape (Belien et al., “Confocal DNA Cytometry: A Contour-Based Segmentation Algorithm For Automated Three-Dimensional Image Segmentation,” Cytometry, volume 49, pages 12-21 (2002)). Yet another useful method employs a distance map (e.g., Euclidean distance map) and/or watershed split (Russ, The Image Processing Handbook, 3^{rd} edition, ISBN 0-8493-2532-3 (CRC Press, 1998)). As discussed below, a watershed split is used to split or resolve nuclear object clumps.

The advantage of applying a Boolean AND between the nuclei influence zone and the cytoplasm binary mask is that the cells do not need to be generally round or spherical. As long as the cytoplasm image and nuclei image data are available and the nuclei are centrally located or are close to being centrally located inside the cells, this strategy (applying the Boolean AND) can be used. As in Sudbo et al., “New Algorithms Based On The Voronoi Diagram Applied In A Pilot Study On Normal Mucosa And Carcinomas,” Analytical Cellular Pathology, volume 21, pages 71-86 (2000), it is reasonable to expect that the sample size requirements should hold true for the present invention, in other words, that a sufficient sample size is needed to utilize the influence zone-based computational method in the present invention. In fact, it has been found that a minimum of 1,000 nuclei is sufficient to yield satisfactory results.

Biological methods based on special highlighting reagents may also be used instead of the influence zone-based image processing method for resolving cellular clumps. These methods may be more advantageous in cases where the cell nuclei are not centrally located or close to being centrally located inside the cells. In many types of cells (e.g., Caco-2 cells, MDCK cells, liver cells), there are specialized proteins (e.g., tight-junction complex proteins, cell-surface proteins, transporter proteins, other membrane proteins) that express on the cell surface or at the junction between two adjacent cells. Special highlighting agents (e.g., labeled antibodies to these cell-surface proteins, or protein chimeras fused to luminescent proteins) can be used to delineate the boundaries between adjacent cells. For example, in Harris et al., “Identification Of The Apical Membrane-Targeting Signal Of The Multidrug Resistance-Associated Protein 2 (MRP2/cMOAT),” Journal Of Biological Chemistry, volume 276, number 24, pages 20876-20881 (2001), the green fluorescent proteins fused to MRP1 or MRP2 cell-surface proteins are able to delineate the cell outlines of two adjacent cells. Those skilled in the art will understand how to utilize other cell-surface proteins to resolve the cellular clumps into individual cells and determine their locations. Cell-surface proteins include: (1) transporter proteins for anions, cations, ions, hormones, nutrients, etc.; (2) cell-surface receptors, such as G-coupled protein receptors, hormone receptors, nutrient receptors; and (3) proteins associated with cell junctions. Many of these proteins, but not all, have names from large protein families followed by a unique membership number (e.g., MRP1, MRP2, MRP3, MRP6, MDR1, MDR3, BSEP, OATP-A, OATP-C, OATP-8, OCT1, OCT2, OCT3, OCTN1, OCTN2, OCTL3, OCTL4, OAT1, OAT3, NTCP, and ISBT).

As noted above, a valuable feature of this invention is that it can differentiate binucleated cells from mononucleated cells. Binucleated cells naturally occur in some cell types (e.g., liver cells, primary hepatocyte cultures). Even for uses other than micronuclei screening, it may be advantageous to identify both binucleated cells and mononucleated cells (e.g., to help provide an accurate cell count, to estimate the percentage of binucleated cells).

Although perimeter convex is preferably used iteratively to select nuclei that are close-by and therefore can be connected by dilation, close, or opening, image features other than perimeter convex can also be used. They include perimeter, area, shape factor (perimeter square divided by 4 pi area), and aspect ratio (length divided by width). In the preferred scheme for micronuclei analysis, binucleated nuclei are differentiated from mononucleated nuclei based on their relative distance to each other (i.e., binucleated nuclei are closer to each other than mononucleated nuclei from separate cells). Alternatively, special biological highlighting reagents may be used to differentiate binucleated cells from mononucleated cells. For example, in normal dividing cells, binucleated cells have undergone DNA replication while mononucleated cells are still in the G0/G1 phase prior to DNA replication. Therefore, biological highlight reagents that can differentially stain DNA replication and/or cell cycle can be used to differentiate these subpopulations of cells. For example, nucleotide analogs such as BrdUTP, Cy5dUTP, etc. can be used to label DNA replication. Also, for example, cell cycle-specific cyclins and cyclin kinases may be used as antigens to differentially stain cells in different cell cycles, and luminescent fusion proteins may be made to highlight cells in a specific cell cycle.

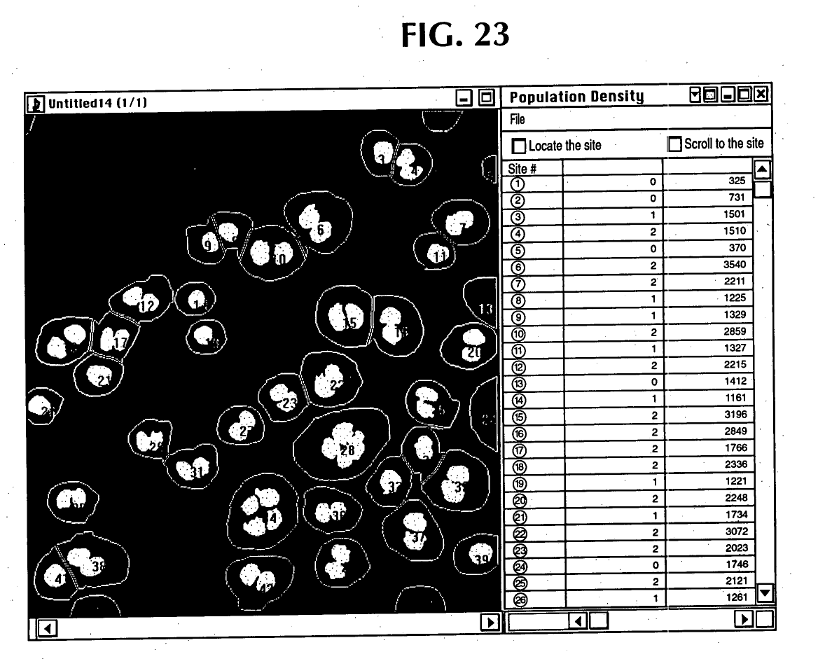

FIGS. 23 & 24 Having completed the steps for determining the cell outline, we turn to the determination (or calculation) of regular nuclei (the middle column in FIG. 4). In FIG. 23, the nuclei image from FIG. 10 (the inverted 8-bit nuclei image, which comprises image data for both nuclei and micronuclei) is thresholded by applying an automatic dark threshold in Image-Pro Plus. A watershed split is performed to split or resolve clumped nuclear objects. (The watershed split algorithm used is similar to known algorithms. See, e.g., Malpica et al., “Applying Watershed Algorithms To The Segmentation Of Clustered Nuclei,” Cytometry, volume 28, pages 289-297 (1997).) Because nuclei are generally round or spherical in shape, the watershed split provides satisfactory results. The nuclear objects are then combined with the cell-by-cell outline from FIG. 22 in population density operations (further described below). The normal size nuclear objects (i.e., nuclei) in each site or cell are selected based on their size, and the number of regular sized nuclei in each site or cell is reported in the Population Density table in FIG. 23. For example, in the Population Density table of FIG. 23, site or cell 3 (near upper right corner of field) has one normal size nuclei (i.e., a mononucleated cell), while site or cell 4 (just to the right of site or cell 3) has two normal size nuclei (i.e., it is a binucleated cell). This was entirely consistent with visual inspection and manual counting.

The population density operation involves determining whether target objects (in this case, nuclei) are within a cell (i.e., within the boundaries of the cell) and how many target objects are within the cell. Specifically, the operation involves “eroding” each target object to a single data location (e.g., pixel) that corresponds to the center of the target object. Eroding of image objects is known in the art and may be accomplished by any acceptable method. See, e.g., Russ, The Image Processing Handbook, 3^{rd} edition, ISBN 0-8493-2532-3 (CRC Press, 1998). The single location resulting from the erosion is then compared to the cell outline image data. If that single location lies within the cell outline, the nucleus whose data were eroded to the single location is considered to be within the cell and is counted (or identified) as being so located.

Although a population density operation is the most preferred method to calculate the number of target objects (in this case, nuclei) within each cell, other image processing and analysis methods can be used to accomplish the same task. For example, each nuclear object can be reduced to a single point (i.e., center of gravity) and the number of these points within each cell can be calculated computationally.

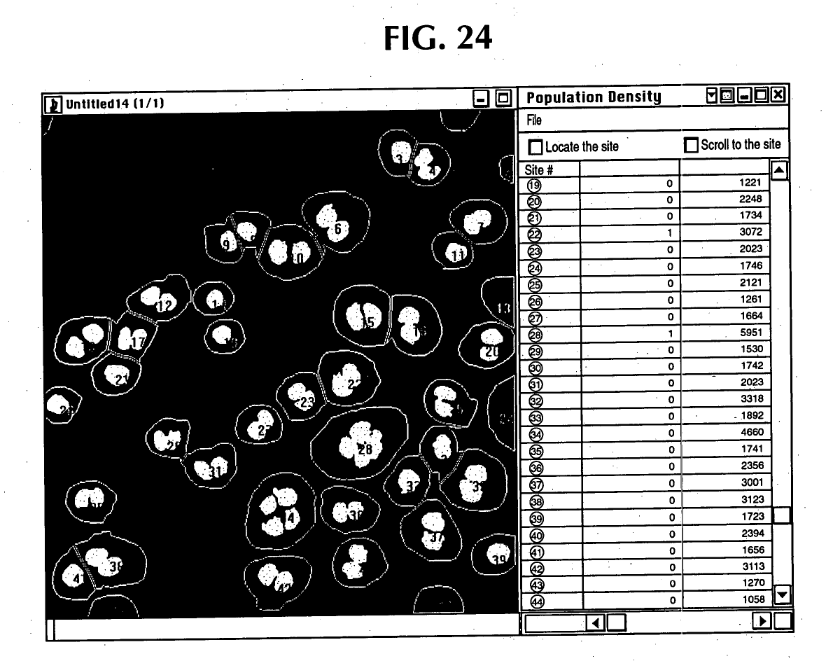

The micronuclei are then selected based on their smaller size. With the experimental conditions described (using Chinese hamster ovary cells, an ArrayScan II microscope at 200× magnification, etc.), a nuclear object size of less than 100 pixels is considered to be a micronucleus. A population density operation similar to that used to locate (e.g., determine whether they are inside cells) and count nuclei is used to locate and calculate the number of micronuclei in each cell. FIG. 24 shows the micronuclei as well as the nuclei in each site or cell. The only two micronuclei in the field of FIG. 24 are in cells 22 and 28 (cell 22 is just to the right of the center of the field and cell 28 is just below cell 22). The Population Density table of FIG. 24 shows sites (cells) 22 and 28 to each have one micronucleus and all the other sites (cells) to have none. That is consistent with visual inspection and manual counting.

Instead of using a watershed split to split or resolve clumped nuclear objects, other image processing methods may be used. For example, a combination of distance map (e.g., Euclidean distance map), watershed split, and AutoSplit function in Image-Pro can be used. An influence zone-based method may also be used if a centrally located marker inside a nucleus can be identified. One such marker is the nucleolus. Others known imaging processing methods that may be used include tophat transform, nonlinear Laplacian transform, and dot label methods to resolve nuclei clumps (see Netten et al., “Fluorescent Dot Counting In Interphase Cell Nuclei,” Bioimaging, volume 4, pages 93-106 (1996)).

The two Population Density tables in FIGS. 23 and 24 can be exported to a spreadsheet program such as Microsoft Excel to be further processed. For example, the Population Density table in FIG. 23 can be further processed using Excel to calculate the number of binucleated cells and the number of mononucleated cells. Using that information, the rate or frequency of the binucleated cells in the population within that field or within the entire microwell or within any sub-group of fields can be calculated as the number of binucleated cells divided by the total number of cells (the rate or frequency may be converted to a percentage by multiplying the rate or frequency by 100). Because one nuclear division without cytoplasmic division results in one binucleated cell, the rate or frequency of binucleated cells so calculated is equal to the rate or frequency of nuclear divisions that have occurred in the cell sample.

Still using Excel™ or another spreadsheet program, the Population Density table in FIG. 24 can be cross-referenced with the Population Density table in FIG. 23 because in the two figures (and therefore the two tables), the site or cell numbers assigned to any given site or cell are identical. Therefore, for example, the program could count micronuclei only from binucleated cells that have undergone only one nuclear division (e.g., cell 22, which, as shown in FIG. 23, has only two nuclei) or only from binucleated cells that have undergone two nuclear division and are thus quadruple-nucleated (e.g., cell 28, which, as shown in FIGS. 23 and 24, has four nuclei) or from all binucleated cells.

The data concerning cells and the number of targets within each cell (e.g., the number of nuclei and the number of micronuclei within each cell) need not be exported to a spreadsheet program (e.g., Excel™). Instead, determinations of which cells are binucleated, the micronuclei frequency, etc. may be made within the main program.

If more than one micronuclei is found in a single cell, the cell is likely undergoing nuclear fragmentation as a result of apoptosis (programmed cell-death) and, accordingly, should be discarded from the final analysis. The micronuclei rate or frequency can be calculated as the number of micronucleated cells divided by the total number of nuclear division in a sample (the rate or frequency may be converted to a percentage by multiplying the rate or frequency by 100). The number of nuclear division is typically defined using the following rules: a binucleated cell with two nuclei counts as one nuclear division and a binucleated cell with four nuclei counts as two nuclear divisions. Other definitions of micronuclei rate or frequency may be used.

Depending on the experimental design (e.g., cells used, incubation protocol), the micronuclei rate or frequency may be used to indicate the potential aneugenicity and/or clastogenicity and/or carcinogenicity and/or mutagenicity of the stimulus being tested (e.g., a drug candidate). The rate or frequency at which two or more micronuclei appear in a cell may be used to indicate apoptosis.

The rate or frequency of nuclear divisions in the cell sample can also be calculated. Such a “nuclear division index” can be used as an indicator of cytotoxicity. For example, a decrease in the calculated nuclear division index may indicate that the stimulus being tested (e.g., a chemical compound) adversely affects the nuclear division rate (i.e., that the stimulus slows down nuclear division in a sample of cells). Other information that can be obtained using the method of this invention will be apparent to those skilled in the art.

In the image analysis software, in addition to the code for resolving clumps of objects and for performing the other tasks described above for all of the images in an image directory, commands are included to provide as much flexibility as possible. Thus, the preferred software deals with missing image files and for starting at fields other than the field denominated as the zeroth field (i.e., the first field). Rather than sequentially using a listing of the image directory, the system mathematically generates the expected next image “name” and uses that name to find and load the image for analysis. Failure to load an image results in an error that leaves a blank line in the resulting Excel spreadsheet (when Excel is used) so that a researcher viewing the results can easily determine which images were skipped. When selecting the first image, that image's field number is used as the basis for all subsequent fields. The program can also distinguish between 96-well plates in the same directory and automatically updates the Excel spreadsheet when switching from one plate to another. That allows the image analysis routine to be performed automatically (i.e., without operator intervention) on 96-well plates in the same directory. The program includes an “auto-count” function to automatically determine how many image files are present in a directory for processing. During processing, the program captures the plate name, image name, and field name from the directory and reports them to Excel (if Excel is used). The reporting output typically comprises two “sheets” in a single Excel “workbook,” one sheet containing data outputs and images on a per field/per well basis and the second sheet summarizing the data outputs for the entire well.

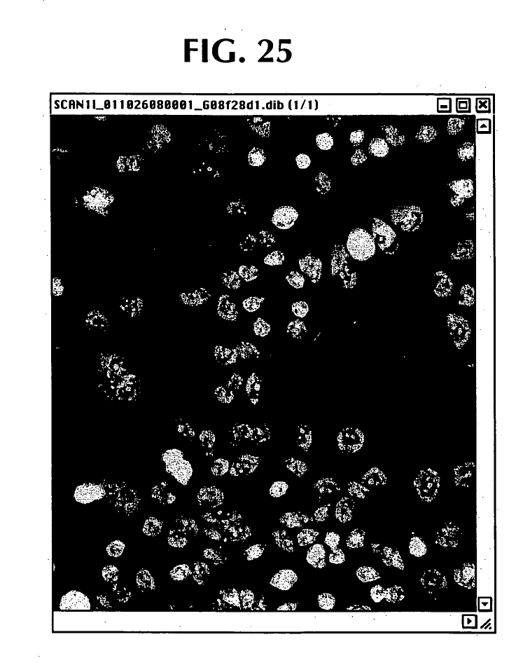

Although the induction of binucleated cells, e.g., by treating cells with Cytochalasin B (also referred to as “CYB”) is the preferred protocol for measuring micronuclei frequency, many of those skilled in the art still consider it to be optional. See, e.g., Frieauff et al., “Automatic Analysis Of The In Vitro Micronucleus Test On V79 Cells,” Mutation Research, volume 413, pages 57-68 (1998), in which Cytochalasin B was not used. In addition, Cytochalasin B may itself cause DNA fragmentation in a number of cell lines, particularly in T lymphoma cell lines, which prevented it from being used in another published study (Nesslany et al., “A Micromethod For The In Vitro Micronucleus Assay,” Mutagenesis, volume 14, number 4, pages 403-410 (1999)). Accordingly, the method of this invention was also used to determine micronuclei frequency in non-cytokinesis-blocked cell samples (i.e., cell samples that were not treated with Cytochalasin B or the like) and, therefore, which were mononucleated. That protocol is discussed in connection with FIGS. 25 to 40, below.

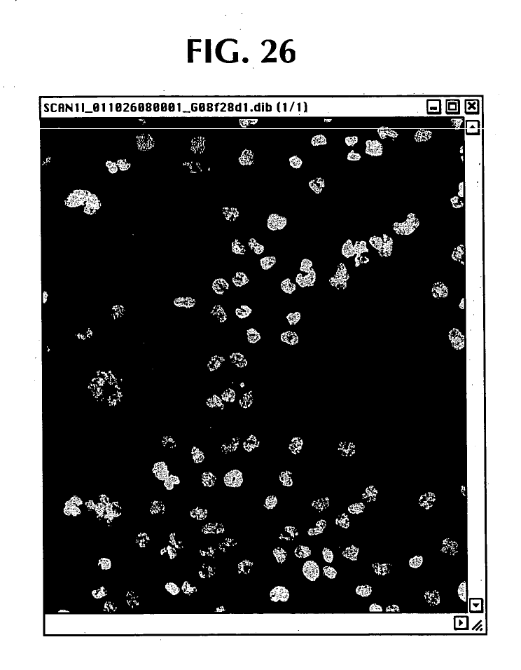

FIGS. 25 & 26 FIG. 25 is a digitized image of cytoplasm of cells in a sample stained with acridine orange, which image was obtained in a manner essentially the same as that for FIG. 5 except Cytochalasin B was omitted from the cell culture media. FIG. 26 is the corresponding digitized image from the same image field of nuclear objects stained with Hoechst 33342, which image was obtained in a manner essentially the same as that for FIG. 6 (except Cytochalasin B was omitted from the cell culture media). Comparison of FIGS. 25 and 26 with FIGS. 5 and 6 shows the effect of Cytochalasin B: the majority of cells in FIGS. 5 and 6 are binucleated and, as expected, the majority of the cells in FIGS. 25 and 26 are mononucleated.

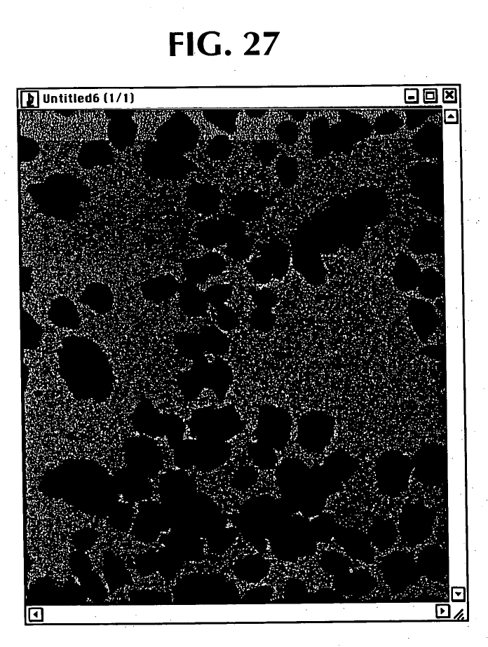

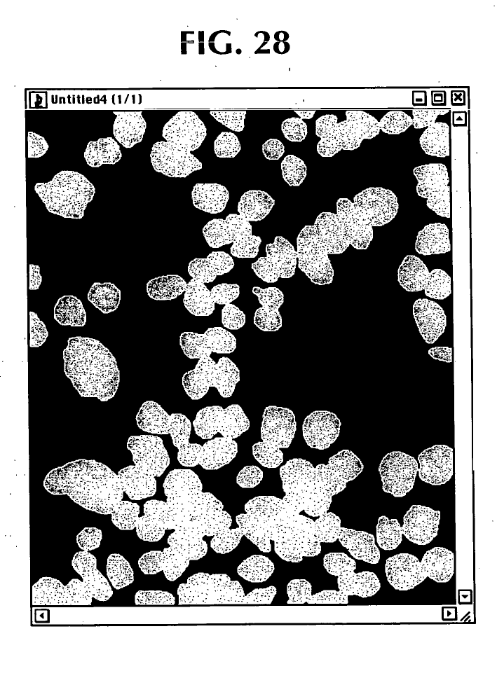

FIGS. 27 & 28 In FIG. 27, the cytoplasm image (FIG. 25) has been converted to an 8-bit scale (which, as explained above, has 256 gradations, ranging from 0 to 255, the latter value equaling 2 to the eighth power minus 1). This is similar to the steps for producing FIG. 7. Thus, 1.5 times the dimmest pixel in the original cytoplasm image (FIG. 25) was set equal to the new minimum of 0 and the mean pixel value of the original image (FIG. 25) plus an offset of 100 was set equal to the new maximum of 255. As before, the image was inverted and an automatic “dark” threshold was applied to outline the cellular region. FIG. 28 shows the result of applying a binary mask to that image data so that the intracellular region is set at “1” and the extracellular space is set at “0.”

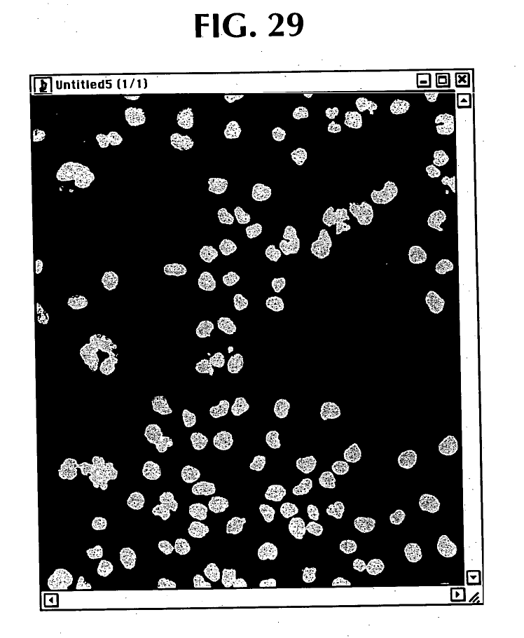

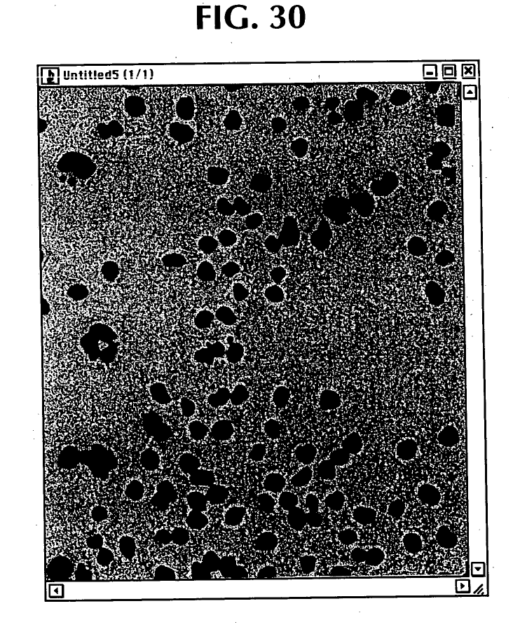

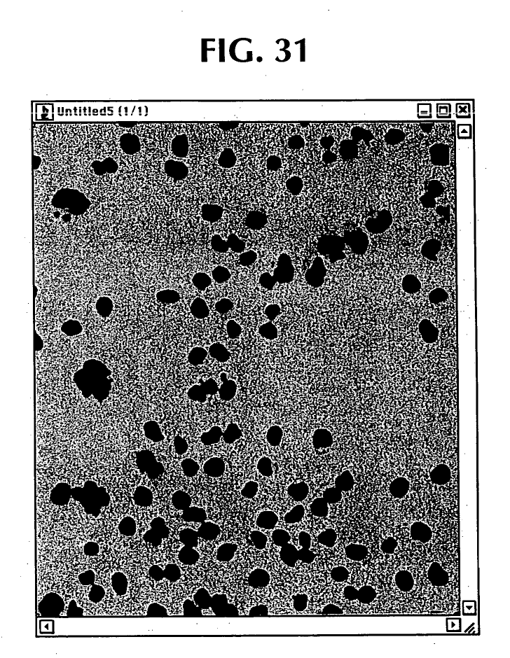

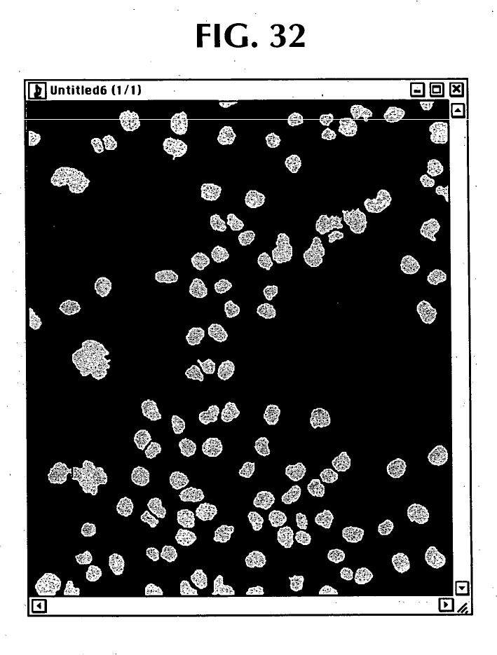

FIG. 29 This figure shows the conversion of the nuclear objects image (FIG. 26) to 8-bit. Twice the dimmest pixel in the original nuclear objects image (FIG. 26) was set equal to the new minimum of 0 for the 8-bit image and twice the mean pixel value of the original image plus an offset of 100 to the new maximum of 255 for the 8-bit image. This conversion minimizes the background while maximizing the nuclei signal in the new 8-bit image and prepares the image for automatic thresholding. FIGS. 30 & 31 To produce FIG. 30, the 8-bit image (FIG. 29) is inverted, a tophat filter is applied to emphasize small nuclei (which could be micronuclei) that are above the background signal, and a slight close is applied to connect close-by nuclei, some of which could be apoptotic nuclear fragments. An automatic “dark” (“AutoDark”) threshold is applied to outline the nuclei (FIG. 31). A binary mask is applied so that the intranuclear region is set at “1” and the extranuclear space is set at “0,” micronuclei are gated out based on their smaller size so that only nuclei (which are larger) are selected, and a watershed split is applied to separate connected nuclei (FIG. 32). As is shown in FIG. 32, several of the larger nuclei groupings have not been split (because of their irregular shape owing to their being apoptotic).

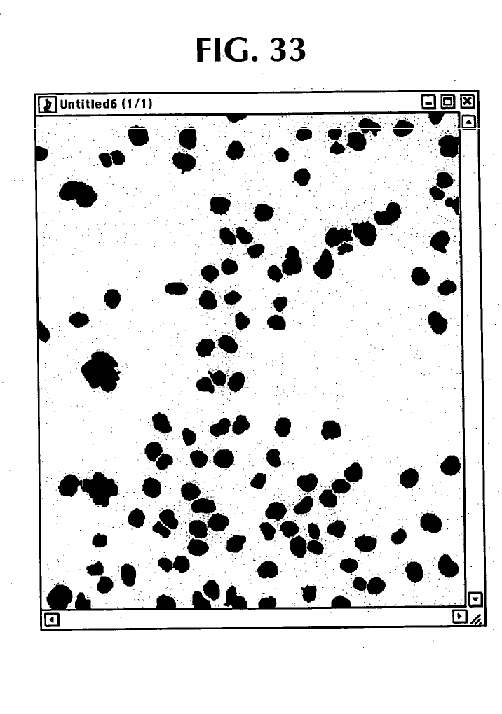

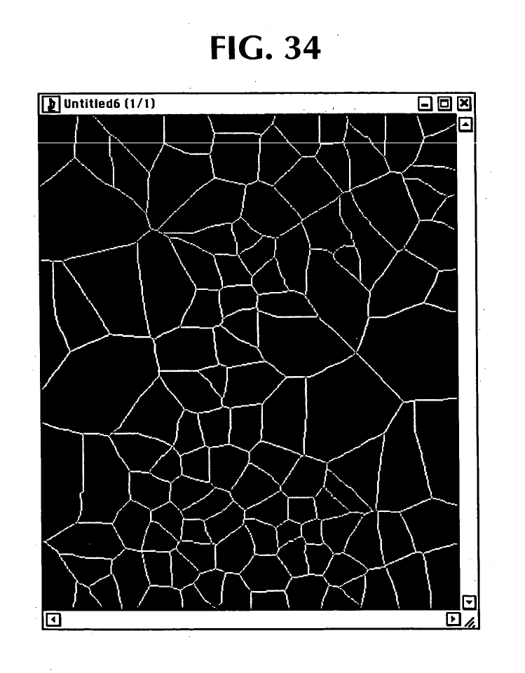

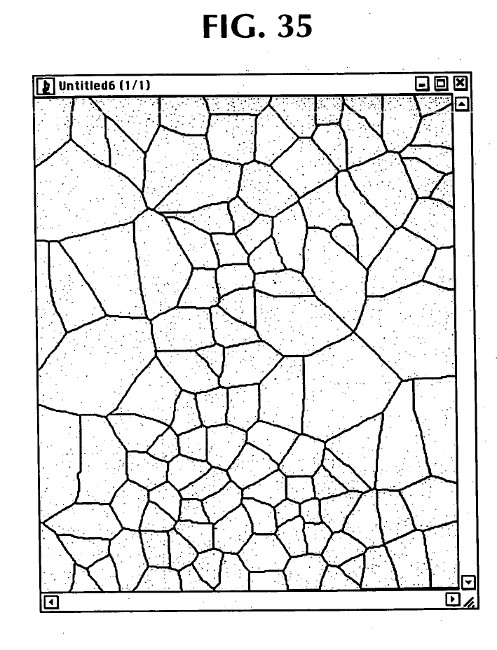

FIG. 32-35 The nuclei binary mask of FIG. 32 is inverted (FIG. 33), a thinning and pruning filter is applied, which yields the nuclei influence zone diagram (FIG. 34), and a second inversion is made (FIG. 35).

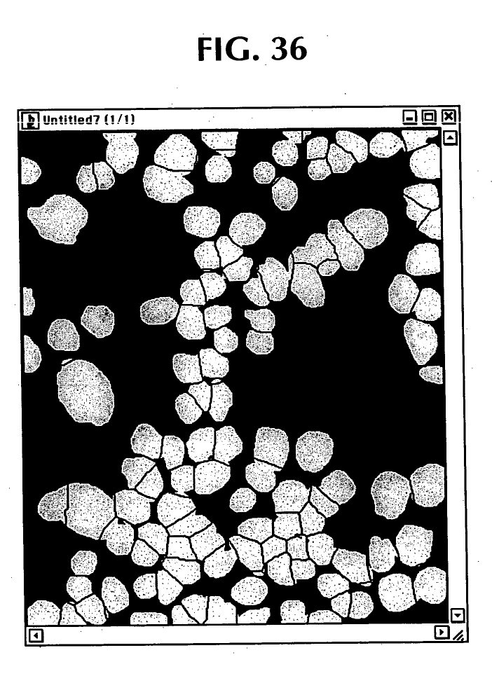

The inverted nuclei influence zone (FIG. 35) is combined using a Boolean AND with the cytoplasm binary mask (FIG. 28) to create a cell-by-cell outline (FIG. 36). Comparison of FIGS. 25 and 36 shows that most of the connected cells in FIG. 25 are now isolated or separated in FIG. 36.

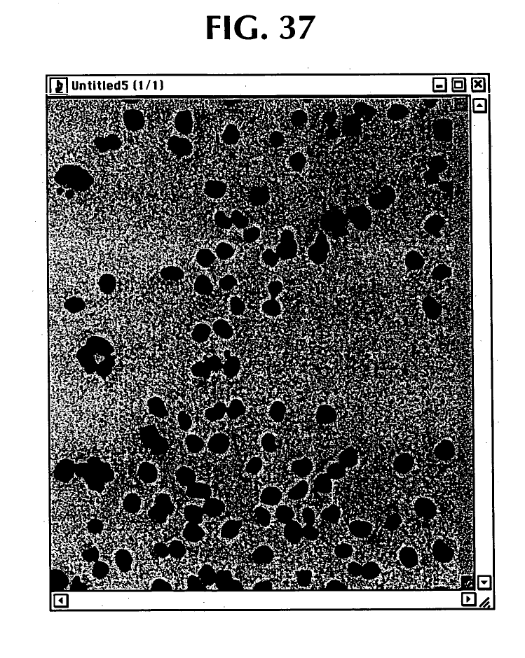

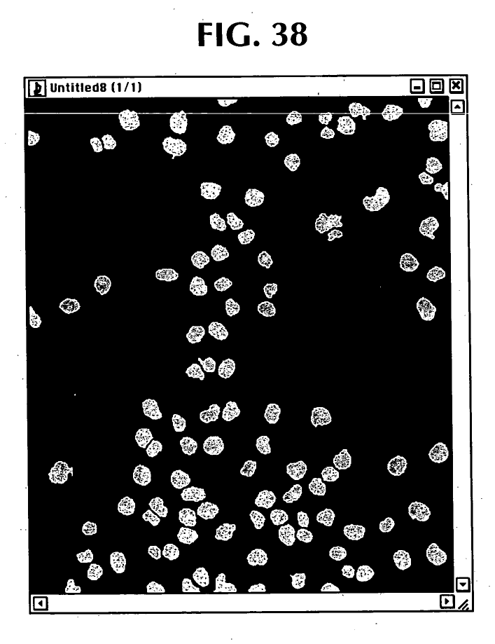

FIGS. 37 & 38 This figure is similar to FIG. 31 except that an “AutoDark” threshold has been applied to help identify the large apoptotic nuclei based on their larger size. Gating out those apoptotic nuclei (based on the their larger size) and micronuclei (based on their smaller size) and inverting the resulting image data produces a binary mask of normal nuclei (FIG. 38).

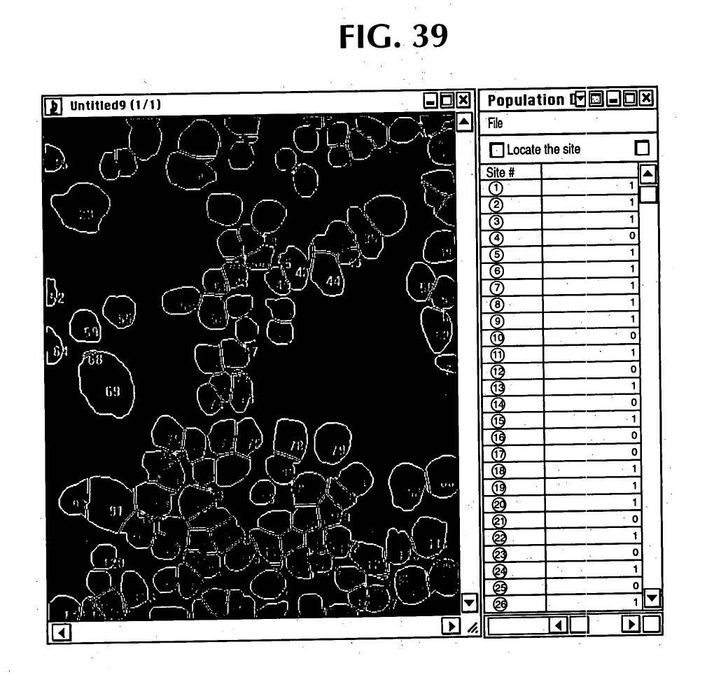

FIG. 39 This figure combines the cell-by-cell outline (FIG. 36) with the binary nuclei outline image data of FIG. 38, which have been watershed split and auto-split to separate connecting nuclei. A population density operation is applied to calculate the number of normal size nuclei in each cell and the results are reported in the Population Density table of FIG. 39. Also, in FIG. 39, apoptotic nuclei are gated out. Therefore, apoptotic cells are recognized as cells or sites that contain zero normal size nuclei (e.g., cell or site 29).

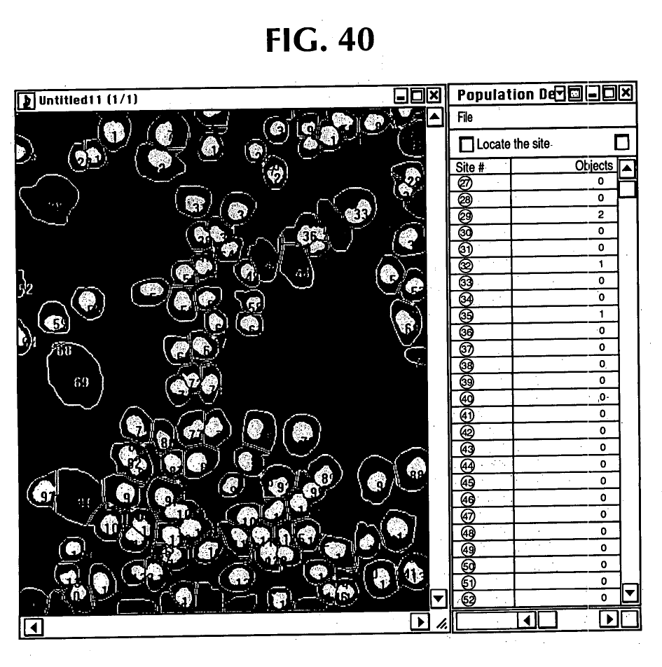

FIG. 40 This figure is the result of operations similar to those used to produce FIG. 39 except that only the micronuclei were selected and counted, the results of which are shown in the Population Density table in FIG. 40. For example, as listed in the portion of the Population Density table, site or cell 29 (near the upper left corner of the field) contains 2 micronuclei, site or cell 32 (along the upper right edge of the field) contains 1 micronuclei, and site or cell 35 (between cells 33 and 36 in the upper right portion of the field) contains 1 micronuclei.

### EXAMPLES

The two experiments described below demonstrate the excellent reproducibility of results that can be attained with the process of this invention for the two protocols discussed above for micronuclei determination (i.e., the first protocol using cells treated with Cytochalasin B and the second protocol using cells not treated with Cytochalasin B or the like).

### Example 1

In the first set of experiments, independent duplicate experiments were run for each of both negative and positive control stimuli. DMSO, which at 1% concentration is known not to be aneugenic or clastogenic (and thus is a negative control), was incubated with Chinese hamster ovary cells in two different microwells, one on each of two different microwell plates, and further processed under substantially identical conditions (incubation temperature, time, and culture medium, fixing and washing protocols, etc.).

Using the protocol discussed above, one of the wells in a microwell plate was inoculated with 2,500 Chinese hamster ovary cells in a growth medium containing Cytochalasin B, incubated with 50 ng/ml (nanograms/milliliter) of mitomycin C (as the chemical stimulus) for 24 hours at 37 degrees Centigrade, washed, fixed, permeabilized, sequentially treated with Hoechst 33342 and acridine orange, and washed. The microwell plate containing this well was then read by the ArrayScan II automated microscope using 200× magnification to acquire the images for each different wavelength of light used (i.e., a given number of images were acquired when the microwell was illuminated with UV light to highlight the nuclear material and the same number of corresponding images were acquired when the microwell was illuminated with green light to highlight the cytoplasmic material). The image data were digitized and stored in the computer that is part of the ArrayScan II microscope system. Any appropriate software and algorithms may be used for digitizing the images, and the particular software and algorithms are not critical provided the software and algorithms allow the benefits of this invention to be achieved.

As shown in Table I, below, the micronuclei frequency (number of micronuclei divided by number of binucleated cells) was determined to be 1.1% for one microwell and 1.2% for the other by the manual scoring method (“Manual MN %”). In the manual scoring method, which is considered to be the “Gold Standard,” a skilled individual visually examines the stained sample and counts the number of micronuclei and binucleated cells present. For the same two samples, the automated method of this invention determined micronuclei frequencies of 1.1% for each well (“Auto MN %”). The relative differences are 0% for the first well and 8% for the second. The relative difference is the percent difference between the micronuclei frequency determined by the method of this invention and by the manual scoring method, in other words, the absolute value of 100 times (Auto MN % minus Manual MN %) divided by Manual MN %.

Chinese hamster ovary cells in two other wells on the same two microwell plates were challenged with (i.e., exposed to) mitomycin C at a concentration of 0.05 micrograms per milliliter (mcg/ml). Mitomycin C is known to be aneugenic/clastogenic (and thus is a positive control). With the manual scoring method, the first mitomycin C well yielded a micronuclei frequency of 3.8% and the second a micronuclei frequency of 3%. With the method of this invention, the first mitomycin C well was determined to have a micronuclei frequency of 3.3% and the second, a micronuclei frequency of 2.7%. These represent relative differences of 13.2% and 10%, respectively, both of which are acceptable for this assay. A value two to three times as great as the negative control (e.g., DMSO-treated sample) value is typically used as cut-off for a positive response. In other words, the methods of this invention would have determined both wells to display a positive response (just as the manual scoring would have) because the values of 2.7% and 3.3% were sufficiently higher than the respective 1.1% negative control values obtained with the method of this invention. In addition, when two different technicians manually score micronuclei frequency, they can differ by as much as 60% (e.g., see FIG. 11 of Frieauff et al., “Automatic Analysis Of The In Vitro Micronucleus Test On V79 Cells,” Mutation Research, volume 413, pages 57-68 (1998)).

TABLE I
CONCORDANCE AND REPRODUCIBILITY OF
CYTOCHALASIN B PROTOCOL: MANUAL VS. AUTO

| | Manual | Auto | % Relative |
|---|---|---|---|
| Treatment | MN % | MN % | Difference |
| 1% DMSO | 1.1 | 1.1 | 0 |
| 1% DMSO | 1.2 | 1.1 | 8 |
| 0.05 mcg/ml | 3.8 | 3.3 | 13.2 |
| Mitomycin C | | | |
| 0.05 mcg/ml | 3 | 2.7 | 10 |
| Mitomycin C | | | |

Sixteen pairs of images from this first experiment (8 pairs for DMSO and 8 pairs for mitomycin C), each pair consisting of a cytoplasm image and a nuclear objects image for the same field, were examined to determine the error rates of the present invention for resolving cellular clumps into individual cells and for resolving nuclear object clumps into individual nuclear objects. About 50 images (either cytoplasm images or nuclear objects images) may be used to capture each well. The images were randomly selected, the only criterion being that each field had to contain at least 10 cells. Together, the 16 cytoplasm images contained 759 cells and the 16 nuclear objects images contained 1,028 nuclei (as determined by manual scoring, i.e., the “Gold Standard”).

The number of cells determined for those 16 cytoplasm images by the method of this invention using the preferred computer program was compared to the actual number of cells, and the number of nuclei determined for those 16 nuclear objects images by the method of this invention using the preferred computer program was compared to the actual number of nuclei. The method of this invention made 23 errors for cells and 25 errors for nuclei, an error being making a split when none should have been made or failing to make a split when it should have been made. The error rate for resolving cellular clumps into individual cells was thus 23 divided by 759 or 3.0% and the error rate for resolving nuclear object clumps into individual nuclear objects was 25 divided by 1,028 or 2.4%. This demonstrates that the method of this invention can resolve clumps of objects (such as cellular clumps and nuclear object clumps) into individual objects (such as individual cells and individual nuclear objects) at very low error rates. Any appropriate statistical analysis known in the art may be used to determine the method's reproducibility, sensitivity, and accuracy for the objects of interest. For example, the coefficient of variation, which is equal to the standard deviation times one hundred divided by the mean, can be calculated to indicate the reproducibility of a method.

### Example 2

In the second set of experiments, Chinese hamster ovary cells were used and the only difference in treatment and image acquisition protocol between runs in this set was the stimulus (i.e., chemical agent) with which the cells were incubated. Cytochalasin B was not used is this set of experiments (and, thus, the cells remained virtually all mononucleated throughout the experiment). A single run was made using DMSO and two identical but independent runs were made for each of four other compounds, mitomycin C, Compound A, Compound B, and Compound C.

Table II, below, shows the resulting data, which illustrate the excellent agreement between determinations made using the process of this invention (i.e., micronuclei frequency determined using this invention, referred to as “Auto MN %”) and manual scoring (micronuclei frequency determined using the “Gold Standard,” referred to as “Manual MN %”). The relative difference, calculated as the absolute value of 100 times (Auto MN % minus Manual MN %) divided by Manual MN %, was calculated for each run and ranges from 0 to 17.6%, which is excellent agreement.

TABLE II
CONCORDANCE AND REPRODUCIBILITY OF NON-
CYTOCHALASIN B PROTOCOL: MANUAL VS. AUTO

| | Concentration | Auto MN | Manual | % Relative |
|---|---|---|---|---|
| Compound Name | (mcg/ml) | % | MN % | Difference |
| DMSO vehicle | 0.01 | 0.6 | 0.6 | 0.0 |
| Mitomycin C | 0.05 | 3.4 | 3.1 | 9.7 |
| Mitomycin C | 0.05 | 3.5 | 3.1 | 12.9 |
| Compound A | 12.50 | 2.7 | 2.7 | 0.0 |
| Compound A | 12.50 | 3.3 | 3.2 | 3.1 |
| Compound B | 50.00 | 2.0 | 1.7 | 17.6 |
| Compound B | 50.00 | 1.4 | 1.6 | 12.5 |
| Compound C | 0.78 | 0.6 | 0.7 | 14.3 |
| Compound C | 0.78 | 1.4 | 1.5 | 6.7 |

The method of this invention and manual scoring each resulted in a micronuclei frequency of 0.6% for the DMSO, which is used as the negative control. Using double that value as the cut-off for a positive response (i.e., micronuclei frequencies of 1.2% and higher indicate a positive response), both mitomycin C runs, both Compound A runs, both Compound B, and the second Compound C run are all positive, whether by manual scoring or by the process of this invention. For Compound C, the first run gave a negative indication. The difference between the two independent runs for that compound is most likely explained by the fact that Compound C is not readily soluble. Although the cells in the two independent replicate runs were supposed to be exposed to the same concentration of Compound C (0.78 micrograms per milliliter), it is believed that the Compound C in the first microwell was at a much lower concentration because it was not fully dissolved. As with any cell-based assay, the solubility of the test agent in the fluid to which the cells are exposed plays a significant role in the experimental outcome. Nevertheless, even for this compound the concordance between the micronuclei frequencies determined by the method of this invention and by the “Gold Standard” is excellent in each of these two replicate runs (relative differences of 14.3% and 6.7%).

As can be seen, for micronuclei screening, when the numbers of nuclei and micronuclei in an individual cell have been calculated and a determination made as to whether the cell is binucleated (if Cytochalasin B or the like is being used), the frequency of micronuclei in the cell sample (or just a portion of the sample, e.g., a field) may be calculated as a percentage equal to one hundred times the sum of the total number of micronuclei in the sample (or portion) divided by the number of binucleated cells in the sample (or portion). The frequency results may be compared to the frequency results for negative and positive controls to determine the effects of the stimulus on the cell sample. Thus, the frequency of micronuclei in a cell sample, when compared to the micronuclei frequency results of positive and negative controls, can be used to determine whether the subject cell stimulus has a clastogenic and/or aneugenic effect on the cell sample. Depending on the cells, the controls used, the cell-handling protocols, etc., in a preferred method, a stimulus may be denominated as clastogenic and/or aneugenic when it results in a micronuclei frequency greater than twice the micronuclei frequency value for the negative control (those skilled in the art will recognize that values other than twice the negative control may be used for making the determination of clastogenicity and/or aneugenicity).

Because the method can be used to count the number of gate-processed target objects per individual cell, the method can be used to verify whether a cell sample has undergone expected cellular development according to the cell sample preparation protocol. For example, when using Cytochalasin B to prevent cellular division (but which does not prevent nuclear division), a count of gate-processed nuclear objects per cell will indicate not only the number of nuclei per cell but also whether at least one complete nuclear division has occurred in a sufficient percentage of the cell population (i.e., whether a sufficient percentage of the cells are binucleated).

The methods of this invention can be used to count the number of nuclear fragments as a result of apoptosis per individual cell. Apoptosis (programmed cell death) often results in nuclear fragmentation. Because nuclear fragmentation often results in more than one irregularly shaped nuclear fragment, as opposed to a single round-shaped micronuclei inside a cell, such irregularly shaped nuclear fragments can be gate-processed and counted by the method of this invention.

It will be apparent to those skilled in the art that the methods of this invention have numerous other benefits. For example, cells can be treated (incubated, stained, etc.) and the images acquired in the same holder (e.g., a 96-well microplate); the cellular clumps and target object clumps resolved, respectively, into individual cells and target objects (e.g., nuclei) with a very low error rate; individual target objects can be analyzed and their relationship to individual cells can be determined; and all of this can be done in an automated manner (e.g., using microwell plates, microwell plate-handling equipment, a camera for obtaining the images, and a computer for analyzing the images).

The working examples discussed above concern micronuclei screening; however, it will be apparent to one skilled in the art from those examples and the present description as a whole that the frequency, size, shape, etc. of target objects in the cells in a cell sample can be used to determine whether the cell sample reveals the effects of a disease, condition, syndrome, or chemical-induced effect (e.g., drug-induced effect) on a patient's cells and/or whether other stimuli being assessed have affected the cells being tested (whether from a patient or from a cell line) in certain ways.

If desired, target objects can be eliminated from further analysis or isolated for further analysis by gating out those target objects based on their size, shape, proximity to other features within a cell, etc. For instance, target objects of a certain size range may be removed from the image data, thereby leaving an image having only target objects greater than the specified gate size. The resulting image (i.e., gate-processed target object image) may be saved to memory for further analysis. This procedure allows target object data to be quickly sorted and various target object images to be derived. For example, as discussed above, when the target objects are nuclear material, this method may be used used to separate nuclear objects having at least the minimum size expected for nuclei from micronuclei (which have a size significantly smaller than the minimum size expected for nuclei). Image data can be subjected to a combination of multiple gate sizes and/or range limitations in order to derive an image corresponding to specific size limitations. An image may be subjected to gates of different types (e.g., size and/or shape and/or proximity).

Because the methods of this invention can resolve cellular clumps into individual cells, several derivative features can be obtained. For example, morphological features of individual cells can be determined (or calculated) and reported. Thus, the boundary and location of each cell can be determined, as in FIG. 24. Other features of the cells may also be determined (e.g., size, shape, and light intensity of each cell). Cell size may be determined by counting the number of data locations (e.g., pixels) within each cell. The most basic measure of the size features in images is the area, which is the number of pixels within the target feature. Another customary measure is perimeter, which is the number of pixels in a single-pixel-width line surrounding the target feature (Russ, The Image Processing Handbook, 3^{rd} edition, ISBN 0-8493-2532-3 (CRC Press, 1998)). The shape may be determined by analyzing the cell boundary and determining, e.g., an aspect ratio (ratio of longest dimension to shortest dimension). These values (e.g., size, shape) may be stored for later use. Another parameter of the roundness of an object is the ratio between the square of perimeter to the area. If an object is a perfect circle, this ratio is equal to 4 pi (ca. 12.56); if an object is a perfect square, this ratio is 16. Thus, the ratio increases as an object's roundness decreases (Russ, The Image Processing Handbook, 3^{rd} edition, ISBN 0-8493-2532-3 (CRC Press, 1998)). The light intensity of individual cells can be determined by first applying a Boolean ADD operation between the cell-by-cell outline and the original cytoplasm image and then adding the pixel intensities of each individual cell to yield the light intensity of that cell. Calculation of object intensity, once each object has been identified, is known in the art.

Because the methods of this invention can resolve target object clumps into individual objects and establish the relationship of individual target objects to individual cells, several derivative features can be obtained. First, the number of individual target objects within individual cells can be determined, as in FIGS. 23 and 24. The location of individual target objects with respect to individual cells can be determined. Specifically, it can be determined whether a target object is inside a cell (i.e., in the intracellular space) or outside a cell (i.e., in the extracellular space). It can be determined whether a target object is pericentric (i.e., near the center region) or periperiphic (i.e., near the periphery). For example, using a cell-by-cell outline (e.g., FIGS. 22 and 36), the periperiphic region of each cell can be selected based on its closer distance from the boundaries of its respective cell and the pericentric region of each cell can be selected based on its longer distance from the boundaries of its respective cell. Target objects within cell-to-cell boundaries (i.e., cell-to-cell junctions) can be determined. For example, the cell-to-cell boundaries in FIG. 36 can be selected by calculating the differences between FIGS. 36 and 28. Once these target regions of interest are selected, the target objects in these regions can be studied by image processing and analysis.

In other words, once cellular clumps are resolved into individual cells and cell-by-cell outlines have been obtained, many morphological features of individual cells can be determined (or calculated) and reported. Similarly, many morphological features of the target objects may be determined (e.g., size, number, location, shape, and intensity of each target object) using similar methods. With this cell-by-cell relationship, morphological and structural features of individual cells and objects can be calculated based on what is known to those skilled in the art. See, e.g., Russ, The Image Processing Handbook, 3^{rd} edition, ISBN 0-8493-2532-3 (CRC Press, 1998); Sudbo et al., “New Algorithms Based On The Voronoi Diagram Applied In A Pilot Study On Normal Mucosa And Carcinomas,” Analytical Cellular Pathology, volume 21, pages 71-86 (2000); and Bigras et al., “Cellular Sociology Applied To Neuroendocrine Tumors Of The Lung: Quantitative Model Of Neoplastic Architecture,” Cytometry, volume 24, pages 74-82 (1996).

Because the location of individual cells are identified and registered and intracellular space and extracellular space delineated, the spatial relationship between individual cells can be calculated. See, e.g., Bigras et al., “Cellular Sociology Applied To Neuroendocrine Tumors Of The Lung: Quantitative Model Of Neoplastic Architecture,” Cytometry, volume 24, pages 74-82 (1996). Morphological and structural changes in such spatial relationships can be used to indicate one or more conditions, diseases, syndromes, or stimuli-induced (e.g., chemical-induced) effects. Under normal conditions cells are typically arrayed in a highly structured fashion. For example, liver hepatocytes are typically arrayed with basolateral membrane facing one side (the sinusoidal side) and apical membrane facing the other (the canalicular side). Therefore, any spatial relationship change from such a normal structural array can be used as indication for one or more liver conditions, diseases, syndromes, or stimuli-induced (e.g., chemical-induced) hepatic side effects. Other cells in other organs or tissues (e.g., lens epithelial cell layers, cholangiocytes, kidney proximal tubule epithelial cells, intestinal enterocytes, microblood vessel endothelial cells) have their characteristic architecture or structure, and changes in those normal spatial relationships can be used to indicate one or more organ or tissue conditions, diseases, syndromes, or stimuli-induced effects.

Furthermore, because the location of individual target objects are identified and registered and intra-object space and extra-object space are delineated, the spatial relationship between individual target objects can be calculated using known methods. See, e.g., Strohmaier et al., “Tomography Of Cells By Confocal Laser Scanning Microscopy And Computer-Assisted Three-Dimensional Image Reconstruction: Localization Of Cathepsin B In Tumor Cells Penetrating Collagen Gels In Vitro,” Journal Of Histochemistry And Cytochemistry, volume 45, number 7, pages 975-983 (1997); Bigras et al., “Cellular Sociology Applied To Neuroendocrine Tumors Of The Lung: Quantitative Model Of Neoplastic Architecture,” Cytometry, volume 24, pages 74-82 (1996). Morphological and structural changes of such spatial relationship can be used to indicate one or more conditions, diseases, syndromes, or stimuli-induced (e.g., chemical-induced) effects. For example, under normal conditions cytochrome C is typically located inside mitochondria; however, during apoptosis, cytochrome C is release from the mitochondria into the cytosol. As another example, genetic diseases such as ataxia telangiectasia and Nijmegen breakage syndromes are characterized by translocation of certain genetic material from their normal chromosomal locations to abnormal chromosomal locations. See, e.g., Stumm et al., “High Frequency Of Spontaneous Translocations Revealed By FISH In Cells From Patients With The Cancer-Prone Syndromes Ataxia Telangiectasia And Nijmegen Breakage Syndrome,” Cytogenetics And Cell Genetics, volume 92, pages 186-191 (2001). Because the genetic material and chromosomes can be highlighted by special highlighting reagents such as whole chromosome painting probes, the method of this invention can be used to identify and register the spatial relationship changes in these chromosomes.

Variations and modifications will be apparent to those skilled in the art and the claims are intended to cover all variations and modifications falling within the true spirit and scope of the invention. For example, it will be apparent to those skilled in the art that numerous computer programs may be written in any of a number of appropriate programming languages to implement the strategies disclosed herein and that numerous variations may be made in these strategies, all without departing from the spirit of the invention or being outside the scope of the claims.

1. An automated process for determining the presence of micronuclei within binucleated cells in a sample or portion thereof, the cells normally containing nuclei and cytoplasm, the nuclei and micronuclei being nuclear objects, the sample or portion thereof being treated to highlight the presence of the cytoplasm and to highlight the presence of nuclear objects, and one or more images of the sample or portion thereof showing the resulting highlighting having been collected, each of the one or more images comprising image data, there being image data for a plurality of locations within each of the one or more images, one or more of the cells in one or more of the images possibly appearing to be joined together in cellular clumps and one or more of the nuclear objects in one or more of the images possibly appearing to be joined together in nuclear object clumps, the process comprising the steps of:
(a) automatically determining the outlines of the cells in the sample or portion thereof from the image data using means that can resolve cellular clumps into individual cells with an error rate no greater than 20%; (b) automatically determining the outlines of the nuclear objects in the sample or portion thereof from the image data using means that can resolve nuclear object clumps into individual nuclear objects with an error rate no greater than 20%; (c) automatically determining which of the nuclear objects are nuclei and which of the nuclear objects are micronuclei; (d) automatically determining which of the nuclei are within the cells; (e) automatically determining which of the cells are binucleated; (f) automatically determining which of the micronuclei are within the cells; and (g) automatically determining whether the binucleated cells contain micronuclei.

2. The process of claim 1 wherein step (a) comprises automatically determining the outlines of the cells in the sample or portion thereof from the image data using means that can resolve cellular clumps into individual cells with an error rate no greater than 10% and step (b) comprises automatically determining the outlines of the nuclear objects in the sample or portion thereof from the image data using means that can resolve nuclear object clumps into individual nuclear objects with an error rate no greater than 10%.

3. The process of claim 1 wherein step (a) comprises automatically determining the outlines of the cells in the sample or portion thereof from the image data using means that can resolve cellular clumps into individual cells with an error rate no greater than 5% and step (b) comprises automatically determining the outlines of the nuclear objects in the sample or portion thereof from the image data using means that can resolve nuclear object clumps into individual nuclear objects with an error rate no greater than 5%.

4. The process of claim 1 wherein step (a) comprises automatically determining the outlines of the cells in the sample or portion thereof from the image data using means that can resolve cellular clumps into individual cells employing, and step (b) comprises automatically determining the outlines of the nuclear objects in the sample or portion thereof from the image data using means that can resolve nuclear object clumps into individual nuclear objects employing, thinning; pruning; erosion; dilation; contour-based segmentation; distance mapping; watershed splitting; non-watershed splitting; tophat transform; nonlinear Laplacian transform; dot label methods; or combinations thereof.

5. The process of claim 1 wherein step (a) comprises automatically determining the outlines of the cells in the sample or portion thereof from the image data using means that can resolve cellular clumps into individual cells employing a nuclei influence zone diagram and step (b) comprises automatically determining the outlines of the nuclear objects in the sample or portion thereof from the image data using means that can resolve nuclear object clumps into individual nuclear objects employing watershed splitting.

6. The process of claim 1 wherein step (a) comprises: (i) creating a cytoplasm binary mask, (ii) for the nuclei, creating a nuclei influence zone diagram, and (iii) applying a Boolean AND to the cytoplasm binary mask and the nuclei influence zone diagram, thereby automatically determining the outlines of the cells.

7. The process of claim 6 wherein the image data comprise cytoplasm image data and nuclear objects image data and creating a cytoplasm binary mask comprises converting the cytoplasm image data to an n-bit scale.

8. The process of claim 7 wherein the step of converting the cytoplasm image data to an n-bit scale comprises setting a constant multiplied by the dimmest piece of image data of the cytoplasm image data as being equivalent to the minimum value of the n-bit scale and setting a constant multiplied by the mean piece of image data of the cytoplasm image data, optionally plus an offset, as being equivalent to the maximum value of the n-bit scale.

9. The process of claim 7 wherein the step of creating a nuclei influence zone diagram comprises converting the nuclear object image data to an n-bit scale comprising setting a constant multiplied by the dimmest piece of image data of the nuclear objects image data as being equivalent to the minimum value of the n-bit scale and setting a constant multiplied by the mean piece of image data of the nuclear objects image data, optionally plus an offset, as being equivalent to the maximum value of the n-bit scale.

10. The process of claim 9 wherein the step of creating a nuclei influence zone diagram further
comprises determining which nuclei are connected or are sufficiently close to be assumed to be within the same cell using a close and erosion process, a gating procedure based on perimeter convex, and a thinning and pruning operation.

11. An automated process for determining the presence of micronuclei within binucleated cells in a sample or portion thereof, the cells normally containing nuclei and cytoplasm, the nuclei and micronuclei being nuclear objects, the sample or portion thereof being treated to highlight the presence of the cytoplasm and to highlight the presence of nuclear objects, and one or more images of the sample or portion thereof showing the resulting highlighting having been collected, each of the one or more images comprising image data, there being image data for a plurality of locations within each of the one or more images, one or more of the cells in one or more of the images possibly appearing to be joined together in cellular clumps and one or more of the nuclear objects in one or more of the images possibly appearing to be joined together in nuclear object clumps, the process comprising the steps of:
(a) automatically determining the outlines of the cells in the sample or portion thereof from the image data using means that can resolve cellular clumps into individual cells with an error rate no greater than 20%; (b) automatically determining the outlines of the nuclear objects in the sample or portion thereof from the image data using means that can resolve nuclear object clumps into individual nuclear objects with an error rate no greater than 20%; (c) automatically determining which of the nuclear objects are nuclei and which of the nuclear objects are micronuclei; and (d) using the results of the steps (a), (b), and (c), automatically identifying the cells that are binucleated and contain micronuclei.

12. The process of claim 11 wherein step (a) comprises automatically determining the outlines of the cells in the sample or portion thereof from the image data using means that can resolve cellular clumps into individual cells with an error rate no greater than 10% and step (b) comprises automatically determining the outlines of the nuclear objects in the sample or portion thereof from the image data using means that can resolve nuclear object clumps into individual nuclear objects with an error rate no greater than 10%.

13. The process of claim 11 wherein step (a) comprises automatically determining the outlines of the cells in the sample or portion thereof from the image data using means that can resolve cellular clumps into individual cells with an error rate no greater than 5% and step (b) comprises automatically determining the outlines of the nuclear objects in the sample or portion thereof from the image data using means that can resolve nuclear object clumps into individual nuclear objects with an error rate no greater than 5%.

14. The process of claim 11 wherein step (a) comprises automatically determining the outlines of the cells in the sample or portion thereof from the image data using means that can resolve cellular clumps into individual cells employing, and step (b) comprises automatically determining the outlines of the nuclear objects in the sample or portion thereof from the image data using means that can resolve nuclear object clumps into individual nuclear objects employing, thinning; pruning; erosion; dilation; contour-based segmentation; distance mapping; watershed splitting; non-watershed splitting; tophat transform; nonlinear Laplacian transform; dot label methods; or combinations thereof.

15. The process of claim 11 wherein step (a) comprises automatically determining the outlines of the cells in the sample or portion thereof from the image data using means that can resolve cellular clumps into individual cells employing a nuclei influence zone diagram and step (b) comprises automatically determining the outlines of the nuclear objects in the sample or portion thereof from the image data using means that can resolve nuclear object clumps into individual nuclear objects employing watershed splitting.

16. The process of claim 11 wherein step (a) comprises: (i) creating a cytoplasm binary mask, (ii) for the nuclei, creating a nuclei influence zone diagram, and (iii) applying a Boolean AND to the cytoplasm binary mask and the nuclei influence zone diagram, thereby automatically determining the outlines of the cells.

17. The process of claim 16 wherein the image data comprise cytoplasm image data and nuclear objects image data and creating a cytoplasm binary mask comprises converting the cytoplasm image data to an n-bit scale.

18. The process of claim 17 wherein the step of converting the cytoplasm image data to an n-bit scale comprises setting a constant multiplied by the dimmest piece of image data of the cytoplasm image data as being equivalent to the minimum value of the n-bit scale and setting a constant multiplied by the mean piece of image data of the cytoplasm image data, optionally plus an offset, as being equivalent to the maximum value of the n-bit scale.

19. The process of claim 17 wherein the step of creating a nuclei influence zone diagram comprises converting the nuclear object image data to an n-bit scale comprising setting a constant multiplied by the dimmest piece of image data of the nuclear objects image data as being equivalent to the minimum value of the n-bit scale and setting a constant multiplied by the mean piece of image data of the nuclear objects image data, optionally plus an offset, as being equivalent to the maximum value of the n-bit scale.

20. The process of claim 19 wherein the step of creating a nuclei influence zone diagram further comprises determining which nuclei are connected or are sufficiently close to be assumed to be within the same cell using a close and erosion process, a gating procedure based on perimeter convex, and a thinning and pruning operation.

21. An automated process for determining the presence of micronuclei within binucleated cells in a sample or portion thereof, the cells normally containing nuclei and cytoplasm, the nuclei and micronuclei being nuclear objects, the process comprising the steps of:
(a) treating the sample or portion thereof to highlight the presence of the cytoplasm and to highlight the presence of nuclear objects; (b) collecting one or more images of the sample or portion thereof showing the resulting highlighting, each of the one or more images comprising image data, there being image data for a plurality of locations within each of the one or more images, one or more of the cells in one or more of the images possibly appearing to be joined together in cellular clumps and one or more of the nuclear objects in one or more of the images possibly appearing to be joined together in nuclear object clumps; (c) automatically determining the outlines of the cells in the sample or portion thereof from the image data using means that can resolve cellular clumps into individual cells with an error rate no greater than 20%; (d) automatically determining the outlines of the nuclear objects in the sample or portion thereof from the image data using means that can resolve nuclear object clumps into individual nuclear objects with an error rate no greater than 20%; (e) automatically determining which of the nuclear objects are nuclei and which of the nuclear objects are micronuclei; (f) automatically determining which of the nuclei are within the cells; (g) automatically determining which of the cells are binucleated; (h) automatically determining which of the micronuclei are within the cells; and (i) automatically determining whether the binucleated cells contain micronuclei.

22. The process of claim 21 wherein step (c) comprises automatically determining the outlines of the cells in the sample or portion thereof from the image data using means that can resolve cellular clumps into individual cells with an error rate no greater than 10% and step (d) comprises automatically determining the outlines of the nuclear objects in the sample or portion thereof from the image data using means that can resolve nuclear object clumps into individual nuclear objects with an error rate no greater than 10%.

23. The process of claim 1 wherein step (c) comprises automatically determining the outlines of the cells in the sample or portion thereof from the image data using means that can resolve cellular clumps into individual cells with an error rate no greater than 5% and step (d) comprises automatically determining the outlines of the nuclear objects in the sample or portion thereof from the image data using means that can resolve nuclear object clumps into individual nuclear objects with an error rate no greater than 5%.

24. The process of claim 21 wherein step (c) comprises automatically determining the outlines of the cells in the sample or portion thereof from the image data using means that can resolve cellular clumps into individual cells employing, and step (d) comprises automatically determining the outlines of the nuclear objects in the sample or portion thereof from the image data using means that can resolve nuclear object clumps into individual nuclear objects employing, thinning; pruning; erosion; dilation; contour-based segmentation; distance mapping; watershed splitting; non-watershed splitting; tophat transform; nonlinear Laplacian transform; dot label methods; or combinations thereof.

25. The process of claim 21 wherein step (c) comprises automatically determining the outlines of the cells in the sample or portion thereof from the image data using means that can resolve cellular clumps into individual cells employing a nuclei influence zone diagram and step (d) comprises automatically determining the outlines of the nuclear objects in the sample or portion thereof from the image data using means that can resolve nuclear object clumps into individual nuclear objects employing watershed splitting.

26. The process of claim 21 wherein step (c) comprises: (i) creating a cytoplasm binary mask, (ii) for the nuclei, creating a nuclei influence zone diagram, and (iii) applying a Boolean AND to the cytoplasm binary mask and the nuclei influence zone diagram, thereby automatically determining the outlines of the cells.

27. The process of claim 26 wherein the image data comprise cytoplasm image data and nuclear objects image data and creating a cytoplasm binary mask comprises converting the cytoplasm image data to an n-bit scale.

28. The process of claim 27 wherein the step of converting the cytoplasm image data to an n-bit scale comprises setting a constant multiplied by the dimmest piece of image data of the cytoplasm image data as being equivalent to the minimum value of the n-bit scale and setting a constant multiplied by the mean piece of image data of the cytoplasm image data, optionally plus an offset, as being equivalent to the maximum value of the n-bit scale.

29. The process of claim 27 wherein the step of creating a nuclei influence zone diagram comprises converting the nuclear object image data to an n-bit scale comprising setting a constant multiplied by the dimmest piece of image data of the nuclear objects image data as being equivalent to the minimum value of the n-bit scale and setting the constant multiplied by the mean piece of image data of the nuclear objects image data, optionally plus an offset, as being equivalent to the maximum value of the n-bit scale.

30. The process of claim 29 wherein the step of creating a nuclei influence zone diagram further
comprises determining which nuclei are connected or are sufficiently close to be assumed to be within the same cell using a close and erosion process, a gating procedure based on perimeter convex, and a thinning and pruning operation.

31. A process for assessing the clastogenicity and/or aneugenicity of a stimulus using cells that normally contain nuclei and cytoplasm, there being a sample or portion thereof containing such cells that have been exposed to the stimulus under predetermined conditions and at least some of the cells in the sample or portion thereof having become binucleated, the sample being treated to highlight the presence of the cytoplasm and to highlight the presence of nuclear objects, nuclei and micronuclei being nuclear objects, and one or more images of the sample or portion thereof showing the resulting highlighting having been collected, the one or more images comprising image data, there being image data for a plurality of locations within each of the one or more images, there being a preselected frequency of micronuclei in binucleated cells above which a stimulus to which such cells have been exposed under predetermined conditions is assessed as being clastogenic and/or aneugenic, the process comprising the steps of:
(a) performing the process of any of claims 1 to 30 to determine how many micronuclei are within the binucleated cells in the sample or portion thereof; (b) calculating an experimental micronuclei frequency for the sample or portion thereof using the number of micronuclei determined in step (a) to be in the binucleated cells in the sample or portion thereof; and (c) comparing the experimental micronuclei frequency from step (b) with the preselected frequency and assessing the stimulus as being clastogenic and/or aneugenic if the resulting value from step (b) is above the preselected frequency.

32. An automated process for determining the presence of micronuclei within cells in a sample or portion thereof, the cells normally containing nuclei and cytoplasm, the nuclei and micronuclei being nuclear objects, the sample or portion thereof being treated to highlight the presence of the cytoplasm and to highlight the presence of nuclear objects, and one or more images of the sample or portion thereof showing the resulting highlighting having been collected, each of the one or more images comprising image data, there being image data for a plurality of locations within each of the one or more images, one or more of the cells in one or more of the images possibly appearing to be joined together in cellular clumps and one or more of the nuclear objects in one or more of the images possibly appearing to be joined together in nuclear object clumps, the process comprising the steps of:
(a) automatically determining the outlines of the cells in the sample or portion thereof from the image data using means that can resolve cellular clumps into individual cells with an error rate no greater than 20%; (b) automatically determining the outlines of the nuclear objects in the sample or portion thereof from the image data using means that can resolve nuclear object clumps into individual nuclear objects with an error rate no greater than 20%; (c) automatically determining which of the nuclear objects are nuclei and which of the nuclear objects are micronuclei; and (d) automatically determining which of the cells contain micronuclei.

33. The process of claim 32 wherein step (a) comprises automatically determining the outlines of the cells in the sample or portion thereof from the image data using means that can resolve cellular clumps into individual cells with an error rate no greater than 10% and step (b) comprises automatically determining the outlines of the nuclear objects in the sample or portion thereof from the image data using means that can resolve nuclear object clumps into individual nuclear objects with an error rate no greater than 10%.

34. The process of claim 32 wherein step (a) comprises automatically determining the outlines of the cells in the sample or portion thereof from the image data using means that can resolve cellular clumps into individual cells with an error rate no greater than 5% and step (b) comprises automatically determining the outlines of the nuclear objects in the sample or portion thereof from the image data using means that can resolve nuclear object clumps into individual nuclear objects with an error rate no greater than 5%.

35. The process of claim 32 wherein step (a) comprises automatically determining the outlines of the cells in the sample or portion thereof from the image data using means that can resolve cellular clumps into individual cells employing, and step (b) comprises automatically determining the outlines of the nuclear objects in the sample or portion thereof from the image data using means that can resolve nuclear object clumps into individual nuclear objects employing, thinning; pruning; erosion; dilation; contour-based segmentation; distance mapping; watershed splitting; non-watershed splitting; tophat transform; nonlinear Laplacian transform; dot label methods; or combinations thereof.

36. The process of claim 32 wherein step (a) comprises automatically determining the outlines of the cells in the sample or portion thereof from the image data using means that can resolve cellular clumps into individual cells employing a nuclei influence zone diagram and step (b) comprises automatically determining the outlines of the nuclear objects in the sample or portion thereof from the image data using means that can resolve nuclear object clumps into individual nuclear objects employing watershed splitting.

37. The process of claim 32 wherein step (a) comprises: (i) creating a cytoplasm binary mask, (ii) for the nuclei, creating a nuclei influence zone diagram, and (iii) applying a Boolean AND to the cytoplasm binary mask and the nuclei influence zone diagram, thereby automatically determining the outlines of the cells.

38. The process of claim 37 wherein the image data comprise cytoplasm image data and nuclear objects image data and creating a cytoplasm binary mask comprises converting the cytoplasm image data to an n-bit scale.

39. The process of claim 38 wherein the step of converting the cytoplasm image data to an n-bit scale comprises setting a constant multiplied by the dimmest piece of image data of the cytoplasm image data as being equivalent to the minimum value of the n-bit scale and setting a constant multiplied by the mean piece of image data of the cytoplasm image data, optionally plus an offset, as being equivalent to the maximum value of the n-bit scale.

40. The process of claim 38 wherein the step of creating a nuclei influence zone diagram comprises converting the nuclear object image data to an n-bit scale comprising setting a constant multiplied by the dimmest piece of image data of the nuclear objects image data as being equivalent to the minimum value of the n-bit scale and setting a constant multiplied by the mean piece of image data of the nuclear objects image data, optionally plus an offset, as being equivalent to the maximum value of the n-bit scale.

41. The process of claim 40 wherein the step of creating a nuclei influence zone diagram further
comprises determining which nuclei are connected or are sufficiently close to be assumed to be within the same cell using a close and erosion process, a gating procedure based on perimeter convex, and a thinning and pruning operation.

42. An automated process for determining the presence of micronuclei within cells in a sample or portion thereof, the cells normally containing nuclei and cytoplasm, the nuclei and micronuclei being nuclear objects, the sample or portion thereof being treated to highlight the presence of the cytoplasm and to highlight the presence of nuclear objects, and one or more images of the sample or portion thereof showing the resulting highlighting having been collected, each of the one or more images comprising image data, there being image data for a plurality of locations within each of the one or more images, one or more of the cells in one or more of the images possibly appearing to be joined together in cellular clumps and one or more of the nuclear objects in one or more of the images possibly appearing to be joined together in nuclear object clumps, the process comprising the steps of:
(a) automatically determining the outlines of the cells in the sample or portion thereof from the image data using means that can resolve cellular clumps into individual cells with an error rate no greater than 20%; (b) automatically determining the outlines of the nuclear objects in the sample or portion thereof from the image data using means that can resolve nuclear object clumps into individual nuclear objects with an error rate no greater than 20%; (c) automatically determining which of the nuclear objects are nuclei and which of the nuclear objects are micronuclei; and (d) using the results of the steps (a), (b), and (c), automatically identifying the cells that contain micronuclei.

43. The process of claim 42 wherein step (a) comprises automatically determining the outlines of the cells in the sample or portion thereof from the image data using means that can resolve cellular clumps into individual cells with an error rate no greater than 10% and step (b) comprises automatically determining the outlines of the nuclear objects in the sample or portion thereof from the image data using means that can resolve nuclear object clumps into individual nuclear objects with an error rate no greater than 10%.

44. The process of claim 42 wherein step (a) comprises automatically determining the outlines of the cells in the sample or portion thereof from the image data using means that can resolve cellular clumps into individual cells with an error rate no greater than 5% and step (b) comprises automatically determining the outlines of the nuclear objects in the sample or portion thereof from the image data using means that can resolve nuclear object clumps into individual nuclear objects with an error rate no greater than 5%.

45. The process of claim 42 wherein step (a) comprises automatically determining the outlines of the cells in the sample or portion thereof from the image data using means that can resolve cellular clumps into individual cells employing, and step (b) comprises automatically determining the outlines of the nuclear objects in the sample or portion thereof from the image data using means that can resolve nuclear object clumps into individual nuclear objects employing, thinning; pruning; erosion; dilation; contour-based segmentation; distance mapping; watershed splitting; non-watershed splitting; tophat transform; nonlinear Laplacian transform; dot label methods; or combinations thereof.

46. The process of claim 42 wherein step (a) comprises automatically determining the outlines of the cells in the sample or portion thereof from the image data using means that can resolve cellular clumps into individual cells employing a nuclei influence zone diagram and step (b) comprises automatically determining the outlines of the nuclear objects in the sample or portion thereof from the image data using means that can resolve nuclear object clumps into individual nuclear objects employing watershed splitting.

47. The process of claim 42 wherein step (a) comprises: (i) creating a cytoplasm binary mask, (ii) for the nuclei, creating a nuclei influence zone diagram, and (iii) applying a Boolean AND to the cytoplasm binary mask and the nuclei influence zone diagram, thereby automatically determining the outlines of the cells.

48. The process of claim 47 wherein the image data comprise cytoplasm image data and nuclear objects image data and creating a cytoplasm binary mask comprises converting the cytoplasm image data to an n-bit scale.

49. The process of claim 48 wherein the step of converting the cytoplasm image data to an n-bit scale comprises setting a constant multiplied by the dimmest piece of image data of the cytoplasm image data as being equivalent to the minimum value of the n-bit scale and setting a constant multiplied by the mean piece of image data of the cytoplasm image data, optionally plus an offset, as being equivalent to the maximum value of the n-bit scale.

50. The process of claim 48 wherein the step of creating a nuclei influence zone diagram comprises converting the nuclear object image data to an n-bit scale comprising setting a constant multiplied by the dimmest piece of image data of the nuclear objects image data as being equivalent to the minimum value of the n-bit scale and setting a constant multiplied by the mean piece of image data of the nuclear objects image data, optionally plus an offset, as being equivalent to the maximum value of the n-bit scale.

51. The process of claim 50 wherein the step of creating a nuclei influence zone diagram further
comprises determining which nuclei are connected or are sufficiently close to be assumed to be within the same cell using a close and erosion process, a gating procedure based on perimeter convex, and a thinning and pruning operation.

52. An automated process for determining the presence of micronuclei within cells in a sample or portion thereof, the cells normally containing nuclei and cytoplasm, the nuclei and micronuclei being nuclear objects, the process comprising the steps of:
(a) treating the sample or portion thereof to highlight the presence of the cytoplasm and to highlight the presence of nuclear objects; (b) collecting one or more images of the sample or portion thereof showing the resulting highlighting, each of the one or more images comprising image data, there being image data for a plurality of locations within each of the one or more images, one or more of the cells in one or more of the images possibly appearing to be joined together in cellular clumps and one or more of the nuclear objects in one or more of the images possibly appearing to be joined together in nuclear object clumps; (c) automatically determining the outlines of the cells in the sample or portion thereof from the image data using means that can resolve cellular clumps into individual cells with an error rate no greater than 20%; (d) automatically determining the outlines of the nuclear objects in the sample or portion thereof from the image data using means that can resolve nuclear object clumps into individual nuclear objects with an error rate no greater than 20%; (e) automatically determining which of the nuclear objects are nuclei and which of the nuclear objects are micronuclei; and (f) automatically determining which of the micronuclei are within the cells.

53. The process of claim 52 wherein step (c) comprises automatically determining the outlines of the cells in the sample or portion thereof from the image data using means that can resolve cellular clumps into individual cells with an error rate no greater than 10% and step (d) comprises automatically determining the outlines of the nuclear objects in the sample or portion thereof from the image data using means that can resolve nuclear object clumps into individual nuclear objects with an error rate no greater than 10%.

54. The process of claim 52 wherein step (c) comprises automatically determining the outlines of the cells in the sample or portion thereof from the image data using means that can resolve cellular clumps into individual cells with an error rate no greater than 5% and step (d) comprises automatically determining the outlines of the nuclear objects in the sample or portion thereof from the image data using means that can resolve nuclear object clumps into individual nuclear objects with an error rate no greater than 5%.

55. The process of claim 52 wherein step (c) comprises automatically determining the outlines of the cells in the sample or portion thereof from the image data using means that can resolve cellular clumps into individual cells employing, and step (d) comprises automatically determining the outlines of the nuclear objects in the sample or portion thereof from the image data using means that can resolve nuclear object clumps into individual nuclear objects employing, thinning; pruning; erosion; dilation; contour-based segmentation; distance mapping; watershed splitting; non-watershed splitting; tophat transform; nonlinear Laplacian transform; dot label methods; or combinations thereof.

56. The process of claim 52 wherein step (c) comprises automatically determining the outlines of the cells in the sample or portion thereof from the image data using means that can resolve cellular clumps into individual cells employing a nuclei influence zone diagram and step (d) comprises automatically determining the outlines of the nuclear objects in the sample or portion thereof from the image data using means that can resolve nuclear object clumps into individual nuclear objects employing watershed splitting.

57. The process of claim 52 wherein step (c) comprises: (i) creating a cytoplasm binary mask, (ii) for the nuclei, creating a nuclei influence zone diagram, and (iii) applying a Boolean AND to the cytoplasm binary mask and the nuclei influence zone diagram, thereby automatically determining the outlines of the cells.

58. The process of claim 57 wherein the image data comprise cytoplasm image data and nuclear objects image data and creating a cytoplasm binary mask comprises converting the cytoplasm image data to an n-bit scale.

59. The process of claim 58 wherein the step of converting the cytoplasm image data to an n-bit scale comprises setting a constant multiplied by the dimmest piece of image data of the cytoplasm image data as being equivalent to the minimum value of the n-bit scale and setting a constant multiplied by the mean piece of image data of the cytoplasm image data, optionally plus an offset, as being equivalent to the maximum value of the n-bit scale.

60. The process of claim 58 wherein the step of creating a nuclei influence zone diagram comprises converting the nuclear object image data to an n-bit scale comprising setting a constant multiplied by the dimmest piece of image data of the nuclear objects image data as being equivalent to the minimum value of the n-bit scale and setting a constant multiplied by the mean piece of image data of the nuclear objects image data, optionally plus an offset, as being equivalent to the maximum value of the n-bit scale.

61. The process of claim 60 wherein the step of creating a nuclei influence zone diagram further comprises determining which nuclei are connected or are sufficiently close to be assumed to be within the same cell using a close and erosion process, a gating procedure based on perimeter convex, and a thinning and pruning operation.

62. A process for assessing the clastogenicity and/or aneugenicity of a stimulus using cells that normally contain nuclei and cytoplasm, there being a sample or portion thereof containing such cells that have been exposed to the stimulus under predetermined conditions, the sample or portion thereof being treated to highlight the presence of the cytoplasm and to highlight the presence of nuclear objects, nuclei and micronuclei being nuclear objects, and one or more images of the sample or portion thereof showing the resulting highlighting having been collected, the one or more images comprising image data, there being image data for a plurality of locations within each of the one or more images, there being a preselected frequency of micronuclei in cells above which a stimulus to which such cells have been exposed under predetermined conditions is assessed as being clastogenic and/or aneugenic, the process comprising the steps of:
(a) performing the process of any of claims 32 to 61 to determine how many micronuclei are within the cells in the sample or portion thereof; (b) calculating an experimental micronuclei frequency for the sample or portion thereof using the number of micronuclei determined in step (a) to be in the cells in the sample or portion thereof; and (c) comparing the experimental micronuclei frequency from step (b) with the preselected frequency and assessing the stimulus as being clastogenic and/or aneugenic if the resulting value from step (b) is above the preselected frequency.

63. An automated process for determining the presence and/or size and/or shape and/or location of target objects inside or outside cells in a sample or portion thereof, the cells normally comprising cytoplasm, the sample or portion thereof being treated to highlight the presence of cytoplasm and to highlight the presence of the target objects, one or more images of the sample or portion thereof showing the resulting highlighting having been collected, each of the one or more images comprising image data, there being image data for a plurality of locations within each of the one or more images, one or more of the cells in one or more of the images possibly appearing to be joined together in cellular clumps and one or more of the target objects in one or more of the images possibly appearing to be joined together in target object clumps, the process comprising the steps of:
(a) automatically determining the outlines of the cells in the sample or portion thereof from the image data using means that can resolve cellular clumps into individual cells with an error rate no greater than 20%; (b) automatically determining the outlines of the target objects in the sample or portion thereof from the image data using means that can resolve target object clumps into individual target objects with an error rate no greater than 20%; and (c) automatically determining which of the target objects are within the cells and/or the size and/or shape and/or location of the target objects.

64. The process of claim 63 wherein step (a) comprises automatically determining the outlines of the cells in the sample or portion thereof from the image data using means that can resolve cellular clumps into individual cells with an error rate no greater than 10% and step (b) comprises automatically determining the outlines of the target objects in the sample or portion thereof from the image data using means that can resolve target object clumps into individual target objects with an error rate no greater than 10%.

65. The process of claim 63 wherein step (a) comprises automatically determining the outlines of the cells in the sample or portion thereof from the image data using means that can resolve cellular clumps into individual cells with an error rate no greater than 5% and step (b) comprises automatically determining the outlines of the target objects in the sample or portion thereof from the image data using means that can resolve target object clumps into individual target objects with an error rate no greater than 5%.

66. The process of claim 63 wherein step (a) comprises automatically determining the outlines of the cells in the sample or portion thereof from the image data using means that can resolve cellular clumps into individual cells employing, and step (b) comprises automatically determining the outlines of the target objects in the sample or portion thereof from the image data using means that can resolve target object clumps into individual target objects employing, thinning; pruning; erosion; dilation; contour-based segmentation; distance mapping; watershed splitting; non-watershed splitting; tophat transform; nonlinear Laplacian transform; dot label methods; or combinations thereof.

67. The process of claim 63 wherein step (a) comprises automatically determining the outlines of the cells in the sample or portion thereof from the image data using means that can resolve cellular clumps into individual cells employing a target objects influence zone diagram and step (b) comprises automatically determining the outlines of the target objects in the sample or portion thereof from the image data using means that can resolve target object clumps into individual target objects employing watershed splitting.

68. The process of claim 63 wherein step (a) comprises: (i) creating a cytoplasm binary mask, (ii) for the target objects, creating a target objects influence zone diagram, and (iii) applying a Boolean AND to the cytoplasm binary mask and the target objects influence zone diagram, thereby automatically determining the outlines of the cells.

69. The process of claim 68 wherein the image data comprise cytoplasm image data and target objects image data and creating a cytoplasm binary mask comprises converting the cytoplasm image data to an n-bit scale.

70. The process of claim 69 wherein the step of converting the cytoplasm image data to an n-bit scale comprises setting a constant multiplied by the dimmest piece of image data of the cytoplasm image data as being equivalent to the minimum value of the n-bit scale and setting a constant multiplied by the mean piece of image data of the cytoplasm image data, optionally plus an offset, as being equivalent to the maximum value of the n-bit scale.

71. The process of claim 69 wherein the step of creating a target objects influence zone diagram comprises converting the target object image data to an n-bit scale comprising setting a constant multiplied by the dimmest piece of image data of the target objects image data as being equivalent to the minimum value of the n-bit scale and setting a constant multiplied by the mean piece of image data of the target objects image data, optionally plus an offset, as being equivalent to the maximum value of the n-bit scale.

72. The process of claim 71 wherein the step of creating a target objects influence zone diagram further comprises determining which target objects are connected or are sufficiently close to be assumed to be within the same cell using a close and erosion process, a gating procedure based on perimeter convex, and a thinning and pruning operation.

73. An automated process for determining the presence and/or size and/or shape and/or location of target objects inside or outside cells in a sample or portion thereof, the cells normally containing cytoplasm, the process comprising the steps of:
(a) treating the sample or portion thereof to highlight the presence of the cytoplasm and to highlight the presence of target objects; (b) collecting one or more images of the sample or portion thereof showing the resulting highlighting, each of the one or more images comprising image data, there being image data for a plurality of locations within each of the one or more images, one or more of the cells in one or more of the images possibly appearing to be joined together in cellular clumps and one or more of the target objects in one or more of the images possibly appearing to be joined together in target object clumps; (c) automatically determining the outlines of the cells in the sample or portion thereof from the image data using means that can resolve cellular clumps into individual cells with an error rate no greater than 20%; (d) automatically determining the outlines of the target objects in the sample or portion thereof from the image data using means that can resolve target object clumps into individual target objects with an error rate no greater than 20%; and (e) automatically determining which of the target objects are within the cells and/or the size and/or shape and/or location of the target objects.

74. The process of claim 73 wherein step (c) comprises automatically determining the outlines of the cells in the sample or portion thereof from the image data using means that can resolve cellular clumps into individual cells with an error rate no greater than 10% and step (d) comprises automatically determining the outlines of the target objects in the sample or portion thereof from the image data using means that can resolve target object clumps into individual target objects with an error rate no greater than 10%.

75. The process of claim 73 wherein step (c) comprises automatically determining the outlines of the cells in the sample or portion thereof from the image data using means that can resolve cellular clumps into individual cells with an error rate no greater than 5% and step (d) comprises automatically determining the outlines of the target objects in the sample or portion thereof from the image data using means that can resolve target object clumps into individual target objects with an error rate no greater than 5%.

76. The process of claim 73 wherein step (c) comprises automatically determining the outlines of the cells in the sample or portion thereof from the image data using means that can resolve cellular clumps into individual cells employing, and step (d) comprises automatically determining the outlines of the target objects in the sample or portion thereof from the image data using means that can resolve target object clumps into individual target objects employing, thinning; pruning; erosion; dilation; contour-based segmentation; distance mapping; watershed splitting; non-watershed splitting; tophat transform; nonlinear Laplacian transform; dot label methods; or combinations thereof.

77. The process of claim 73 wherein step (c) comprises automatically determining the outlines of the cells in the sample or portion thereof from the image data using means that can resolve cellular clumps into individual cells employing a target objects influence zone diagram and step (d) comprises automatically determining the outlines of the target objects in the sample or portion thereof from the image data using means that can resolve target object clumps into individual target objects employing watershed splitting.

78. The process of claim 73 wherein step (c) comprises: (i) creating a cytoplasm binary mask, (ii) for the target objects, creating a target objects influence zone diagram, and (iii) applying a Boolean AND to the cytoplasm binary mask and the target objects influence zone diagram, thereby automatically determining the outlines of the cells.

79. The process of claim 78 wherein the image data comprise cytoplasm image data and target objects image data and creating a cytoplasm binary mask comprises converting the cytoplasm image data to an n-bit scale.

80. The process of claim 79 wherein the step of converting the cytoplasm image data to an n-bit scale comprises setting a constant multiplied by the dimmest piece of image data of the cytoplasm image data as being equivalent to the minimum value of the n-bit scale and setting a constant multiplied by the mean piece of image data of the cytoplasm image data, optionally plus an offset, as being equivalent to the maximum value of the n-bit scale.

81. The process of claim 79 wherein the step of creating a target objects influence zone diagram comprises converting the target object image data to an n-bit scale comprising setting a constant multiplied by the dimmest piece of image data of the target objects image data as being equivalent to the minimum value of the n-bit scale and setting a constant multiplied the mean piece of image data of the target objects image data, optionally plus an offset, as being equivalent to the maximum value of the n-bit scale.

82. The process of claim 81 wherein the step of creating a target objects influence zone diagram further comprises determining which target objects are connected or are sufficiently close to be assumed to be within the same cell using a close and erosion process, a gating procedure based on perimeter convex, and a thinning and pruning operation.

83. A process for assessing the presence and/or state of a disease, condition, syndrome, or stimuli-induced effect using cells that normally contain cytoplasm, there being a sample or portion thereof containing such cells that have been treated to highlight the presence of the cytoplasm and to highlight the presence of target objects whose abnormality is indicative of the disease, condition, syndrome, or stimuli-induced effect, one or more images of the sample or portion thereof showing the resulting highlighting having been collected, the one or more images comprising image data, there being image data for a plurality of locations within each of the one or more images, the process comprising the steps of:
(a) performing the process of any of claims 63 to 82 to determine the presence of target objects in the sample or portion thereof and/or the size and/or shape and/or location of the target objects inside or outside the cells; (b) assessing the presence and/or state of the disease, condition, syndrome, or stimuli-induced effect based on the presence or absence of target objects inside or outside the cells in the sample or portion thereof and/or the size and/or shape and/or location of the target objects inside or outside the cells.

84. The process of claim 83 wherein the target object is selected from the group consisting of
cellular DNA, nuclei, nuclear fragments, micronuclei, cytoplasm, cellular membrane, lysosomes, peroxisomes, ribosomes, phagosomes, endosomes, Golgi complexes, microbodies, granules, lamellar bodies, vacuoles, vesicles, clathrin-coated vesicles, Golgi vesicles, small membrane vesicles, secretory vesicles, centrioles, endoplasmic reticulum, mitochondria, respirating mitochondria, resting mitochondria, membranes, cilia, rod outer segments, cones, microtubules, microfilaments, actin filaments, intermediate filaments, cytoskeletons, cytoplasm, carbohydrates, glycogen, glucose, monosaccharides, disaccharides, polysaccharides, amino acids, peptides, proteins, enzymes, transporters, receptors, channels, ion channels, pumps, synapses, neurotransmitters, glycoproteins, lipoproteins, antibodies, antigens, insulins, hormones, lipids, phospholipids, fatty acids, cholesterol, triglycerides, glycerol, glycolipids, isoprenoids, steroids, sterols, steroid hormones, bile salts, bile acids, nucleic acids, nucleotides, DNA, RNA, mRNA, tRNA, rRNA, DNA probes, RNA probes, nucleus, nucleolus, apoptotic bodies, mitotic bodies, chromosomes, chromosome fragments, spindles, kinetochores, centromeres, endogenous molecules, reactive oxygen species, reactive nitrogen species, antioxidants, thiols, glutathione, amines, xenobiotics, bacteria, virus, fungus, chemicals, pigments, xenobiotic residues, ingested nutrients, vitamins, ingested foreign objects or particles, endocytized foreign objects or particles, phagocytized foreign objects or particles, and infiltrated cells.

85. The process of claim 83 wherein the target object is selected from the group consisting of
cellular DNA, nuclei, micronuclei, cytoplasm, glycogen granules, lipids, phospholipids, phagocytized material, bile acids, bile salts, and mitochondria.
